(19) United States
(12) Patent Application Publication
(10) Pub. No.: US 2010/0216664 A1
(43) Pub. Date: Aug. 26, 2010

(54) Method

(75) Inventors: Mark Lathrop, Paris (FR); Swee Lay Thein, London (GB)

Correspondence Address: STEPTOE & JOHNSON LLP, 1330 CONNECTICUT AVENUE, N.W., WASHINGTON, DC, 20036, US

(73) Assignees: KING'S COLLEGE LONDON, London (GB); COMMISSARIAT A L'ENERGIE ATOMIQUE, Paris (FR)

(21) Appl. No.: 12/652,989

(22) Filed: Jan. 6, 2010

Related U.S. Application Data
(63) Continuation of application No. PCT/GB2008/002276, filed on Jul. 2, 2008.
(60) Provisional application No. 60/948,340, filed on Jul. 6, 2007.

(30) Foreign Application Priority Data
Jul. 6, 2007 (GB) 0713183.2

(51) Int. Cl. C40B 30/04; C40B 40/06

(52) U.S. Cl. 506/9; 506/16

(57) ABSTRACT

The present invention relates, in one aspect, to a method for determining the severity of a disease attributed to at least one genetic mutation in one or more of the genes encoding haemoglobin polypeptide chains, comprising the steps of: (a) providing a sample from said subject; and (b) determining the presence of one or more diagnostic markers:
(i) within a 127 kb segment on chromosome 2p15;
(ii) within MYB and/or HBSIL and/or the intergenic region between MYB and HBSIL located on the 6q23 QTL interval; and/or
(iii) within one of the chromosomal loci given in Table 14; wherein the presence of said marker(s) in said sample is indicative that the severity of said disease in said subject will be or is less severe in said subject in comparison to a subject that does not possess said marker(s).

### FIELD

The present invention relates, in one aspect, to methods for determining the severity of a disease attributed to at least one genetic mutation in one or more of the genes encoding haemoglobin polypeptide chains,

### BACKGROUND

Haemoglobin is a complex, iron-containing, allosteric erythrocyte protein that carries oxygen from the lungs to cells and carbon dioxide from cells to the lungs. Hemoglobin A, the principle adult haemoglobin protein, comprises four polypeptide chains (two α-globin chains and two β-globin chains) and is among the best characterized of human proteins. A number of human disease states have been attributed to genetic mutations effecting one or more of the genes encoding haemoglobin polypeptide chains, including sickle cell anemia, which results from a point mutation in the haemoglobin β-chain. α- and β-thalassemia conditions are blood-related disorders which result from genetic mutations manifested phenotypically by deficient synthesis of one type of globin chain, resulting in excess synthesis of the other type of globin chain.

In normal adults, the synthesis of fetal Hb (Hb F) is reduced to very low levels, with the vast majority having only trace amounts. The Hb F is unevenly distributed and restricted to a subset of erythrocytes named F cells (FC). Since an increased level of Hb F has an ameliorating effect on diseases—such as sickle cell anemia and β-thalassemia—this has prompted numerous genetic and pharmacological approaches for the reactivation of HbF synthesis in those disorders. Current pharmacological agents in use—such as hydroxycarbamide, butyrate analogues, 5-azacytidine and its analogue, decitabine, provide evidence that it is possible to augment HbF production therapeutically, but these agents are limited by their toxic effects and not all patients are responsive.

Moreover, the molecular mechanism of Hb F reactivation and F cell production is not fully understood. Family studies and twin studies indicate that there are genetic factors influencing the expression of HbF production and the high FC trait.

Recently, a locus involved in the control of FC production have been mapped on chromosome 6q23 in an extensive, inbred Asian Indian kindred with β thalassaemia (Nature Genetics (1996) 12, 58; Am. J. Hum. Genet. (1998) 62, 1468). Another locus (FC production or FCP locus) which is associated with variation in FC levels in sickle cell disease has been mapped to the Xp22.2-p22.3 region (Blood (1992) 80, 816).

Currently, there is no effective therapy to prevent vascular blockage that underlies the pain and various organ damage associated with sickle cell disease or to correct the genetic defect. The current treatment approach includes intravenous solutions of glucose and electrolytes, narcotic analgesics, and antiinflammatory agents (Green et al. (1986) American journal of Hematology 23:317-321) for acute pain. Recently, the chemotherapeutic agent hydroxyurea has been used in an increasing number of sickle cell anemia patients. In more severe cases or following ischemic stroke, exchange transfusions and bone marrow transplantation have been utilized (American Journal of Emergency Medicine (1997) 15(7):671-679). The severe anemia in β thalassemia is corrected by life-long blood transfusion.

Whilst numerous different methods are available for determining if a subject is suffering from diseases—such as Sickle Cell Anemia and thalassemia (see for example, U.S. Pat. No. 4,236,526 and U.S. Pat. No. 5,281,519) it is not yet possible to predict the severity of the disease that a subject may face in the future. This is of particular importance in, for example, the pre-natal setting in order to determine the severity of the disease that an unborn child is likely to face following birth. This may also be of importance when parents wish to gain a better understanding of the severity of the disease that their unborn child may face or even when a couple are making a decision to have a child.

### SUMMARY OF THE INVENTION

Advantageously, the present invention provides for the first time, a method that can be used to predict the severity of diseases—such as Sickle Cell Anemia and β-thallasemia—that will develop in a subject.

The diagnostic marker(s) described herein are associated with an increase in the levels of F cell production. F cells are erythrocytes that contain HbF. An increased level of HbF has an ameliorating effect on the diseases described herein. Accordingly, subjects that possess one or more of the diagnostic markers described herein are likely to have an increase in the levels of F cell production such that the severity of the disease will be reduced in comparison to a subject who does not possess the one or more markers.

Advantageously, the diagnostic markers described herein account for 50% of the heritability of F cell variance. Methods are therefore described herein for genotyping the diagnostic markers associated with HbF and F cell variance for predicting a subject's ability to produce HbF. To date, although HbF response is a major ameliorating factor in diseases—such as β thalassaemia and sickle cell disease—it has not been possible to define this on a molecular basis.

### SUMMARY ASPECTS

In one aspect, there is provided a method for determining the severity of a disease attributed to at least one genetic mutation in one or more of the genes encoding haemoglobin polypeptide chains, comprising the steps of: (a) providing a sample from said subject; and (b) determining the presence of one or more diagnostic markers:
(i) within a 127 kb segment on chromosome 2p15;
(ii) within MYB and/or HBSIL and/or the intergenic region between MYB and HBSIL located on the 6q23 QTL interval; and/or
(iii) within one of the chromosomal loci given in Table 14; wherein the presence of said marker(s) in said sample is indicative that the severity of said disease will be or is less severe in said subject in comparison to a subject that does not possess said marker(s).

In another aspect, there is provided a method for determining the severity of a disease attributed to at least one genetic mutation in one or more of the genes encoding haemoglobin polypeptide chains, comprising the steps of: (a) providing a sample from said subject; and (b) determining the presence of one or more diagnostic markers within a 127 kb segment on chromosome 2p15; wherein the presence of said marker(s) in said sample is indicative that the severity of said disease will be or is less severe in said subject in comparison to a subject that does not possess said marker(s).

There is also provided a nucleic acid primer pair which specifically amplifies one or more diagnostic markers for determining the severity of a disease attributed to at least one genetic mutation in one or more of the genes encoding haemoglobin polypeptide chains, wherein said markers are: (i) within a 127 kb segment on chromosome 2p15;
(ii) within MYB and/or HBSIL and/or the intergenic region between MYB and HBSIL located on the 6q23 QTL interval; or
(iii) within one of the chromosomal loci given in Table 14.

A nucleic acid probe is also provided which specifically hybridises to one or more diagnostic markers for determining the severity of a disease attributed to at least one genetic mutation in one or more of the genes encoding haemoglobin polypeptide chains, wherein said markers are:
(i) within a 127 kb segment on chromosome 2p15;
(ii) within MYB and/or HBSIL and/or the intergenic region between MYB and HBSIL located on the 6q23 QTL interval; and/or
(iii) within one of the chromosomal loci given in Table 14.

An array of probes immobilised on a support comprising one or more the probes is also provided.

In a further aspect, there is described a method for preparing an array for use in determining the severity of a disease attributed to at least one genetic mutation in one or more of the genes encoding haemoglobin polypeptide chains comprising the step of immobilising on a solid support the array of probes.

An array obtained or obtainable by this method is also provided.

Another aspect relates to a method of detecting the presence of one or more nucleic acids in a sample comprising the steps of: (a) contacting the array with a sample under conditions sufficient for binding between said diagnostic marker(s) and said array to occur; and (b) detecting the presence of binding complexes on the surface of said array to detect the presence of said one or more diagnostic markers in said sample.

An assay method is also provided for identifying one or more agents that modulate the severity of a disease attributed to at least one genetic mutation effecting one or more of the genes encoding haemoglobin polypeptide chains, comprising the steps of: (a) identifying one or more agents that modulate the expression of the BCL11A and/or MYB and/or HBSIL gene(s) or the activity of the protein(s) encoded thereby; and (b) determining if said one or more agents increase F cell production, wherein an increase in F cell production is indicative of an agent that modulates the severity of the disease.

An agent obtained or obtainable by this method is also described.

A kit determining the severity of a disease attributed to at least one genetic mutation in one or more of the genes encoding haemoglobin polypeptide chains is also described, comprising at least one nucleic acid primer pair and/or at least one nucleic acid probe and/or at least one array as described herein.

In a further aspect, there is provided the use of at least one nucleic acid primer pair and/or at least one nucleic acid probe and/or an array as described herein for determining the severity of a disease in a subject attributed to at least one genetic mutation in one or more of the genes encoding haemoglobin polypeptide chains.

A final aspect relates to a method, a mutant, a nucleic acid, an array, an assay, a kit or a use substantially as described herein with reference to the accompanying Figures.

### SUMMARY EMBODIMENTS

Suitably, said diagnostic marker(s) are within a 127 kb segment on chromosome 2p15 are within the BCL11A gene.

Suitably, said diagnostic marker(s) are within a 15 kb region of the second intron of BCL11A located 50-65 kb downstream of exon 2.

Suitably, said diagnostic marker(s) are within a 67 kb region in the 3′ region of the gene located 8 to 74 kb downstream of exon 5.

Suitably, said diagnostic marker(s) are within a gene residing at one of the chromosomal loci given in Table 14.

Suitably, said diagnostic marker(s) are single nucleotide polymorphism(s).

Suitably, said single nucleotide polymorphisms are selected from the group consisting of: a mutation at nucleotide 60,460,511, nucleotide 60,467,280, nucleotide 60,562,101, nucleotide 60,571,547, nucleotide 60,573,474 or nucleotide 60,574,455 on chromosome 2p15 or combinations of at least two diagnostic marker(s).

Suitably, said single nucleotide polymorphisms are selected from the group consisting of: a mutation at nucleotide 135,424,673, a mutation at nucleotide 135,460,711, a mutation at nucleotide 135,468,266, and a mutation at nucleotide 135,484,905 on chromosome 6q23 or combinations of at least two diagnostic marker(s).

Suitably, said single nucleotide polymorphisms are selected from the group consisting of: a mutation at nucleotide 177035448 on chromosome 2q31.1; a mutation at nucleotide 42271177 on chromosome 4p13; a mutation at nucleotide 83818702 on chromosome 4q21.22; a mutation at nucleotide 124968427 on chromosome 4q28.1; a mutation at nucleotide 66862442 on chromosome 5q13.1; a mutation at nucleotide 153257952 on chromosome 5q33.2; a mutation at nucleotide 18447773 on chromosome 6p22.3; a mutation at nucleotide 137297618 on chromosome 9q34.3; a mutation at nucleotide 56556926 on chromosome 10q21.1; a mutation at nucleotide 103881964 on chromosome 10q24.32; a mutation at nucleotide 69876078 on chromosome 16q22.3; a mutation at nucleotide 2225359 on chromosome 17p13.3; a mutation at nucleotide 38800671 on chromosome 17q21.31; a mutation at nucleotide 40627042 on chromosome 20q12; a mutation at nucleotide 27667687 on chromosome 21q21.3; a mutation at nucleotide 70058755 on chromosome Xq13.1 or combinations of at least two diagnostic marker(s).

Suitably, the presence of one or more diagnostic markers within chromosome 11p15.4 is also determined.

Suitably, said diagnostic marker is a single nucleotide polymorphism at nucleotide 5,232,745 on chromosome 11.

Suitably, said single nucleotide polymorphism(s) are at nucleotides 60,460,511, 60,467,280, 60,562,101, 60,571,547, 60,573,474 and 60,574,455 on chromosome 2p15; at nucleotide 135,424,673, 135,460,711, 135,468,266, and 135,484,905 on chromosome 6q23; at nucleotide 5,232,745 on chromosome 11; at nucleotide 177035448 on chromosome 2q31.1; at nucleotide 42271177 on chromosome 4p13; at nucleotide 83818702 on chromosome 4q21.22; at nucleotide 124968427 on chromosome 4q28.1; at nucleotide 66862442 on chromosome 5q13.1; at nucleotide 153257952 on chromosome 5q33.2; at nucleotide 18447773 on chromosome 6p22.3; at nucleotide 137297618 on chromosome 9q34.3; at nucleotide 56556926 on chromosome 10q21.1; at nucleotide 103881964 on chromosome 10q24.32; at nucleotide 69876078 on chromosome 16q22.3; at nucleotide 2225359 on chromosome 17p13.3; at nucleotide 38800671 on chromosome 17q21.31; at nucleotide 40627042 on chromosome 20q12; at nucleotide 27667687 on chromosome 21q21.3; and at nucleotide 70058755 on chromosome Xq13.1. Accordingly, the presence of each of these SNPs in a sample is indicative that the disease will be less severe.

Suitably, the presence of the one or more diagnostic markers is determined using an array—such as a microarray.

Suitably, the presence of the one or more diagnostic markers is determined using the Illumina® GoldenGate® assay system with VeraCode™ technology.

Suitably, the method for preparing the array comprises the steps of (a) preparing one or more of the nucleic acid probes; and (b) immobilising said probes on a solid support.

### FIGURES

FIG. 1

a) Distribution of the log-transformed F cell trait in 5,184 European individuals. To enhance power for the genome-wide association screen, contrasting individuals from the upper and lower 95th percentile point (pink) were screened.

b) Association statistics (−log₁₀(p-value)) for the 3,225 markers genome-wide with p<10₋₂.

c) Association statistics for 211 markers across the 2p15 region of association for individuals included in the genome-screen panel.

FIG. 2

Quantile-quantile (Q-Q) plot of the one degree-of-freedom chi-squared statistics for genotype effect, computed from a linear regression model. The plot includes all markers included in the genome-wide analysis.

FIG. 3

Linkage disequilibrium plots showing pair-wise D′ values computed using the Haploview program. Estimated values of 1.0 are shown as blank squares in the figures. Blue squares indicate D′=1.0 with moderate statistical significance (LOD<2.0).

FIG. 4

Linkage disequilibrium plots showing pair-wise r2 values computed using the Haploview program. Estimated values of 1.0 are shown as blank squares in the figures. Blue squares indicate D′=1.0 with moderate statistical significance (LOD<2.0).

FIG. 5

RT-PCR of BCL11A across a tissue panel. The different tissues are represented by-FL: Fetal liver; PL: Peripheral leukocytes; Th: Thymus; BM: Bone marrow; Tst: Testis; K562 cells; Jur: Jurkat cells; d3: Primary erythroid cells day 3; d5: Primary erythroid cells day 5; d6: Primary erythroid cells day 6; d7: Primary erythroid cells day 7; B: water blank; M: Roche DNA Marker VIII. PCR primers were designed to amplify across exons 1 to 2 (225 bp) which are common to all known splice forms of BCL11a. Forward primer: 5′-GCAAACCCCAGCACTTAAGCAAAC-3′ Reverse primer: 5′-CCACAGCTTTTTCTAAGCAGAGGC-3′ Reverse transcription was carried out using 1 pg total RNA, with oligo dT priming using Super Script III Reverse Transcriptase (Invitrogen, UK) according to the manufacturer's protocol.

FIG. 6

Overview of the 6q23 region and the HMIP locus.

(a) Genomic organization of the 1.5-Mb candidate interval and the 126-kb segment spanning portions of HBS1L and MYB and the intergenic region on chromosome 6q23 (not to scale). The regions covered by the three trait-associated blocks (HMIP 1, 2, and 3) are indicated by square brackets with the locations of the high-scoring SNP alleles. Boxes represent both confirmed and putative exons with arrows indicating transcriptional orientation: red, coding sequence; white, 5_UTR.

(b) Positions of markers and significance (_log 10 P value) of test statistics from the mixed-model ANOVA at sites within the HBS1L-MYB interval of association and flanking regions. SNPs over MYB are significantly associated with the trait but this situation reflects the linkage disequilibrium across the region.

FIG. 7

Descriptions of the principal HBS1L and alternative HBS1L-1a splice forms, and RT-PCR sequence analysis.

(ai) Protein sequence of the principal HBS1L;

(aii) protein sequence of the alternative HBS1L-1a splice form. HBS1L is composed of 684 amino acids. The genomic sequence corresponding to this transcript spans 94.5 kb (from 39,385,952 to 39,480,451 on contig NT_{—}025741.13 or 135,323,216 to 135,417,715 on chromosome 6), and includes 18 exons, the first of which is located 127 kb from MYB. HBS1L-1a is composed of 699 amino acids and differs from HBS1L only in the sequence of their respective first exons (underlined). Alternative black and blue colors are used to indicate amino acids corresponding to different exons. The residues spanning splice junctions are indicated in red.

(b) Direct sequence analysis of RT-PCR product across the exon 1a/2 junction of HBS1L-1a transcript (indicated by arrow) confirming the presence of the open reading frame.

(c) RT-PCR of HBS1L-1a across a tissue panel. Primers within exon 3 and 1a were chosen to give a 239 by product. Primer sequences are:

| | |
|---|---|
| HBS1L exon 1a: | 5′-CTACAGCAGGCTTCAGGAAGTG-3′ |
| HBS1L exon 3: | 5′-CACAGGCTCAACGGAAGGTTTG-3′ |

Positive signals, confirmed by sequence analysis, are indicated by arrows. The different tissues are represented by: AL: adult liver; FL: fetal liver; Thy: thymus; Leu: peripheral leukocytes; Jur:Jurkat; BM: bone marrow; Tes: testis; Ery: primary erythroid cells; K562: K562 cells; —RT: no RT control. The DNA marker is PhiX174-HaeIII.

FIG. 8

Relationship between genotype and quantitative evaluation of HBS1L expression in 35 individuals: (a) HMIP 1 markers; (b) HMIP 2 markers; and (c) HMIP 3 markers. Day 0 values are shown at the left-hand side and day 3 values are shown on the right-hand side. In most instances, genotype status (presence of alleles associated with high or low mean FC trait values) was consistent for all markers across an association block. Two individuals who were heterozygous at one site and homozygous for all other genotyped sites in block 2 were scored as homozygous for the block. Similarly, two individuals who were heterozygous at one site and homozygous at other genotyped sites in block 3 were scored as homozygous for the block, whereas one individual who was heterozygous for multiple sites and homozygous for other genotyped sites in block 3 was not scored for this block. The significance of the relationship between genotype and expression measurements was assessed by linear regression (Stata version 9.2); possible correlation of observations generated from samples on the same plate was taken into account in these analyses (Williams, R. L. (2000) Biometrics 56, 645-646).

FIG. 9

Genotype and quantitative evaluation of MYB expression in 35 individuals: (a) HMIP 1 markers; (b) HMIP 2 markers; and (c) HMIP 3 markers. Day 0 values are shown at the left hand side and day 3 values are shown on the right hand side. No significant relationships were found between genotype and MYB expression.

FIG. 10

Graphical representation of new loci showing evidence for association with the F-cell trait in Caucasian healthy individuals.

For each locus, all SNPs within 2 megabase of the top-scoring SNP are shown. For each SNP, a log score (−log₁₀ of association p-value) is plotted for each of the statistical models evaluated. Models are represented by different-coloured dots. The x-axis represents the nucleotide position on the respective chromosome (USCS version March 2006).

### DETAILED DESCRIPTION

### Disease

As described above, haemoglobin is a complex, iron-containing, allosteric erythrocyte protein that carries oxygen from the lungs to cells and carbon dioxide from cells to the lungs. Hemoglobin A, the principle adult hemoglobin protein, comprises four polypeptide chains (two α-globin chains and two β-globin chains) and is among the best characterized of human proteins. A number of human disease states have been attributed to genetic mutations effecting one or more of the genes encoding hemoglobin polypeptide chains, including sickle cell anemia, which results from a point mutation in the hemoglobin β-chain. Alpha- and beta-thalassemia conditions are blood-related disorders which result from genetic mutations manifested phenotypically by deficient synthesis of one type of globin chain, resulting in excess synthesis of the other type of globin chain (Weatherall et al., The Thalassaemia Syndromes, 3rd ed., Oxford, Blackwell Scientific, 1981).

Accordingly, the disease as described herein is a disease that is attributed to one or more genetic mutations affecting the 13 globin gene encoding 13 globin polypeptide chains.

Suitably, the disease results from a point mutation in the hemoglobin β-chain (eg. sickle cell disease).

Suitably, the disease results from one or more genetic mutations manifested phenotypically by deficient synthesis of β globin chain, resulting in excess synthesis of a globin chain (eg. (β-thalassemia).

Suitably, the disease is sickle cell disease (eg. sickle cell anemia) and/or thalassemia (eg. β-thalassemia).

Sickle cell diseases (SCD) and thalassemia are inherited hemoglobinopathies characterized by a structural hemoglobin defect or quantitative deficiency of one type of globin chain. SCD include diseases which cause sickling of the red blood cells, and includes sickle cell anemia (which results from two hemoglobin S genes), hemoglobin SC disease (one hemoglobin S and one hemoglobin C), hemoglobin S/β thalassemia (one hemoglobin and one β thalassemia gene), and the rarer diseases, hemoglobin S/Lepore and hemoglobin S/O-Arab. Thalassemia includes β-thalassemia and α-thalassemia. These hereditary diseases have significant morbidity and mortality and affect individuals of African heritage, as well as those of Mediterranean, Middle Eastern, and South East Asian descent. SCD commonly causes severe pain in sufferers in part due to ischemia caused by the damaged red blood cells blocking free flow through the circulatory system. β thalassemia leads to severe anemia and requires life-long blood transfusions for survival.

### Sickle Cell Disease

As used herein the term “sickle cell disease” refers to a variety of clinical problems attendant upon sickle cell anemia, especially in those subjects who are homozygotes for the sickle cell substitution in HbS. Among the constitutional manifestations referred to herein by use of the term of sickle cell disease are delay of growth and development, an increased tendency to develop serious infections, particularly due to pneumococcus, marked impairment of splenic function, preventing effective clearance of circulating bacteria, with recurrent infarcts and eventual destruction of splenic tissue. Also included in the term “sickle cell disease” are acute episodes of musculoskeletal pain, which affect primarily the lumbar spine, abdomen, and femoral shaft, and which are similar in mechanism and in severity to the bends. In adults, such attacks commonly manifest as mild or moderate bouts of acute pain of short duration every few weeks or months interspersed with agonizing attacks lasting 5 to 7 days that strike on average about once a year. Among events known to trigger such crises are infection that leads to acidosis, hypoxia and dehydration, all of which potentiate intracellular polymerization of HbS (J. H. Jandl, Blood: Textbook of Hematology, 2nd Ed., Little, Brown and Company, Boston, 1996, pages 544-545).

Sickle cell disease is a hemolytic disorder, which affects, in its most severe form, approximately 80,000 patients in the United States (see, for example, D. L. Rucknagel, in R. D. Levere, Ed., Sickle Cell Anemia and Other Hemoglobinopathies, Academic Press, New York, 1975, p. 1). The disease is caused by a single mutation in the hemoglobin molecule; β6 glutamic acid in normal adult hemoglobin A is changed to valine in sickle hemoglobin S. (see, for example, V. M. Ingram in Nature, 178:792-794 (1956)). Hemoglobin S has a markedly decreased solubility in the deoxygenated state when compared to that of hemoglobin A. Therefore, upon deoxygenation, hemoglobin S molecules within the erythrocyte tend to aggregate and form helical fibers that cause the red cell to assume a variety of irregular shapes, most commonly in the sickled form. After repeated cycles of oxygenation and deoxygenation, the sickle cell in the circulation becomes rigid and no longer can squeeze through the small capillaries in tissues, resulting in delivery of insufficient oxygen and nutrients to the organ, which eventually leads to local tissue necrosis. The prolonged blockage of microvascular circulation and the subsequent induction of tissue necrosis lead to various symptoms of sickle cell anemia, including painful crises of vaso-occlusion.

Now, most patients with sickle cell disease can be expected to survive into adulthood, but still face a lifetime of crises and complications, including chronic hemolytic anemia, vaso-occlusive crises and pain, and the side effects of therapy. Currently, most common therapeutic interventions include blood transfusions, opioid and hydroxyurea therapies (see, for example, S. K. Ballas in Cleveland Clin. J. Med., 66:48-58 (1999).

### Thalassemia

The thalassemias represent a heterogeneous group of diseases, characterized by the absence or diminished synthesis of one or the other of the globin chains of hemoglobin A. In α-thalassemia, α-chain synthesis is decreased or absent; whereas in β-thalassemia, β-chain synthesis is diminished or absent. Numerous molecular defects account for the various thalassemias. The degree of clinical expression is generally dictated by the nature and severity of the underlying globin gene (DNA) defect. Thalassemia major (homozygous β-thalassemia) defines the most severe variety of the disease. Thalassemia intermedia is generally associated with milder clinical manifestations and caused by homozygous or heterozygous state, while thalassemia minor (heterozygous state) generally has no clinical manifestations.

β-thalassemia is an autosomal recessive disorder characterized by absent or decreased synthesis of the β-globin chain. Thalassemia is found in populations from tropical or sub-tropical regions around the world where malaria is endemic. It has been estimated that 3% of the world's population or 150 million people carry β-thalassemia genes. Indeed, it is among the most common genetic disease in the world.

### Diagnostic Marker

As used herein, the term “diagnostic marker” refers to a marker (eg. a polymorphism, a mutation or a single nucleotide polymorphism) that can be detected in a sample from a subject in order to determine the severity of a disease therein.

Suitably, the one or more markers described herein occur at a frequency of greater than about 15%, 20%, 25%, 30%, 35%, 40%, 45% or 50% or more of a selected population.

Suitably, the one or more diagnostic markers are within a 127 kb segment on chromosome 2p15 (chr2: 60,456,396 to 60,582,798).

Suitably, the one or more diagnostic markers are within the BCL11A gene.

Suitably, the one or more diagnostic markers are within a 15 kb region (at 60,561,398 to 60,575,745) of the second intron of BCL11A located 50-65 kb downstream of exon 2.

In one embodiment, the BCL11A gene is identified as uc002sab.1 at chromosome 2 (60,451,806-60,634,137).

Suitably, the one or more diagnostic markers are within a 67 kb region (at 60,457,454 to 60,523,981) in the 3′ region of the gene located 8 to 74 kb downstream of exon 5.

Suitably, the one or more diagnostic markers are within the MYB gene on the 6q23 QTL interval.

Suitably, the one or more diagnostic markers are within the HBS1L gene on the 6q23 QTL interval.

Suitably, the one or more diagnostic markers are within the intergenic region located between MYB and HBS1L located on the 6q23 QTL interval.

Suitably, the one or more diagnostic markers are within the HBS1L MYB Intergenic Polymorphism (HMIP) block 2 (HMIP-2).

The one or more diagnostic markers may be one or more polymorphisms.

As used herein, the term “polymorphism” refers to the occurrence of genetically determined alternative sequences or alleles in a population. The polymorphism may comprise one or more base changes, an insertion, a repeat, or a deletion. A polymorphic locus may be as small as one base pair and may affect the cleavage site of a restriction enzyme (restriction fragment length polymorphism). The polymorphic locus may also include a variable number of tandem repeats (VNTR's), hypervariable regions, minisatellites, dinucleotide repeats, trinucleotide repeats, tetranucleotide repeats, simple sequence repeats, and insertion elements—such as Alu. The first identified allelic form is arbitrarily designated as the reference form and other allelic forms are designated as alternative or variant alleles. The allelic form occurring most frequently in a selected population is sometimes referred to as the wildtype form.

In one embodiment, the one or more polymorphisms are single nucleotide polymorphisms (SNPs).

Suitably, the SNP(s) are within a 127 kb segment on chromosome 2p15 (chr2: 60,456,396 to 60,582,798). Suitably, the SNP(s) are within the BCL11A gene. Suitably, the SNPs are within a 15 kb region (at 60,561,398 to 60,575,745) of the second intron of BCL11A located 50-65 kb downstream of exon 2. Suitably, the SNPs are within a 67 kb region (at 60,457,454 to 60,523,981) in the 3′ region of the gene located 8 to 74 kb downstream of exon 5.

In addition or in the alternative, the SNP(s) are within the MYB gene on the 6q23 QTL interval. In addition or in the alternative, the SNP(s) are within HBS1L on the 6q23 QTL interval. In addition or in the alternative, the SNP(s) are within the intergenic region located between MYB and HBS1L located on the 6q23 QTL interval.

In another embodiment, the SNP(s) are within a 127 kb segment on chromosome 2p15, and within the MYB gene on the 6q23 QTL interval and within the intergenic region located between MYB and HBS1L located on the 6q23 QTL interval;

In one embodiment, the MYB gene is identified as uc003qbb.1 at chromosome 6 (135,544,146-135,582,003).

In one embodiment, the HBS1L gene is identified as uc003qez.1 at chromosome 6 (135,323,214-135,417,715).

The intergenic region located between MYB and HBS1L is identified on chromosome 6 (135,417,716-135,544,145).

Suitably, the one or more diagnostic marker(s) are SNPs selected from the group consisting of a mutation at nucleotide 60,460,511 or nucleotide 60,467,280 or a combination thereof.

Suitably, the one or more diagnostic marker(s) are SNPs selected from the group consisting of: a mutation at nucleotide 60,562,101, nucleotide 60,571,547, nucleotide 60,573,474 or nucleotide 60,574,455 on chromosome 2p15 or combinations of at least two diagnostic marker(s).

Suitably, the one or more diagnostic marker(s) are SNPs selected from the group consisting of: a mutation at nucleotide 60,460,511, nucleotide 60,467,280, nucleotide 60,562,101, nucleotide 60,571,547, nucleotide 60,573,474 or nucleotide 60,574,455 on chromosome 2p15 or combinations of at least two diagnostic marker(s).

In addition or in the alternative, the one or more diagnostic marker(s) are SNPs selected from the group consisting of a mutation at nucleotide 135,424,673, nucleotide 135,460,711, or nucleotide 135,484,905 on chromosome 6q23 or a combination of at least two diagnostic marker(s).

In addition or in the alternative, the diagnostic marker is a SNP at nucleotide 5,232,745 on chromosome 11p15.4.

In another embodiment, the diagnostic marker(s) are SNPs at nucleotides 60,460,511, 60,467,280, 60,562,101, 60,571,547, 60,573,474 and 60,574,455 on chromosome 2p15, nucleotides 135,424,673, 135,460,711, and 135,484,905 on chromosome 6q23 and nucleotide 5,232,745 on chromosome 11p15.4.

Suitably the one or more diagnostic markers are SNPs selected from the group consisting of: a mutation at nucleotide 177035448 on chromosome 2q31.1; a mutation at nucleotide 42271177 on chromosome 4p13; a mutation at nucleotide 83818702 on chromosome 4q21.22; a mutation at nucleotide 124968427 on chromosome 4q28.1; a mutation at nucleotide 66862442 on chromosome 5q13.1; a mutation at nucleotide 153257952 on chromosome 5q33.2; a mutation at nucleotide 18447773 on chromosome 6p22.3; a mutation at nucleotide 137297618 on chromosome 9q34.3; a mutation at nucleotide 56556926 on chromosome 10q21.1; a mutation at nucleotide 103881964 on chromosome 10q24.32; a mutation at nucleotide 69876078 on chromosome 16q22.3; a mutation at nucleotide 2225359 on chromosome 17p13.3; a mutation at nucleotide 38800671 on chromosome 17q21.31; a mutation at nucleotide 40627042 on chromosome 20q12; a mutation at nucleotide 27667687 on chromosome 21q21.3; a mutation at nucleotide 70058755 on chromosome Xq13.1 or combinations of at least two diagnostic marker(s).

The diagnostic marker may be within a locus on one of the following chromosome segments: 2q31.1; 4p13; 4q21.22; 4q28.1; 5q13.1; 5q33.2; 6p22.3; 9q34.3; 10q21.1; 10q24.32; 16q22.3; 17p13.3; 17q21.31; 20q12; 21q21.3; and Xq13.1.

The diagnostic marker may be within one of the chromosomal loci given in Table 14. Table 14 gives the representative, or main, SNP (e.g. rs6749901) and its location (177035448 on chromosome segment 2q31.1). The locus may be defined as the region comprising representative SNP and the SNPs in linkage disequilibrium with the main SNP.

For each main SNP given in Table 14, associated SNPs which have currently been identified are given in Table 15.

The locus may also be defined as the region consisting of the main SNP and the portion of sequence 500 kb upstream and 500 kb downstream of the main SNP.

The diagnostic marker may be located within the following regions:
176804554-177703938 on chromosome 2;
420-42230-42339069; 83818702-83851997 or 124968427-125042126 on chromosome 4;
66202370-66908117; or 152796682-153778031 on chromosome 5;
18397751-18495794 on chromosome 6;
137159547-138017087 on chromosome 9;
103581467-103974050 on chromosome 10;
69784829-70575918 on chromosome 16;
38465179-39028855 on chromosome 17;
40406674-40627042 on chromosome 20;
26943343-27677096 on chromosome 21; or
69590536-70101555 on chromosome X.

Suitably, the polymorphisms (eg. the single nucleotide polymorphisms) are point mutations.

In one embodiment, the SNP is a mutation from T to G at nucleotide 60,460,511 in chromosome 2p15.

In one embodiment, the SNP is a mutation from G to A at nucleotide 60,467,280 in chromosome 2p15.

In one embodiment, the SNP is a mutation from T to C at nucleotide 60,562,101 in chromosome 2p15.

In one embodiment, the SNP is a mutation from G to T at nucleotide 60,571,547 in chromosome 2p15.

In one embodiment, the SNP is a mutation from A to C at nucleotide 60,573,474 in chromosome 2p15.

In one embodiment, the SNP is a mutation from G to A at nucleotide 60,574,455 in chromosome 2p15.

In one embodiment, the SNP is a mutation from G to T at nucleotide 135,424,673 in chromosome 6q23.

In one embodiment, the SNP is a mutation from T to C at nucleotide 135,460,711 in chromosome 6q23.

In one embodiment, the SNP is a mutation from G to A at nucleotide 135,484,905 in chromosome 6q23.

In one embodiment, the SNP is a mutation from G to A at nucleotide 5,232,745 in chromosome 11p15.4.

In one embodiment, the SNP(s) are high scoring SNP(s).

### Severity

As described herein, there is provided a method for determining the severity of a disease in a subject. Less severe disease is connected to the one or more diagnostic markers described herein.

In one aspect, there is provided a method for determining the severity of a disease attributed to at least one genetic mutation in one or more of the genes encoding haemoglobin polypeptide chains, comprising the steps of: (a) providing a sample from said subject; and (b) determining the presence of one or more diagnostic markers: (i) within a 127 kb segment on chromosome 2p15; (ii) within MYB and/or HBS1L and/or the intergenic region between MYB and HBS1L located on the 6q23 QTL interval; and/or (iii) within one of the chromosomal loci given in Table 14, wherein the presence of said marker(s) in said sample is indicative that said disease will be less severe in said subject in comparison to a subject that does not possess said marker(s).

In addition or in the alternative, the one or more diagnostic markers may be within the MYB gene on the 6q23 QTL interval. In addition or in the alternative, the one or more diagnostic markers are within HBS1L on the 6q23 QTL interval. In addition or in the alternative, the one or more diagnostic markers are within the intergenic region located between MYB and HBS1L located on the 6q23 QTL interval.

In a further aspect, there is provided a method for determining the severity of a disease attributed to at least one genetic mutation in one or more of the genes encoding haemoglobin polypeptide chains, comprising the steps of: (a) providing a sample from said subject; and (b) determining the presence of one or more diagnostic markers within a 127 kb segment on chromosome 2p15; wherein the presence of said marker(s) in said sample is indicative that said disease will be less severe in said subject in comparison to a subject that does not possess said marker(s).

In one embodiment of this aspect of the invention, the one or more diagnostic markers on the 6q23 QTL interval are also identified—such as one or more diagnostic markers within the MYB gene on the 6q23 QTL interval; and/or one or more diagnostic markers within HBS1L on the 6q23 QTL interval; and/or one or more diagnostic markers within the intergenic region located between MYB and HBS1L located on the 6q23 QTL interval.

In one embodiment, the one or more diagnostic markers within the 127 kb segment on chromosome 2p15 are used for determining the severity of sickle cell disease and/or β-thalassemia.

In one embodiment, the one or more diagnostic markers within the 6q23 QTL interval are used for determining the severity of sickle cell disease and/or β-thalassemia.

In general, “a less severe disease” is intended to mean that the manifestations of the disease are reduced in the subject as compared to a subject that does not possess one or more of the markers described herein. Accordingly, the subject may have less severe symptoms of the disease. The subject may have a reduced number of symptoms. The subject may have a delayed onset of the symptoms. The subject may require less intensive therapeutic treatment—such as a reduced drug dosage or fewer drugs in total.

In one embodiment, “less severe disease” means that the manifestations of the disease are reduced in the subject as compared to a subject that does not possess one or more of the markers described herein. Accordingly, symptoms—such as delay of growth and development, susceptibility to infections, acute episodes of musculoskeletal pain, complications—such as stroke, acute chest crisis, chronic lung disease and kidney failure—are reduced in said subjects possessing the one or more markers described herein.

Suitably, the one or more diagnostic markers are detected/measured in a body fluid or tissue after removal or excretion from the body (eg. in nucleic acid from a body fluid or tissue after removal or excretion from the body). For example, the diagnostic marker(s) may be detected in nucleic acid extracted from a sample of blood or saliva from a patient. In one embodiment, the method described herein is therefore non-invasive. In one embodiment, the method described herein excludes the step of collecting the sample from the subject.

The method for determining the severity of a disease attributed to one or more genetic mutations effecting one or more of the genes encoding haemoglobin polypeptide chains relies on the detection of one or more diagnostic markers—such as one more polymorphisms (eg. single nucleotide polymorphisms).

The term “polymorphism” as used herein is synonymous with the term “mutation” or “mutant”.

The one or more diagnostic markers may be detected in a variety of methods which can include the use of sequencing, probes, primers, nucleic acid hybridization, PCR, nucleic acid chip hybridization and/or electrophoresis, for example.

Sequencing methods are common laboratory procedures known to many in the art and would be able to detect the exact nature of the mutation.

In addition, mutation(s) may be detected by a nucleic acid probe. For instance, one skilled in the art is aware that a fluorescent tag could be specific for binding of a mutation and could be exposed to, for instance, glass beads coated with nucleic acids containing potential mutations. Upon binding of the tag to the mutation in question, a change in fluorescence (such as creation of fluorescence, increase in intensity, or partial or complete quenching) could be indicative of the presence of that mutation.

Nucleic acid hybridization including Southern hybridization or Northern hybridization may be utilized to detect mutations such as those involved in alteration of large regions of the sequence or of those involved in alteration of a sequence containing a restriction endonuclease site. Hybridization may be detected by a variety of ways including radioactivity, colour change, light emission, or fluorescence.

Amplification methods—such as PCR—may also be used to amplify a region suspected to contain a mutation and the resulting amplified region could either be subjected to sequencing or to restriction digestion analysis in the event that the mutation was responsible for creating or removing a restriction endonuclease site.

Many amplification methods rely on an enzymatic chain reaction (such as a polymerase chain reaction, a ligase chain reaction, or a self-sustained sequence replication).

Suitably, the amplification is an exponential amplification, as exhibited by, for example, the polymerase chain reaction.

Many target and signal amplification methods have been described in the literature, for example, general reviews of these methods in Landegren, U., et al., Science 242:229-237 (1988) and Lewis, R., Genetic Engineering News 10:1, 54-55 (1990). These amplification methods can be used in the methods described herein, and include polymerase chain reaction (PCR), PCR in situ, ligase amplification reaction (LAR), ligase hybridisation, Q-beta bacteriophage replicase, transcription-based amplification system (TAS), genomic amplification with transcript sequencing (GAWTS), nucleic acid sequence-based amplification (NASBA) and in situ hybridisation. Primers suitable for use in various amplification techniques can be prepared according to methods known in the art.

### Polymerase Chain Reaction (PCR)

PCR is a nucleic acid amplification method described inter alia in U.S. Pat. Nos. 4,683,195 and 4,683,202. PCR consists of repeated cycles of DNA polymerase generated primer extension reactions. The target DNA is heat denatured and two oligonucleotides, which bracket the target sequence on opposite strands of the DNA to be amplified, are hybridised. These oligonucleotides become primers for use with DNA polymerase. The DNA is copied by primer extension to make a second copy of both strands. By repeating the cycle of heat denaturation, primer hybridisation and extension, the target DNA can be amplified a million fold or more in about two to four hours. PCR is a molecular biology tool, which must be used in conjunction with a detection technique to determine the results of amplification. An advantage of PCR is that it increases sensitivity by amplifying the amount of target DNA by 1 million to 1 billion fold in approximately 4 hours. PCR can be used to amplify any known nucleic acid in a diagnostic context (Mok et al., (1994), Gynaecologic Oncology, 52: 247-252).

### Self-Sustained Sequence Replication (3SR)

Self-sustained sequence replication (3SR) is a variation of TAS, which involves the isothermal amplification of a nucleic acid template via sequential rounds of reverse transcriptase (RT), polymerase and nuclease activities that are mediated by an enzyme cocktail and appropriate oligonucleotide primers (Guatelli et al. (1990) Proc. Natl. Acad. Sci. USA 87:1874). Enzymatic degradation of the RNA of the RNA/DNA heteroduplex is used instead of heat denaturation. RNase H and all other enzymes are added to the reaction and all steps occur at the same temperature and without further reagent additions. Following this process, amplifications of 10⁶ to 10⁹ have been achieved in one hour at 42° C.

### Ligation Amplification (LAR/LAS)

Ligation amplification reaction or ligation amplification system uses DNA ligase and four oligonucleotides, two per target strand. This technique is described by Wu, D. Y. and Wallace, R. B. (1989) Genomics 4:560. The oligonucleotides hybridise to adjacent sequences on the target DNA and are joined by the ligase. The reaction is heat denatured and the cycle repeated.

### Qβ Replicase

In this technique, RNA replicase for the bacteriophage Qβ, which replicates single-stranded RNA, is used to amplify the target DNA, as described by Lizardi et al. (1988) Bio/Technology 6:1197. First, the target DNA is hybridised to a primer including a T7 promoter and a Qβ 5′ sequence region. Using this primer, reverse transcriptase generates a cDNA connecting the primer to its 5′ end in the process. These two steps are similar to the TAS protocol. The resulting heteroduplex is heat denatured. Next, a second primer containing a Qβ 3′ sequence region is used to initiate a second round of cDNA synthesis. This results in a double stranded DNA containing both 5′ and 3′ ends of the Qβ bacteriophage as well as an active T7 RNA polymerase binding site. T7 RNA polymerase then transcribes the double-stranded DNA into new RNA, which mimics the Qβ. After extensive washing to remove any unhybridised probe, the new RNA is eluted from the target and replicated by Qβ replicase. The latter reaction creates 10⁷ fold amplification in approximately 20 minutes.

Alternative amplification technologies can also be exploited. For example, strand displacement amplification (SDA; Walker et al., (1992) PNAS (USA) 80:392) may be used and begins with a specifically defined sequence unique to a specific target. But unlike other techniques which rely on thermal cycling, SDA is an isothermal process that utilises a series of primers, DNA polymerase and a restriction enzyme to exponentially amplify the unique nucleic acid sequence. SDA comprises both a target generation phase and an exponential amplification phase. In target generation, double-stranded DNA is heat denatured creating two single-stranded copies. A series of specially manufactured primers combine with DNA polymerase (amplification primers for copying the base sequence and bumper primers for displacing the newly created strands) to form altered targets capable of exponential amplification. The exponential amplification process begins with altered targets (single-stranded partial DNA strands with restricted enzyme recognition sites) from the target generation phase.

An amplification primer is bound to each strand at its complementary DNA sequence. DNA polymerase then uses the primer to identify a location to extend the primer from its 3′ end, using the altered target as a template for adding individual nucleotides. The extended primer thus forms a double-stranded DNA segment containing a complete restriction enzyme recognition site at each end.

A restriction enzyme is then bound to the double stranded DNA segment at its recognition site. The restriction enzyme dissociates from the recognition site after having cleaved only one strand of the double-sided segment, forming a nick. DNA polymerase recognises the nick and extends the strand from the site, displacing the previously created strand. The recognition site is thus repeatedly nicked and restored by the restriction enzyme and DNA polymerase with continuous displacement of DNA strands containing the target segment.

Each displaced strand is then available to anneal with amplification primers as above. The process continues with repeated nicking, extension and displacement of new DNA strands, resulting in exponential amplification of the original DNA target.

Once the nucleic acid has been amplified from the sample, a number of techniques are available for detection of the one or more diagnostic markers described herein.

One such technique is Single Stranded Conformational Polymorphism (SSCP). SCCP detection is based on the aberrant migration of single stranded mutated DNA compared to reference DNA during electrophoresis. Mutation produces conformational change in single stranded DNA, resulting in mobility shift. Fluorescent SCCP uses fluorescent-labelled primers to aid detection. Reference and mutant DNA are thus amplified using fluorescent labelled primers. The amplified DNA is denatured and snap-cooled to produce single stranded DNA molecules, which are examined by non-denaturing gel electrophoresis.

Chemical mismatch cleavage (CMC) is based on the recognition and cleavage of DNA mismatched base pairs by a combination of hydroxylamine, osmium tetroxide and piperidine. Thus, both reference DNA and mutant DNA are amplified with fluorescent labelled primers. The amplicons are hybridised and then subjected to cleavage using Osmium tetroxide, which binds to an mismatched T base, or Hydroxylamine, which binds to mismatched C base, followed by Piperidine which cleaves at the site of a modified base. Cleaved fragments are then detected by electrophoresis.

Techniques based on restriction fragment polymorphisms (RFLPs) can also be used. Although many single nucleotide polymorphisms (SNPs) do not permit conventional RFLP analysis, primer-induced restriction analysis PCR (PIRA-PCR) can be used to introduce restriction sites using PCR primers in a SNP-dependent manner, Primers for PIRA-PCR which introduce suitable restriction sites can be designed by computational analysis, for example as described in Xiaiyi et al., (2001) Bio informatics 17:838-839.

Accordingly, the assays for detection of the one or more diagnostic markers may find use in detection assays that are able to discriminate between mutations—such as enzyme mismatch cleavage methods (e.g. U.S. Pat. Nos. 6,110,684, 5,958,692 and 5,851,770); branched hybridization methods (e.g. U.S. Pat. Nos. 5,849,481, 5,710,264, 5,124,246, and 5,624,802); rolling circle replication (e.g., U.S. Pat. Nos. 6,210,884, 6,183,960 and 6,235,502); NASBA (eg. U.S. Pat. No. 5,409,818); molecular beacon technology (eg. U.S. Pat. No. 6,150,097); E-sensor technology (U.S. Pat. Nos. 6,248,229, 6,221,583, 6,013,170, and 6,063,573); cycling probe technology (eg. U.S. Pat. Nos. 5,403,711, 5,011,769, and 5,660,988); signal amplification methods (eg. U.S. Pat. Nos. 6,121,001, 6,110,677, 5,914,230, 5,882,867, and 5,792,614); ligase chain reaction (Proc. Natl. Acad Sci USA 88, 189-93 (1991)); sandwich hybridization methods (eg. U.S. Pat. No. 5,288,609) and the Invader assay (eg. U.S. Pat. No. 5,888,780).

One skilled in the art is also aware that one or more diagnostic markers may be detected in a protein through the following methods: sequencing, mass spectrometry, by molecular weight, with antibodies, through increased expression of a target gene, by chromosomal coating or by alterations in methylation of DNA patterns. Examples of alterations include a change, loss, or addition of an amino acid, truncation or fragmentation of the protein. Alterations can increase degradation of the protein, can change conformation of the protein, or can be present in a hydrophobic or hydrophilic domain of the protein. The alteration need not be in an active site of the protein to have a deleterious effect on its function or structure, or both. Alteration can include modifications to the protein such as phosphorylation, myristilation, acetylation, or methylation. Sequencing of the protein or a fragment thereof directly by methods well known in the art would identify specific amino acid alterations. Alterations in protein sequences can be detected by analyzing either the entire protein or fragments of the protein and subjecting them to mass spectrometry, which would be able to detect even minor changes in molecular weight. Additionally, antibodies can be used to detect mutations in said proteins if the epitope includes the particular site which has been mutated. Antibodies can be used to detect mutations in the protein by immunoblotting, with in situ methods, or by immunoprecipitation.

Suitably, the method for the detection of one or more diagnostic markers is rapid, repeatable, and/or easy to perform.

### Arrays

A specific method of nucleic acid hybridization that can be utilized is nucleic acid chip/array hybridization in which nucleic acids are present on a immobilized surface—such as a microarray and are subjected to hybridization techniques sensitive enough to detect minor changes in sequences.

As used herein, an “array” includes any two-dimensional or substantially two-dimensional (as well as a three-dimensional) arrangement of addressable regions bearing a particular chemical moiety or moieties (e.g., biopolymers—such as polynucleotide or oligonucleotide sequences (nucleic acids), polypeptides (e.g., proteins), carbohydrates, lipids, etc.). The array may be an array of polymeric binding agents—such as polypeptides, proteins, nucleic acids, polysaccharides or synthetic mimetics. Typically, the array is an array of nucleic acids, including oligonucleotides, polynucleotides, cDNAs, mRNAs, synthetic mimetics thereof, and the like. Where the arrays are arrays of nucleic acids, the nucleic acids may be covalently attached to the arrays at any point along the nucleic acid chain, but are generally attached at one of their termini (e.g. the 3′ or 5′ terminus). Sometimes, the arrays are arrays of polypeptides, e.g., proteins or fragments thereof.

Array technology and the various techniques and applications associated with it is described generally in numerous textbooks and documents. These include Lemieux et al., 1998, Molecular Breeding 4, 277-289, Schena and Davis. Parallel Analysis with Biological Chips. in PCR Methods Manual (eds. M. Innis, D. Gelfand, J. Sninsky), Schena and Davis, 1999, Genes, Genomes and Chips. In DNA Microarrays: A Practical Approach (ed. M. Schena), Oxford University Press, Oxford, UK, 1999), The Chipping Forecast (Nature Genetics special issue; January 1999 Supplement), Mark Schena (Ed.), Microarray Biochip Technology, (Eaton Publishing Company), Cortes, 2000, The Scientist 14[17]:25, Gwynne and Page; Microarray analysis: the next revolution in molecular biology, Science, 1999 Aug. 6; and Eakins and Chu, 1999, Trends in Biotechnology, 17, 217-218.

Array technology overcomes the disadvantages with traditional methods in molecular biology, which generally work on a “one gene in one experiment” basis, resulting in low throughput and the inability to appreciate the “whole picture” of gene function. A major application for array technology in the context of the present invention is the identification of one or more diagnostic markers (eg. one or more single nucleotide polymorphisms).

In general, any library may be arranged in an orderly manner into an array, by spatially separating the members of the library. Examples of suitable libraries for arraying include nucleic acid libraries (including DNA, cDNA, oligonucleotide, etc libraries), peptide, polypeptide and protein libraries, as well as libraries comprising any molecules, such as ligand libraries, among others.

The samples (e.g., members of a library) are generally fixed or immobilised onto a solid phase, preferably a solid substrate, to limit diffusion and admixing of the samples. In a preferred embodiment, libraries of DNA binding ligands may be prepared. In particular, the libraries may be immobilised to a substantially planar solid phase, including membranes and non-porous substrates such as plastic and glass. Furthermore, the samples are preferably arranged in such a way that indexing (i.e., reference or access to a particular sample) is facilitated. Typically the samples are applied as spots in a grid formation. Common assay systems may be adapted for this purpose. For example, an array may be immobilised on the surface of a microplate, either with multiple samples in a well, or with a single sample in each well. Furthermore, the solid substrate may be a membrane, such as a nitrocellulose or nylon membrane (for example, membranes used in blotting experiments). Alternative substrates include glass, or silica based substrates. Thus, the samples are immobilised by any suitable method known in the art, for example, by charge interactions, or by chemical coupling to the walls or bottom of the wells, or the surface of the membrane. Other means of arranging and fixing may be used, for example, pipetting, drop-touch, piezoelectric means, ink-jet and bubblejet technology, electrostatic application, etc. In the case of silicon-based chips, photolithography may be utilised to arrange and fix the samples on the chip.

The samples may be arranged by being “spotted” onto the solid substrate; this may be done by hand or by making use of robotics to deposit the sample. In general, arrays may be described as macroarrays or microarrays, the difference being the size of the sample spots. Macroarrays typically contain sample spot sizes of about 300 microns or larger and may be easily imaged by existing gel and blot scanners. The sample spot sizes in microarrays are typically less than 200 microns in diameter and these arrays usually contain thousands of spots. Thus, microarrays may require specialized robotics and imaging equipment, which may need to be custom made. Instrumentation is described generally in a review by Cortese, 2000, The Scientist 14[11]:26. The number of distinct nucleic acid sequences, and hence spots or similar structures (i.e., array features), present on the array may vary, but is generally at least 2, usually at least 5 and more usually at least 10, where the number of different spots on the array may be as a high as 50, 100, 500, 1000, 10,000 or higher, depending on the intended use of the array. The spots of distinct nucleic acids present on the array surface are generally present as a pattern, where the pattern may be in the form of organized rows and columns of spots, e.g., a grid of spots, across the substrate surface, a series of curvilinear rows across the substrate surface, e.g., a series of concentric circles or semi-circles of spots, and the like. The density of spots present on the array surface may vary, but will generally be at least about 10 and usually at least about 100 spots/cm², where the density may be as high as 10⁶ or higher, but will generally not exceed about 10⁵ spots/cm².

Techniques for producing immobilised libraries of DNA molecules have been described in the art. Generally, most prior art methods described how to synthesise single-stranded nucleic acid molecule libraries, using for example masking techniques to build up various permutations of sequences at the various discrete positions on the solid substrate. U.S. Pat. No. 5,837,832, the contents of which are incorporated herein by reference, describes an improved method for producing DNA arrays immobilised to silicon substrates based on very large scale integration technology. In particular, U.S. Pat. No. 5,837,832 describes a strategy called “tiling” to synthesize specific sets of probes at spatially-defined locations on a substrate which may be used to produced the immobilised DNA libraries of the present invention. U.S. Pat. No. 5,837,832 also provides references for earlier techniques that may also be used.

The array will include at least one probe, and typically a plurality of different probes of different sequence (e.g., at least about 10, usually at least about 50, such as at least about 100, 1000, 5000, or 10,000 or more) immobilized on, e.g., covalently or non-covalently attached to, different and known locations on the substrate surface. The arrays described herein will typically have at least one probe that can be used for the identification of the one or more diagnostic markers described herein.

In one specific embodiment, the arrays described herein will have at least one probe that can be used for the identification of the one or more single nucleotide polymorphisms described herein.

Arrays of peptides (or peptidomimetics) may also be synthesised on a surface in a manner that places each distinct library member (e.g., unique peptide sequence) at a discrete, predefined location in the array. The identity of each library member is determined by its spatial location in the array. The locations in the array where binding interactions between a predetermined molecule (e.g., a target or probe) and reactive library members occur is determined, thereby identifying the sequences of the reactive library members on the basis of spatial location. These methods are described in U.S. Pat. No. 5,143,854; WO90/15070 and WO92/10092; Fodor et al. (1991) Science, 251: 767; Dower and Fodor (1991) Ann. Rep. Med. Chem., 26: 271.

To aid detection, targets and probes may be labelled with any readily detectable reporter, for example, a fluorescent, bioluminescent, phosphorescent, radioactive, etc reporter. Such reporters, their detection, coupling to targets/probes, etc are discussed elsewhere in this document. Labelling of probes and targets is also disclosed in Shalon et al., 1996, Genome Res 6(7):639-45

Specific examples of DNA arrays are as follow:

Format I: probe cDNA (500˜5,000 bases long) is immobilized to a solid surface such as glass using robot spotting and exposed to a set of targets either separately or in a mixture. This method is widely considered as having been developed at Stanford University (Ekins and Chu, 1999, Trends in Biotechnology, 1999, 17, 217-218).

Format II: an array of oligonucleotide (20˜25-mer oligos) or peptide nucleic acid (PNA) probes is synthesized either in situ (on-chip) or by conventional synthesis followed by on-chip immobilization. The array is exposed to labeled sample DNA, hybridized, and the identity/abundance of complementary sequences are determined. Such a DNA chip is sold by Affymetrix, Inc., under the GeneChip® trademark.

Data analysis is also an important part of an experiment involving arrays. The raw data from a microarray experiment typically are images, which need to be transformed into gene expression matrices—tables where rows represent for example genes, columns represent for example various samples such as tissues or experimental conditions, and numbers in each cell for example characterize the expression level of the particular gene in the particular sample. These matrices have to be analyzed further, if any knowledge about the underlying biological processes is to be extracted. Methods of data analysis (including supervised and unsupervised data analysis as well as bioinformatics approaches) are disclosed in Brazma and Vilo J (2000) FEBS Lett 480(1):17-24.

As disclosed above, proteins, polypeptides, etc may also be immobilised in arrays. For example, antibodies have been used in microarray analysis of the proteome using protein chips (Borrebaeck C A, 2000, Immunol Today 21(8):379-82). Polypeptide arrays are reviewed in, for example, MacBeath and Schreiber, 2000, Science, 289(5485): p. 1760-1763.

The arrays described herein may find use in a variety of applications, where such applications are generally analyte detection applications in which the presence of a particular analyte in a given sample is detected at least qualitatively, if not quantitatively. Protocols for carrying out such assays are well known to those skilled in the art. Generally, the sample which is to be tested for the presence of the one or more diagnostic markers is contacted with the array described herein under conditions sufficient for the analyte to bind to its respective binding pair member that is present on the array. Thus, if the analyte of interest is present in the sample, it binds to the array at the site of its complementary binding member and a complex is formed on the array surface. The presence of this binding complex on the array surface is then detected. The presence of the analyte in the sample is then deduced from the detection of binding complexes on the substrate surface.

Specific analyte detection applications include hybridization assays in which nucleic acid arrays are employed. In these assays, a sample of nucleic acid from a subject is first prepared. A collection of labelled control targets may also be included in the sample, where the collection may be made up of control targets that are all labelled with the same label or two or more sets that are distinguishably labelled with different labels. Following sample preparation, the sample is contacted with the array under hybridization conditions, whereby complexes are formed between the nucleic acids that are complementary to the probe sequences attached to the array surface. The presence of hybridized complexes is then detected.

In one embodiment, the SNPs are detected using the BeadXpress Reader System (Illumina Inc., North America). See for example, U.S. Pat. No. 6,355,431. This system is a high-throughput, dual-colour laser detection system that enables scanning of a broad range of multiplexed assays developed using the VeraCode digital microbead technology. Unique VeraCode microbeads are scanned for their code and fluorescent signals, generating highly robust data quickly and efficiently. Downstream analysis is conductedusing Illumina's BeadStudio data analysis software or other third-party analysis programs.

### Sample

The sample may be or may be derived from a biological sample.

The sample may be or may be derived from an in vitro sample.

Biological samples may be provided by obtaining a blood sample, a biopsy specimen, a tissue explant, an organ culture or any other tissue or cell preparation from a subject or a biological source.

The biological sample may be or may be derived from whole blood or a fraction of whole blood.

Suitably, the sample is nucleic acid—such as DNA and/or RNA and/or genomic DNA and/or total RNA.

### Subject

The subject may be a born or an unborn human.

In one embodiment, the subject is unborn (eg. a foetus) in which is intended that the severity of the one or more of the diseases described herein is to be determined before birth. Accordingly, the sample may be from a foetus such that the methods described herein can be of use in the prenatal setting.

Prenatal or antenatal diagnosis or testing is commonly used to diagnose abnormalities in the foetus, such as the presence of chromosomal translocations, deletions, amplifications, mutations or an extra, missing or rearranged chromosome.

Foetal cells for analysis can be obtained by amniocentesis, chorionic villus sampling (CVS), or drawing blood from the foetal umbilical cord. Amniocentesis is the most commonly used method to collect foetal cells. The procedure is usually performed in the 15th week of pregnancy or later, but can sometimes be performed as early as the 11th week. A needle is inserted through the mother's abdominal wall and foetal cells (amniocytes) are removed from the amniotic sac (the fluid-filled sack surrounding the foetus).

High-quality DNA for prenatal diagnosis can be obtained from chorionic villi samples, fetal blood, or amniotic fluid. Adequate amounts of DNA can be extracted from amniotic fluid cells beginning at 8 weeks gestation, and these samples are suitable for prenatal diagnosis using methods—such as PCR.

The options for the prenatal detection of chromosomal abnormalities are mainly limited to invasive methods with a small but finite risk for fetal loss. The most common method for detection of abnormalities is amniocentesis. However, because amniocentisis is an invasive method it is generally performed only on older mothers where the risk of a fetus presenting with chromosomal abnormalities is increased. It is therefore beneficial to establish non-invasive methods for the diagnosis of fetal chromosomal abnormalities that can be used on larger population of prospective mothers. One such non-invasive method has been described in U.S. Pat. No. 4,874,693, which discloses a method for detecting placental dysfunction indicative of chromosomal abnormalities by monitoring the maternal levels of human chorionic gonadotropin hormone (HCG).

In another embodiment, the subject is born. The born subject may be a sufferer of one or more of the diseases described herein or may be a carrier of the disease, without suffering from the disease.

The born subject(s) may be a male subject and a female subject that intend to conceive a child. According to this embodiment of the invention, the severity of the disease of their child may be predicted by detecting one or more of the markers described herein in each of the male and female subjects. By assessing which markers are present/absent in each of the male and female subjects it may be possible to predict the severity of the disease in their child if the child has inherited the said markers from the parents.

The born subject(s) may be a male subject and a female subject that have conceived a child. According to this embodiment of the invention, the severity of the disease of their child may be determined by detecting one or more of the markers described herein in each of the male and female subjects. By assessing which markers are present/absent in each of the male and female subjects it may be possible to determine the severity of the disease in their child.

Such determinations may have prognostic and/or diagnostic usefulness.

Where it is desirable to determine whether or not a subject or biological source falls within clinical parameters that are indicative of disease, signs and symptoms of disease that are accepted by those skilled in the art may be used to so designate a subject or biological source as suffering from the disease.

The subject or biological source may be suspected of having or being at risk for having disease, and in certain embodiments the subject or biological source may be known to be free of a risk or presence of such a disease.

### Nucleic Acid Molecules

Unless the context indicates otherwise, nucleic acid molecules disclosed herein may have one or more of the following characteristics: (1) They may be DNA or RNA (including variants of naturally occurring DNA or RNA structures, which have non-naturally occurring bases and/or non-naturally occurring backbones); (2) They may be single-stranded or double-stranded (or in some cases higher stranded, e.g. triple-stranded); (3) They may be provided in recombinant form i.e. covalently linked to a heterologous 5′ and/or 3′ flanking sequence to provide a chimeric molecule (e.g. a vector) that does not occur in nature; (4) They may be provided with or without 5′ and/or 3′ flanking sequences that normally occur in nature; (5) They may be provided in substantially pure form, e.g. by using probes to isolate cloned molecules having a desired target sequence or by using chemical synthesis techniques. Thus they may be provided in a form that is substantially free from contaminating proteins and/or from other nucleic acids; (6) They may be provided with introns (e.g. as a full-length gene) or without introns (e.g. as DNA); and/or (7) They may be provided in linear or non-linear (e.g. circular) form.

### Hybridising Nucleic Acid Molecules

Nucleic acid molecules that can hybridise to one or more of the nucleic acid molecules discussed above are also described herein. Such nucleic acid molecules are referred to herein as “hybridising” nucleic acid molecules. Desirably hybridising molecules are at least 10 nucleotides in length and preferably are at least 20, at least 50, at least 100, or at least 200 nucleotides in length.

The greater the degree of sequence identity that a given single stranded nucleic acid molecule has with a strand of a nucleic acid molecule, the greater the likelihood that it will hybridise to the complement of said strand.

Hybridising nucleic acid molecules can be useful as probes or primers, for example.

Hybridising molecules also include antisense strands. These hybridise with “sense” strands so as to inhibit transcription and for translation. An antisense strand can be synthesised based upon knowledge of a sense strand and base pairing rules. It may be exactly complementary with a sense strand, although it should be noted that exact complementarity is not always essential. It may also be produced by genetic engineering, whereby a part of a DNA molecule is provided in an antisense orientation relative to a promoter and is then used to transcribe RNA molecules. Large numbers of antisense molecules can be provided (e.g. by cloning, by transcription, by PCR, by reverse PCR, etc.

Hybridising molecules include ribozymes. Ribozymes can also be used to regulate expression by binding to and cleaving RNA molecules that include particular target sequences recognised by the ribozymes. Ribozymes can be regarded as special types of antisense molecule. They are discussed, for example, by Haselhoff and Gerlach (Nature (1988) 334:585-91).

Antisense molecules may be DNA or RNA molecules. They may be used in antisense therapy to prevent or reduce undesired expression or activity. Antisense molecules may be administered directly to a patient (e.g. by injection). Alternatively, they may be synthesised in situ via a vector that has been administered to a patient.

Preferred are sequences, probes and primers which hybridise under high-stringency conditions such that they hybridise specifically.

Stringency of hybridisation refers to conditions under which polynucleic acids hybrids are stable. Such conditions are evident to those of ordinary skill in the field. As known to those of skill in the art, the stability of hybrids is reflected in the melting temperature (Tm) of the hybrid which decreases approximately 1 to 1.5° C. with every 1% decrease in sequence homology. In general, the stability of a hybrid is a function of sodium ion concentration and temperature.

As used herein, high stringency refers to conditions that permit hybridisation of only those nucleic acid sequences that form stable hybrids in 1 M Na+ at 65-68° C. High stringency conditions can be provided, for example, by hybridisation in an aqueous solution containing 6×SSC, 5×Denhardt's, 1% SDS (sodium dodecyl sulphate), 0.1 Na+ pyrophosphate and 0.1 mg/ml denatured salmon sperm DNA as non specific competitor.

It is understood that these conditions may be adapted and duplicated using a variety of buffers, e.g. formamide-based buffers, and temperatures. Denhardt's solution and SSC are well known to those of skill in the art as are other suitable hybridisation buffers (see, e.g. Sambrook, et al., eds. (1989) Molecular Cloning: A Laboratory Manual, Cold Spring Harbor Laboratory Press, New York or Ausubel, et al., eds. (1990) Current Protocols in Molecular Biology, John Wiley & Sons, Inc.). Optimal hybridisation conditions have to be determined empirically, as the length and the GC content of the hybridising pair also play a role.

### Vectors

The nucleic acid molecules described here may be provided in the form of vectors. Vectors comprising such nucleic acid include plasmids, phasmids, cosmids, viruses (including bacteriophages), YACs, PACs, etc. They will usually include an origin of replication and may include one or more selectable markers e.g. drug resistance markers and/or markers enabling growth on a particular medium. A vector may include a marker that is inactivated when a nucleic acid molecule, such as the ones described here, is inserted into the vector.

Vectors may include one or more regions necessary for transcription of RNA encoding a polypeptide. Such vectors are often referred to as expression vectors. They will usually contain a promoter and may contain additional regulatory regions—e.g. operator sequences, enhancer sequences, etc. Translation can be provided by a host cell or by a cell free expression system.

Vectors need not be used for expression. They may be provided for maintaining a given nucleic acid sequence, for replicating that sequence, for manipulating, it or for transferring it between different locations (e.g. between different organisms).

Large nucleic acid molecules may be incorporated into high capacity vectors (e.g. cosmids, phasmids, YACs or PACs). Smaller nucleic acid molecules may be incorporated into a wide variety of vectors.

### Cells

Cells comprising nucleic acid molecules or vectors are also described. These may for example be used for expression, as described herein. A cell capable of expressing a polypeptide described here can be cultured and used to provide the polypeptide, which can then be purified.

Such cells may be provided in any appropriate form. For example, they may be provided in isolated form, in culture, in stored form, etc. Storage may, for example, involve cryopreservation, buffering, sterile conditions, etc.

### Modulating

As used herein, the term “modulating” in the context of severity of disease refers, in one embodiment, to reducing, decreasing, suppressing, or otherwise affecting the severity of the diseases described herein—such as reducing, decreasing, suppressing, or otherwise affecting one or more of the symptoms associated with the diseases described herein

### Primer

The term “primer” as used herein refers to an oligonucleotide, whether occurring naturally as in a purified restriction digest or produced synthetically, which is capable of acting as a point of initiation of synthesis when placed under conditions in which synthesis of a primer extension product which is complementary to a nucleic acid strand is induced, i.e. in the presence of nucleotides and an inducing agent—such as DNA polymerase and at a suitable temperature and pH. The primer is preferably single stranded for maximum efficiency in amplification, but may alternatively be double stranded. If double stranded, the primer is first treated to separate its strands before being used to prepare extension products. Preferably, the primer is an oligodeoxyribonucleotide. The primer must be sufficiently long to prime the synthesis of extension products in the presence of the inducing agent. The exact lengths of the primers will depend on many factors, including temperature, source of primer and use of the method. For example, for diagnostics applications, depending on the complexity of the target sequence, the oligonucleotide primer typically contains 15-25 or more nucleotides, although it may contain fewer nucleotides. For other applications, the oligonucleotide primer is typically shorter, e.g., 7-15 nucleotides. For other applications, the probes may be at least 10 nucleotides, at least 20 nucleotides, or at least 30 nucleotides in length.

### Probe

As used herein, the term “probe” refers to a nucleic acid (eg. an oligonucleotide or a polynucleotide sequence) that is complementary to a nucleic acid sequence present in a sample such that the probe will specifically hybridize to the nucleic acid sequence present in the sample under appropriate conditions. The nucleic acid probes are typically associated with a support or substrate to provide an array of nucleic acid probes to be used in an array assay. Suitably, the probe is pre-synthesized or obtained commercially, and then attached to the substrate or synthesized on the substrate, i.e synthesized in situ on the substrate.

Nucleic acids—such as the primers and/or the probes—may be labelled in order to facilitate their detection. Such labels (also known as reporters) include, but are not limited to, radioactive isotopes, fluorophores, chemiluminescent moieties, enzymes, enzyme substrates, enzyme cofactors, enzyme inhibitors, dyes, metal ions, metal sols, other suitable detectable markers—such as biotin or haptens and the like. Particular example of labels which may be used include, but are not limited to, fluorescein, 5(6)-carboxyfluorescein, Cyanine 3 (Cy3), Cyanine 5 (Cy5), rhodamine, dansyl, umbelliferone, Texas red, luminal, NADPH and horseradish peroxidase.

Suitably, the probes are at least 10 nucleotides, at least 20 nucleotides, at least 30 nucleotides or at least 40 nucleotides in length.

### Assay Method

There is also described an assay method for identifying one or more agents that modulate the severity of a disease attributed to at least one genetic mutation effecting one or more of the genes encoding haemoglobin polypeptide chains.

According to this aspect of the invention, one or more agents that modulate the expression of the genes described herein or the activity of the protein encoded thereby are identified.

Screening for Compounds which Bind the Protein Expressed by the Gene

A plurality of candidate compounds may be screened using the methods described below. In particular, these methods may be suited for screening libraries of compounds.

Where the candidate compounds are proteins, in particular antibodies or peptides, libraries of candidate compounds can be screened using phage display techniques. Phage display is a protocol of molecular screening which utilises recombinant bacteriophage. The technology involves transforming bacteriophage with a gene that encodes the library of candidate compounds, such that each phage or phagemid expresses a particular candidate compound. The transformed bacteriophage (which preferably is tethered to a solid support) expresses the appropriate candidate compound and displays it on their phage coat. Specific candidate compounds which are capable of interacting with the protein expressed by the gene are enriched by selection strategies based on affinity interaction. The successful candidate agents are then characterised. Phage display has advantages over standard affinity ligand screening technologies. The phage surface displays the candidate agent in a three dimensional configuration, more closely resembling its naturally occurring conformation. This allows for more specific and higher affinity binding for screening purposes.

The yeast two-hybrid system may also be used to screen for polypeptides. For example, a human cDNA from a tissue may be substituted with a cDNA library from a different tissue or species, or a combinatorial library of synthetic oligonucleotides.

Another method of screening a library of compounds utilises eukaryotic or prokaryotic host cells which are stably transformed with recombinant DNA molecules expressing the library of compounds. Such cells, either in viable or fixed form, can be used for standard binding-partner assays. See also Parce et al. (1989) Science 246:243-247; and Owicki et al. (1990) Proc. Nat'l Acad. Sci. USA 87; 4007-4011, which describe sensitive methods to detect cellular responses. Competitive assays are particularly useful, where the cells expressing the library of compounds are incubated with a labelled antibody, such as ¹²⁵I-antibody, and a test sample such as a candidate compound whose binding affinity to the protein expressed by the gene is being measured. The bound and free labelled binding partners are then separated to assess the degree of binding. The amount of test sample bound is inversely proportional to the amount of labelled antibody bound.

Any one of numerous techniques can be used to separate bound from free binding partners to assess the degree of binding. This separation step could typically involve a procedure such as adhesion to filters followed by washing, adhesion to plastic following by washing, or centrifugation of the cell membranes.

Still another approach is to use solubilized, unpurified or solubilized purified protein either extracted from expressing mammalian cells or from transformed eukaryotic or prokaryotic host cells. This allows for a “molecular” binding assay with the advantages of increased specificity, the ability to automate, and high drug test throughput.

Another technique for candidate compound screening involves an approach which provides high throughput screening for new compounds having suitable binding affinity and is described in WO 84/03564. First, large numbers of different small peptide test compounds are synthesised on a solid substrate, e.g., plastic pins or some other appropriate surface; see Fodor et al. (1991). Then all the pins are reacted with solubilized protein and washed. The next step involves detecting bound protein. Detection may be accomplished using a monoclonal antibody to the protein of interest. Compounds which interact specifically with the protein may thus be identified.

Rational design of candidate compounds likely to be able to interact with the protein may be based upon structural studies of the molecular shapes of the protein and/or its in vivo binding partners. One means for determining which sites interact with specific other proteins is a physical structure determination, e.g., X-ray crystallography or two-dimensional NMR techniques. These will provide guidance as to which amino acid residues form molecular contact regions. For a detailed description of protein structural determination, see, e.g., Blundell and Johnson (1976) Protein Crystallography, Academic Press, New York.

Screening for Compounds which Modulate the Activity of a Protein Expressed by the Gene

As mentioned above, the compound may modulate the capacity of the protein to interact with an in vivo binding partner. Once the in vivo binding partner has been identified, there are a number of methods known in the art by which compounds may be screened for their capacity to modulate the interaction between the protein and its binding partner, or the physiological effect of the interaction.

For example, in vitro competitive binding assays using either immobilised protein or binding partner (see above) can be used to investigate the capacity of a library of test compounds to inhibit or enhance the protein:binding partner interaction.

Alternatively, the yeast two-hybrid system as described above can be used to identify compounds which affect the protein:binding partner interaction. For example, a first fusion protein (comprising the DNA binding domain of a transcription activating factor and the protein) and a second fusion protein (comprising the transcription activating domain and the binding partner) may be expressed in a yeast cell. When the protein:binding partner interaction takes place, transcription of a reporter gene under the transcriptional control of the transcriptional activator is initiated. Compounds which increase or decrease reporter expression relative to a user-defined threshold (for example, a five-fold increase or five-fold decrease) are thus identified as being modulators of the interaction.

Modulation of the interaction can be measured by examining the changes in the physiological effect mediated by the interaction, as described below.

Screening for Compounds which Modulate the Expression of a Protein Expressed by the Gene

There are numerous methods suitable for measuring the expression of a protein, by measuring expression of the gene or the protein.

Gene expression may be measured using the polymerase chain reaction (PCR), for example using RT-PCR. RT-PCR may be a useful technique where the candidate compound is designed to block the transcription of the gene. Alternatively, the presence or amount of mRNA can be detected using Northern blot. Northern blotting techniques are particularly suitable if the candidate compound is designed to act by causing degradation of the mRNA. For example, if the candidate compound is an antisense sequence, which may cause the target mRNA to be degraded by enzymes such as RNAse H.

Protein expression may be detected or measured by a number of known techniques, including Western blotting, immunoprecipitation, immunocytochemisty techniques, immunohistochemistry, in situ hybridisation, ELISA, radio-immunolabelling, fluorescent labelling techniques (fluorimetry, confocal microscopy) and spectrophotometry.

For a general reference on screening, see the Handbook of Drug Screening, edited by Ramakrishna Seethala, Prabhavathi B. Fernandes. New York, N.Y., Marcel Dekker, 2001 (ISBN 0-8247-0562-9).

It is expected that the assay methods of the present invention will be suitable for both small and large-scale screening of agents as well as in quantitative assays.

A plurality of agents may be screened using the methods described.

The agent may be an organic compound or other chemical. The agent may be a compound, which is obtainable from or produced by any suitable source, whether natural or artificial. The agent may be an amino acid molecule, a polypeptide, or a chemical derivative thereof, or a combination thereof. The agent may even be a polynucleotide molecule—which may be a sense or an anti-sense molecule, or an antibody, for example, a polyclonal antibody, a monoclonal antibody or a monoclonal humanised antibody.

Various strategies have been developed to produce monoclonal antibodies with human character, which bypasses the need for an antibody-producing human cell line. For example, useful mouse monoclonal antibodies have been “humanised” by linking rodent variable regions and human constant regions (Winter, G. and Milstein, C. (1991) Nature 349, 293-299). This reduces the human anti-mouse immunogenicity of the antibody but residual immunogenicity is retained by virtue of the foreign V-region framework. Moreover, the antigen-binding specificity is essentially that of the murine donor. CDR-grafting and framework manipulation (EP 0239400) has improved and refined antibody manipulation to the point where it is possible to produce humanised murine antibodies which are acceptable for therapeutic use in humans. Humanised antibodies may be obtained using other methods well known in the art (for example as described in U.S. Pat. No. 239,400).

The agents may be attached to an entity (e.g. an organic molecule) by a linker which may be a hydrolysable bifunctional linker.

The entity may be designed or obtained from a library of compounds, which may comprise peptides, as well as other compounds, such as small organic molecules.

By way of example, the entity may be a natural substance, a biological macromolecule, or an extract made from biological materials such as bacteria, fungi, or animal (particularly mammalian) cells or tissues, an organic or an inorganic molecule, a synthetic agent, a semi-synthetic agent, a structural or functional mimetic, a peptide, a peptidomimetics, a peptide cleaved from a whole protein, or a peptides synthesised synthetically (such as, by way of example, either using a peptide synthesizer or by recombinant techniques or combinations thereof, a recombinant agent, an antibody, a natural or a non-natural agent, a fusion protein or equivalent thereof and mutants, derivatives or combinations thereof.

Typically, the entity will be an organic compound. For some instances, the organic compounds will comprise two or more hydrocarbyl groups. Here, the term “hydrocarbyl group” means a group comprising at least C and H and may optionally comprise one or more other suitable substituents. Examples of such substituents may include halo-, alkoxy-, nitro-, an alkyl group, a cyclic group etc. In addition to the possibility of the substituents being a cyclic group, a combination of substituents may form a cyclic group. If the hydrocarbyl group comprises more than one C then those carbons need not necessarily be linked to each other. For example, at least two of the carbons may be linked via a suitable element or group. Thus, the hydrocarbyl group may contain hetero atoms. Suitable hetero atoms will be apparent to those skilled in the art and include, for instance, sulphur, nitrogen and oxygen. For some applications, preferably the entity comprises at least one cyclic group. The cyclic group may be a polycyclic group, such as a non-fused polycyclic group. For some applications, the entity comprises at least the one of said cyclic groups linked to another hydrocarbyl group.

The entity may contain halo groups—such as fluoro, chloro, bromo or iodo groups.

The entity may contain one or more of alkyl, alkoxy, alkenyl, alkylene and alkenylene groups—which may be unbranched- or branched-chain.

The agent may comprise one or more antisense compounds, including antisense RNA (eg. siRNA and the like) and antisense DNA, which are capable of reducing the level of expression of the protein in the cell which is exposed to the drug. Preferably, the antisense compounds comprise sequences complementary to the mRNA encoding the protein.

Suitably, the antisense compounds are oligomeric antisense compounds, particularly oligonucleotides. The antisense compounds preferably specifically hybridize with one or more nucleic acids encoding the protein. As used herein, the term “nucleic acid encoding protein” encompasses DNA encoding the protein, RNA (including pre-mRNA and mRNA) transcribed from such DNA, and also cDNA derived from such RNA. The specific hybridization of an oligomeric compound with its target nucleic acid interferes with the normal function of the nucleic acid. This modulation of function of a target nucleic acid by compounds which specifically hybridize to it is generally referred to as “antisense”. The functions of DNA to be interfered with include replication and transcription. The functions of RNA to be interfered with include all vital functions such as, for example, translocation of the RNA to the site of protein translation, translation of protein from the RNA, splicing of the RNA to yield one or more mRNA species, and catalytic activity which may be engaged in or facilitated by the RNA. The overall effect of such interference with target nucleic acid function is modulation of the expression of the protein.

Antisense constructs are described in detail in U.S. Pat. No. 6,100,090 (Monia et al), and Neckers et al., 1992, Crit. Rev Oncog 3(1-2):175-231, the teachings of which document are specifically incorporated by reference.

Having identified one or more agents that modulate the expression of the gene(s) or the protein encoded thereby, the effect of the agent on F cell production can be determined.

Typically, the one or more agents can be tested on non-human animals—such as non-human primates, sheep and transgenic mice comprising the human β globin locus—and their effect on F cell production determined by obtaining blood samples at one or more intervals following exposure to the agent(s). Typically, blood samples are collected in EDTA and the F cells identified and quantified using methods that are known in the art. By way of example, F cells may be measured using flow cytometry of cells using a monoclonal anti-γ globin chain antibody conjugated with a label (eg. a fluorescent label)—such as FITC. Quantifying Hb F can typically be achieved using a monoclonal antibody against γ chains of HbF (α₂γ₂).

Suitably, an agent that increases F cell production in the non-human animals following exposure to the one or more agent(s) as compared to the F cell production before exposure to the one or more agent(s) is indicative that said agent can modulate the severity of disease(s) attributed to at least one genetic mutation effecting one or more of the genes encoding haemoglobin polypeptide chains.

### Sequence Identity or Sequence Homology

The use of sequences having a degree of sequence identity or sequence homology with amino acid sequence(s) of a polypeptide having the specific properties defined herein or of any nucleotide sequence encoding such a polypeptide (hereinafter referred to as a “homologous sequence(s)”) is also contemplated. Here, the term “homologue” means an entity having a certain homology with the subject amino acid sequences (eg. the amino acid sequence corresponding to the protein encoded by the BCL11A and/or MYB and/or HBS1L genes) and the subject nucleotide sequences (eg. the nucleotide sequence encoding the BCL11A and/or MYB and/or HBS1L genes). Here, the term “homology” can be equated with “identity”.

The homologous amino acid sequence and/or nucleotide sequence should provide and/or encode a polypeptide which retains the functional activity and/or enhances the activity of the enzyme.

In the present context, a homologous sequence is taken to include an amino acid sequence which may be at least 70, 75, 85 or 90% identical, preferably at least 95 or 98% identical to the subject sequence. Typically, the homologues will comprise the same active sites etc. as the subject amino acid sequence. Although homology can also be considered in terms of similarity (i.e. amino acid residues having similar chemical properties/functions), in the context of the present invention it is preferred to express homology in terms of sequence identity.

In the present context, a homologous sequence is taken to include a nucleotide sequence which may be at least 75, 85 or 90% identical, preferably at least 95 or 98% identical to a nucleotide sequence encoding a polypeptide of the present invention (the subject sequence). Typically, the homologues will comprise the same sequences that code for the active sites etc. as the subject sequence. Although homology can also be considered in terms of similarity (i.e. amino acid residues having similar chemical properties/functions), in the context of the present invention it is preferred to express homology in terms of sequence identity.

Homology comparisons can be conducted by eye, or more usually, with the aid of readily available sequence comparison programs. These commercially available computer programs can calculate % homology between two or more sequences.

% homology may be calculated over contiguous sequences, i.e. one sequence is aligned with the other sequence and each amino acid in one sequence is directly compared with the corresponding amino acid in the other sequence, one residue at a time. This is called an “ungapped” alignment. Typically, such ungapped alignments are performed only over a relatively short number of residues.

Although this is a very simple and consistent method, it fails to take into consideration that, for example, in an otherwise identical pair of sequences, one insertion or deletion will cause the following amino acid residues to be put out of alignment, thus potentially resulting in a large reduction in % homology when a global alignment is performed. Consequently, most sequence comparison methods are designed to produce optimal alignments that take into consideration possible insertions and deletions without penalising unduly the overall homology score. This is achieved by inserting “gaps” in the sequence alignment to try to maximise local homology.

However, these more complex methods assign “gap penalties” to each gap that occurs in the alignment so that, for the same number of identical amino acids, a sequence alignment with as few gaps as possible—reflecting higher relatedness between the two compared sequences—will achieve a higher score than one with many gaps. “Affine gap costs” are typically used that charge a relatively high cost for the existence of a gap and a smaller penalty for each subsequent residue in the gap. This is the most commonly used gap scoring system. High gap penalties will of course produce optimised alignments with fewer gaps. Most alignment programs allow the gap penalties to be modified. However, it is preferred to use the default values when using such software for sequence comparisons.

Calculation of maximum % homology therefore firstly requires the production of an optimal alignment, taking into consideration gap penalties. A suitable computer program for carrying out such an alignment is the Vector NTI (Invitrogen Corp.). Examples of software that can perform sequence comparisons include, but are not limited to, the BLAST package (see Ausubel et al 1999 Short Protocols in Molecular Biology, 4th Ed—Chapter 18), BLAST 2 (see FEMS Microbiol Lett 1999 174(2): 247-50; FEMS Microbiol Lett 1999 177(1): 187-8 and tatiana@ncbi.nlm.nih.gov), FASTA (Altschul et al 1990 J. Mol. Biol. 403-410) and AlignX for example. At least BLAST, BLAST 2 and FASTA are available for offline and online searching (see Ausubel et al 1999, pages 7-58 to 7-60).

Although the final % homology can be measured in terms of identity, the alignment process itself is typically not based on an all-or-nothing pair comparison. Instead, a scaled similarity score matrix is generally used that assigns scores to each pairwise comparison based on chemical similarity or evolutionary distance. An example of such a matrix commonly used is the BLOSUM62 matrix—the default matrix for the BLAST suite of programs. Vector NTI programs generally use either the public default values or a custom symbol comparison table if supplied (see user manual for further details). For some applications, it is preferred to use the default values for the Vector NTI package.

Alternatively, percentage homologies may be calculated using the multiple alignment feature in Vector NTI (Invitrogen Corp.), based on an algorithm, analogous to CLUSTAL (Higgins DG & Sharp PM (1988), Gene 73(1), 237-244).

Once the software has produced an optimal alignment, it is possible to calculate % homology, preferably % sequence identity. The software typically does this as part of the sequence comparison and generates a numerical result.

Should Gap Penalties be used when determining sequence identity, then preferably the following parameters are used for pairwise alignment:

| FOR BLAST | |
|---|---|
| GAP OPEN | 0 |
| GAP EXTENSION | 0 |

| FOR CLUSTAL | DNA | PROTEIN | |
|---|---|---|---|
| WORD SIZE | 2 | 1 | K triple |
| GAP PENALTY | 15 | 10 | |
| GAP EXTENSION | 6.66 | 0.1 | |

In one embodiment, CLUSTAL may be used with the gap penalty and gap extension set as defined above.

Suitably, the degree of identity with regard to a nucleotide sequence is determined over at least 20 contiguous nucleotides, preferably over at least 30 contiguous nucleotides, preferably over at least 40 contiguous nucleotides, preferably over at least 50 contiguous nucleotides, preferably over at least 60 contiguous nucleotides, preferably over at least 100 contiguous nucleotides.

Suitably, the degree of identity with regard to a nucleotide sequence is determined over the entire nucleotide sequence and not a portion thereof.

### Genome Wide Association

As described herein, a modified version of genome wide association (GWA) was used to map additional QTLs efficiently. A primary study sample (GWA panel) of about 180 unrelated individuals from the extreme upper and lower tails (above the 95^{th} or below the 5th percentile points i.e. >P₉₅ or <P₅) of the FC distribution for genotyping with the Illumina Sentrix® HumanHap300 BeadChip was used.

Accordingly, in a further aspect, there is provided a method for efficiently mapping one or more loci (eg. QTLs) comprising the steps of: (a) identifying about 180 unrelated individuals from the extreme upper and lower tails of the FC distribution; (b) genotyping said individuals; and (c) assessing the association.

Suitably, the extreme upper and lower tails of the FC distribution are above the 95th or below the 5th percentile points i.e. >P₉₅ or <P₅)

Suitably, association is assessed using a Fisher exact chi-square statistic for the allele counts in the high/low trait categories, and a linear regression analysis of the continuous trait against genotype (additive effects coded as 0, 1, 2), with age and sex included as covariates.

### KITS

The materials for use in the methods of the present invention are ideally suited for preparation of kits.

Such a kit may comprise containers, each with one or more of the various reagents (typically in concentrated form) utilised in the methods, including, for example, buffers, the appropriate nucleotide triphosphates (e.g., dATP, dCTP, dGTP and dTTP; or rATP, rCTP, rGTP and UTP), DNA polymerase and one or more primers and/or probes.

Primers and/or probes in containers can be in any form, e.g., lyophilized, or in solution (e.g., a distilled water or buffered solution), etc. Primers and/or probes ready for use in the same amplification reaction can be combined in a single container or can be in separate containers.

The kit optionally further comprises a control nucleic acid.

A set of instructions will also typically be included.

### General Recombinant DNA Methodology Techniques

The present invention employs, unless otherwise indicated, conventional techniques of chemistry, molecular biology, microbiology, recombinant DNA and immunology, which are within the capabilities of a person of ordinary skill in the art. Such techniques are explained in the literature. See, for example, J. Sambrook, E. F. Fritsch, and T. Maniatis, 1989, Molecular Cloning: A Laboratory Manual, Second Edition, Books 1-3, Cold Spring Harbor Laboratory Press; Ausubel, F. M. et al. (1995 and periodic supplements; Current Protocols in Molecular Biology, ch. 9, 13, and 16, John Wiley & Sons, New York, N.Y.); B. Roe, J. Crabtree, and A. Kahn, 1996, DNA Isolation and Sequencing: Essential Techniques, John Wiley & Sons; J. M. Polak and James O′D. McGee, 1990, In Situ Hybridization: Principles and Practice; Oxford University Press; M. J. Gait (Editor), 1984, Oligonucleotide Synthesis: A Practical Approach, Irl Press; and, D. M. J. Lilley and J. E. Dahlberg, 1992, Methods of Enzymology: DNA Structure Part A: Synthesis and Physical Analysis of DNA Methods in Enzymology, Academic Press.

The invention will now be further described by way of Examples, which are meant to serve to assist one of ordinary skill in the art in carrying out the invention and are not intended in any way to limit the scope of the invention.

### EXAMPLES

### Example 1

### Summary

F cells measure the presence of fetal hemoglobin (HbF), a heritable quantitative trait in adults that accounts for substantial phenotypic diversity of sickle cell disease and β thalassemia. A genome-wide association mapping strategy applied to individuals with contrasting extreme trait values led to mapping of a novel F cell QTL to BCL11A, a zinc-finger protein on chromosome 2p15. The 2p15 BCL11A QTL accounts for 15.1% of the trait variance.

### Introduction

Genome-wide association is a promising new methodology that has recently identified susceptibility loci for several diseases1,2, but it has relatively high per sample cost and requires large samples to detect modest risk effects. Strategies to increase power include selection of study subjects with an increased genetic load through early onset or familial clustering of disease. Here, we apply a powerful alternative approach that uses a comparatively small number of study subjects taken from the extremes of a quantitative distribution. Fetal hemoglobin (HbF, α2γ2) is present at residual levels (<0.6% of total hemoglobin) in healthy adults with >20-fold variation between individuals. 10-15% of adults in the upper tail of the distribution have HbF levels of >0.8% and up to 5.0%. Because the HbF is unevenly distributed among the erythrocytes, this form of hereditary persistence of fetal hemoglobin (HPFH) is referred to as heterocellular HPFH (hHPFH)3. Although the increases in HbF levels are modest in otherwise normal individuals, interaction of hHPFH with β thalassemia or sickle cell disease (SCD) can increase HbF output in these individuals to levels that are clinically beneficial4,5. The ameliorating effect of HbF on SCD and β thalassemia has prompted numerous genetic and pharmacological approaches for the reactivation of HbF synthesis in those disorders6,7.

Current pharmacological agents in use, such as hydroxycarbamide, butyrate analogues, 5-azacytidine and its analogue, decitabine, provide evidence that it is possible to augment HbF production therapeutically, but these agents are limited by their toxic effects and not all patients are responsive. Furthermore, the molecular mechanism of the HbF reactivation is not fully understood. HbF in the normal range (including hHPFH) is most sensitively measured by the proportion of F cells (FC), i.e. proportion of erythrocytes containing measurable amounts of HbF3. The majority of the quantitative variation of HbF as measured by FC is highly heritable (h2=0.89)8, but the genetic etiology is complex, with several contributing quantitative trait loci (QTLs). Identification of these QTLs should increase our understanding of the pathways and mechanisms of HbF control and provide new targets in therapeutic approaches. Major QTLs have been identified with strong and reproducible statistical support at XmnI-Gγ in the β globin locus on chromosome 11p159, and the HBS1L-MYB intergenic region on chromosome 6q23.

### Results

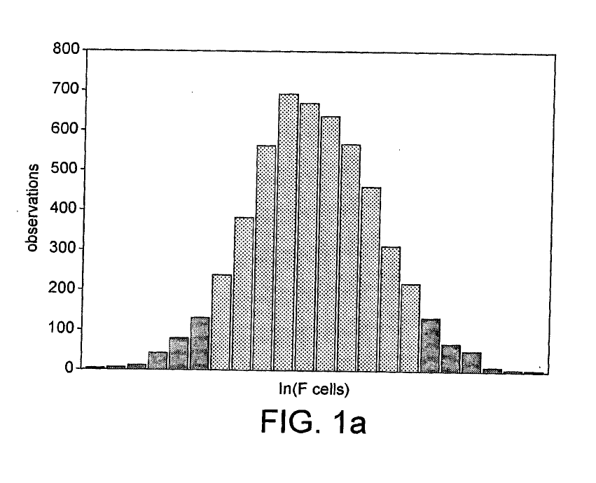

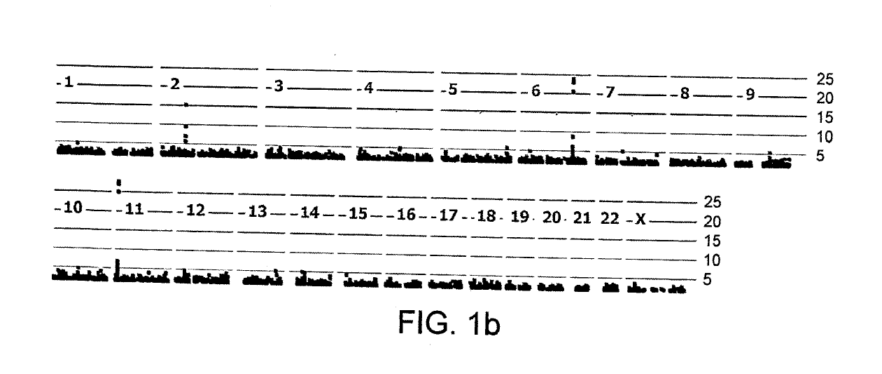

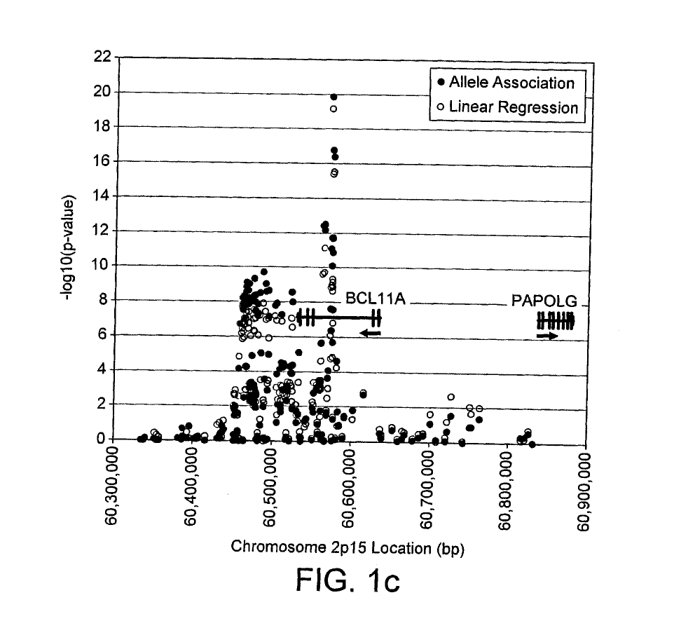

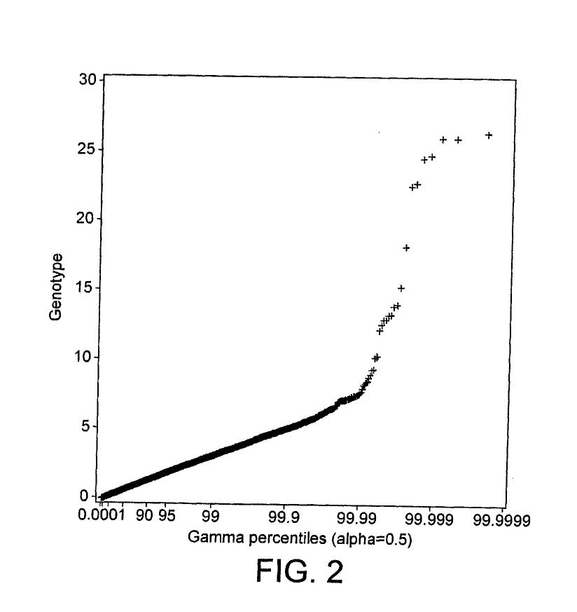

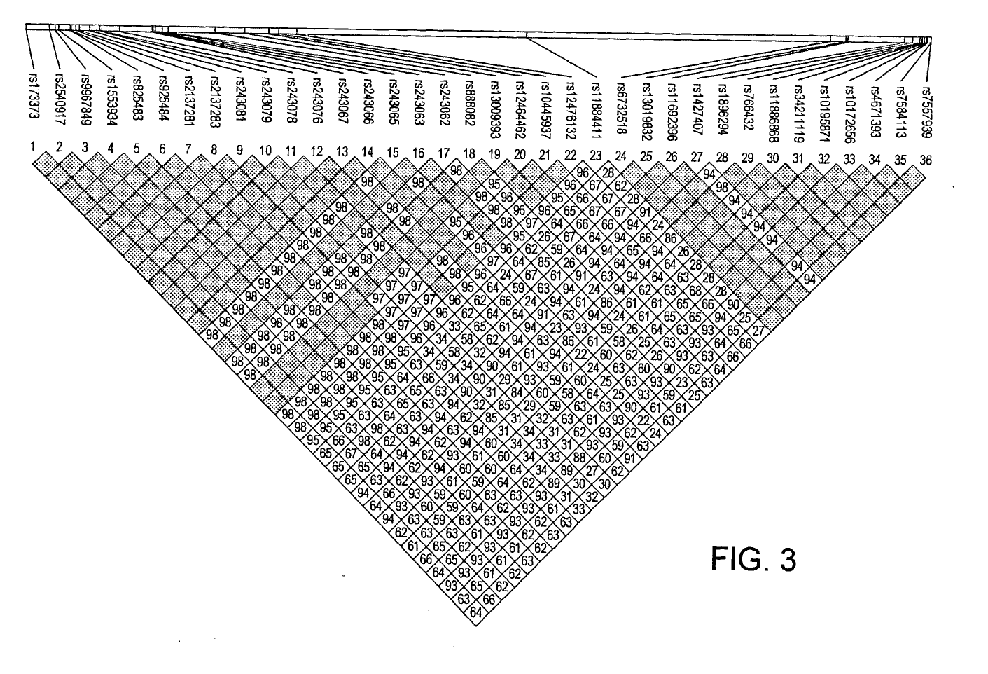

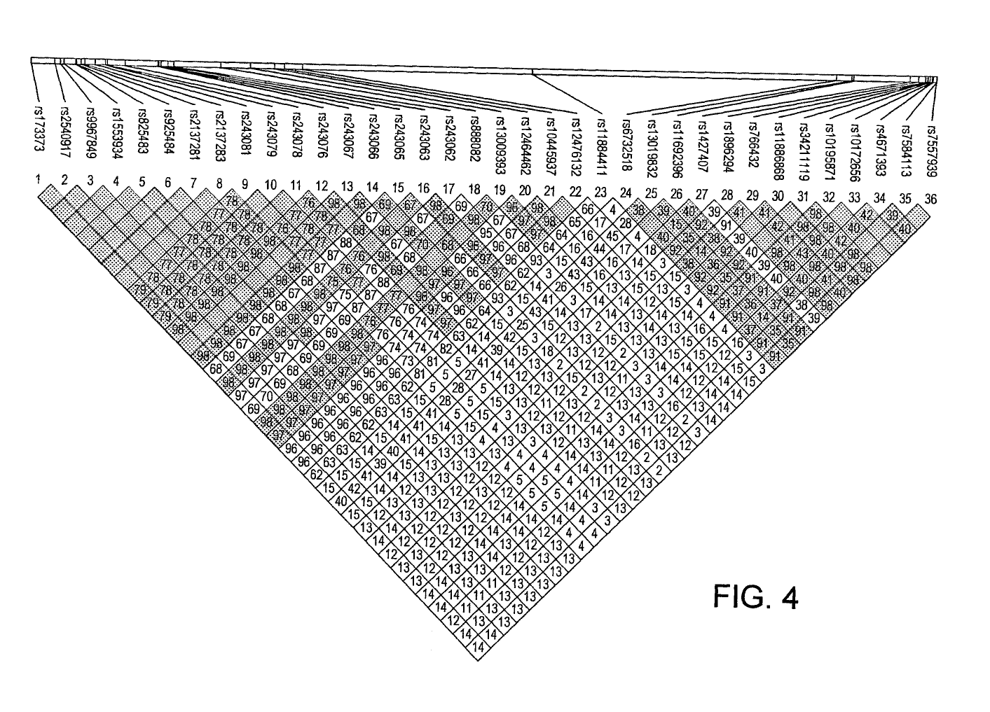

To map additional QTLs efficiently, we selected a primary study sample (GWA panel) of 179 unrelated individuals from the extreme upper and lower tails (above the 95^{th} or below the 5th percentile points i.e. >P₉₅ or <P₅) of the FC distribution (drawn from a database of 5,184 phenotyped individuals from the St. Thomas UK Adult Twin Registry, www.twinsuk.ac.uk¹⁰) for genotyping with the Illumina Sentrix® HumanHap300 BeadChip (FIG. 1a). For the 308,015 markers retained after quality-control, association was assessed using a Fisher exact chi-square statistic for the allele counts in the high/low trait categories, and a linear regression analysis of the continuous trait against genotype (additive effects coded as 0, 1, 2), with age and sex included as covariates. The two approaches gave similar results, and p-values from the allele count test are presented in the text. We also examined deviations from non additivity in the linear regression, and this was found to lead to identical conclusions. Although extreme discordant sampling designs violate the usual normality assumption of linear regression, it has been previously shown that this does not inflate the type 1 error rate11 which we confirmed by simulations. This is also shown by the Q-Q plot shown in FIG. 2. The genomic control parameter was equal to 1.01, indicating that there was minimal evidence of admixture or cryptic relatedness in this sample12. Principal components analysis with Eigenstrat13 confirmed the absence of significant stratification.

We identified major QTLs on chromosome 2p15 (p=4.0×10₋₁₆), on chromosome 6q23 (p=8.8×10₋₂₅), and on chromosome 11p15 (p=1.7×10₋₂₆) (FIG. 1b). Two correspond to previously described QTLs. The 6q23 QTL was localized through linkage analysis in a large Asian-Indian family with beta thalassemia14. Subsequent validation and fine-mapping was obtained in Northern Europeans. The association signal on 11p15 maps to the beta globin cluster where the functional variant is thought to be the XmnI-Gγ variant at position −158 upstream of the Gγ globin gene9. Markers within an approximately 127-kb segment on chromosome 2p15 (chr2: 60,456,396 to 60,582,798) identified a third, previously unreported QTL. The strongest association was detected at markers in the oncogene BCL11A₁₅. To further characterize this QTL, we genotyped 142 supplementary SNPs of which 103 came from HapMap16 and 39 others were identified from dbSNP or by resequencing (Table 2).

Analysis of this dense marker set revealed two clusters with markers showing highly significant association at p<10₋₁₀ (FIG. 1c). The strongest associations (e.g. p<10₋₁₉ at rs1427407) were seen in a region spanning 15 kb at 60,561,398 to 60,575,745 of the 2^{nd} intron of BCL11A located 50-65 kb downstream of exon 2. The second association cluster spans 67 kb at 60,457,454 to 60,523,981 in the 3′ region of the gene located approximately 8 to 74 kb downstream of exon 5. Markers that are significantly associated with the trait in general exhibit high LD with each cluster and lower LD between clusters (FIG. 2).

To corroborate our findings, we investigated two additional sample panels (‘replication panel’ and ‘twin panel’ as defined below) with markers selected to represent the three QTLs (Table 1a and Table 3). For chromosome 2p15, we examined four markers from the 1st association cluster and two markers from 2^{nd} association cluster. For chromosome 6q23, we chose markers to represent three linkage disequilibrium groups that contribute independently to the QTL. The XmnI-Gγ marker was genotyped on chromosome 11p15.

First, we replicated the associations in an independent group of 90 individuals with contrasting trait values (‘replication panel’, n=90, <P₅ or >P₉₅). Highly significant association was found for all three QTLs (Table 1a). Then, we measured the contribution of the marker to the overall trait variance in an unselected group of 720 twins (‘twin panel’; 310 DZ twin-pairs and 100 singletons from MZ twin pairs). As related individuals were included, we applied a mixed linear model to test association and estimate residual heritability in the twin panel. The model included a random effects covariance matrix for each twin type and fixed effects for age, sex and genotype. The individual markers were all significantly associated with the trait (Table 1a). A within-family test of association17, which has less power but controls for possible population stratification, was significant for markers at the chromosome 2 and chromosome 6 QTLs (results not shown). The trait variance attributed to each locus in the mixed linear model was 15.1% (95% CI 12.6%-17.6%) for 2p15, 19.4% (16.6%-22.2%) for 6q22 and 10.2% (8.2%-12.2%) for 11p15. Tests of interactions between QTLs were non-significant suggesting that they contribute additively. Together, they explain over 44% of the total trait variance in the twin panel, i.e. half of the overall heritability of 89%. Finally, we examined contributions of the 2p15 markers in more detail. Haplotype analysis in the twin panel showed incomplete linkage disequilibrium, particularly between markers in the two association clusters (Table 1b and Table 4). A forward stepwise regression with all the markers identified two (rs4671393 and rs6732518) from the 1st association cluster showing independent statistical effects on the trait. In particular, the two markers from the 2nd cluster did not show significant association after taking into account rs4671393 and rs6732518 (Table 5). These preliminary findings are consistent with the presence of more than one functional SNP, or the presence of untyped functional SNPs in incomplete LD with the typed markers from the 1st association cluster.

### Conclusions

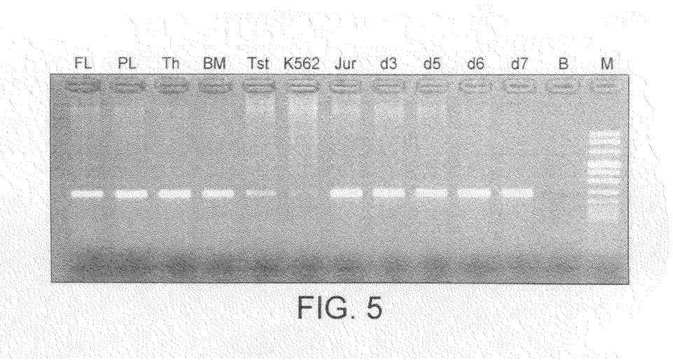

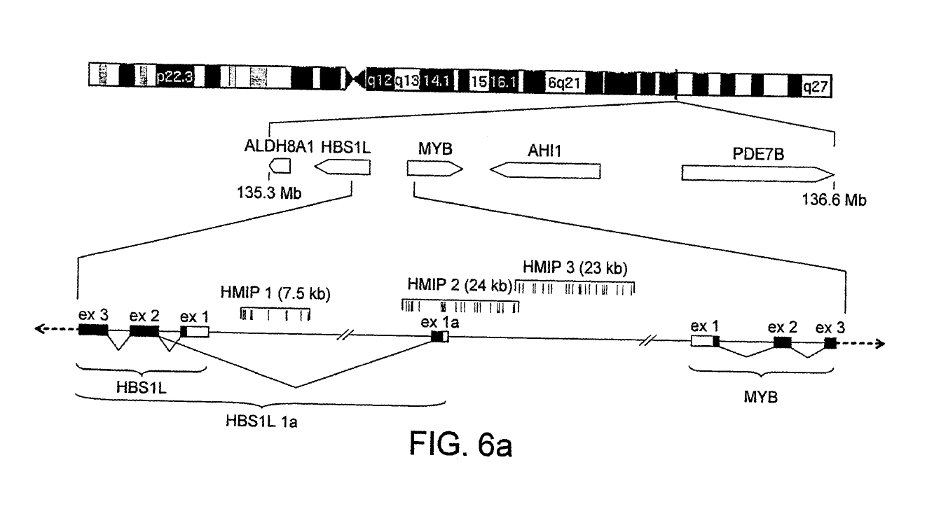

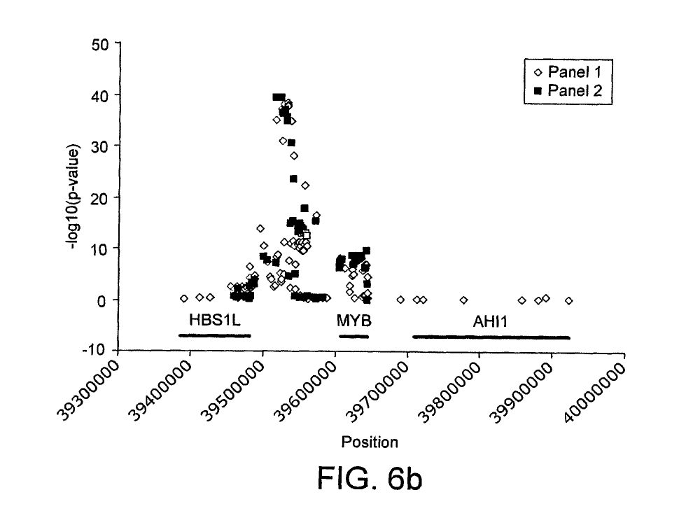

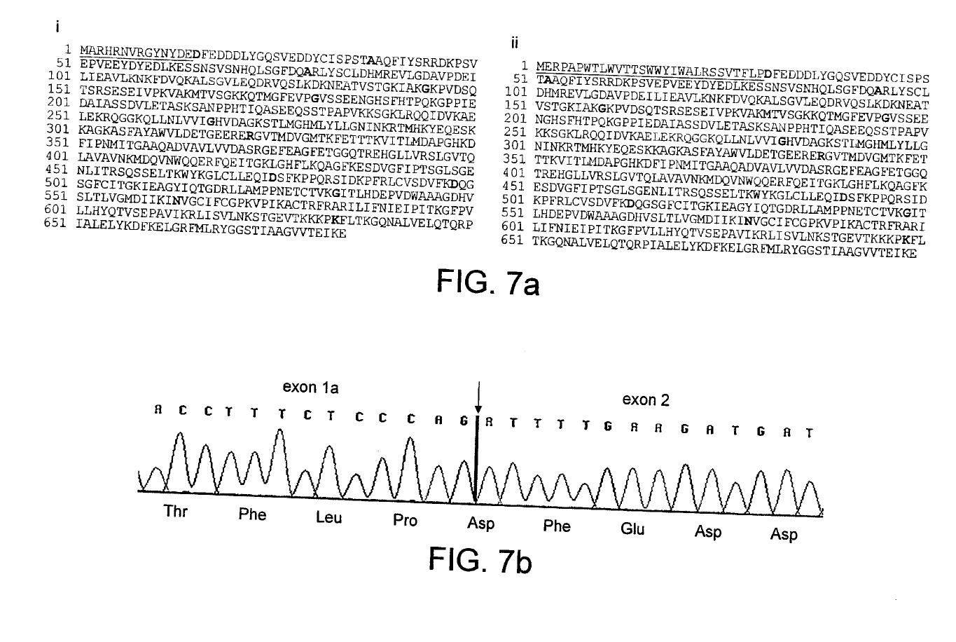

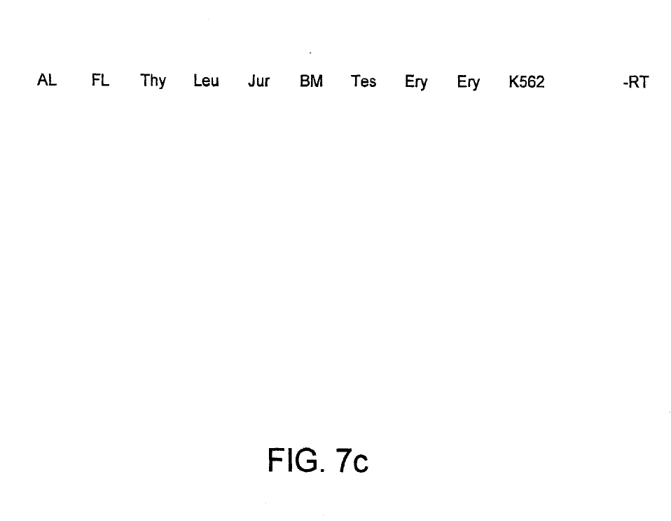

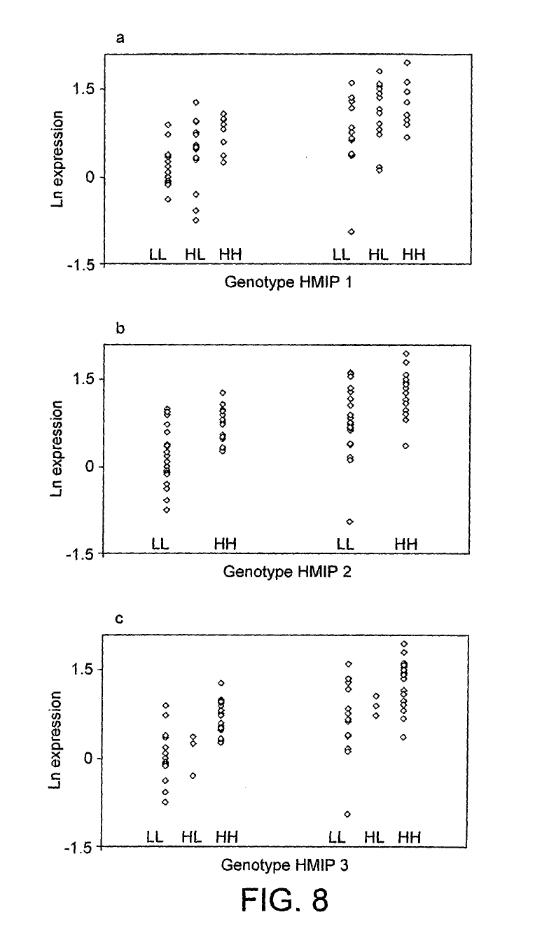

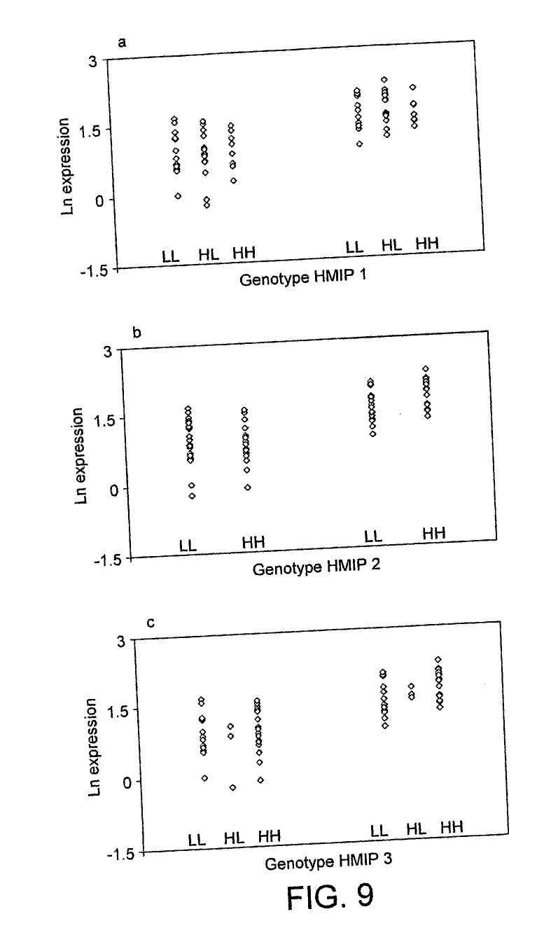

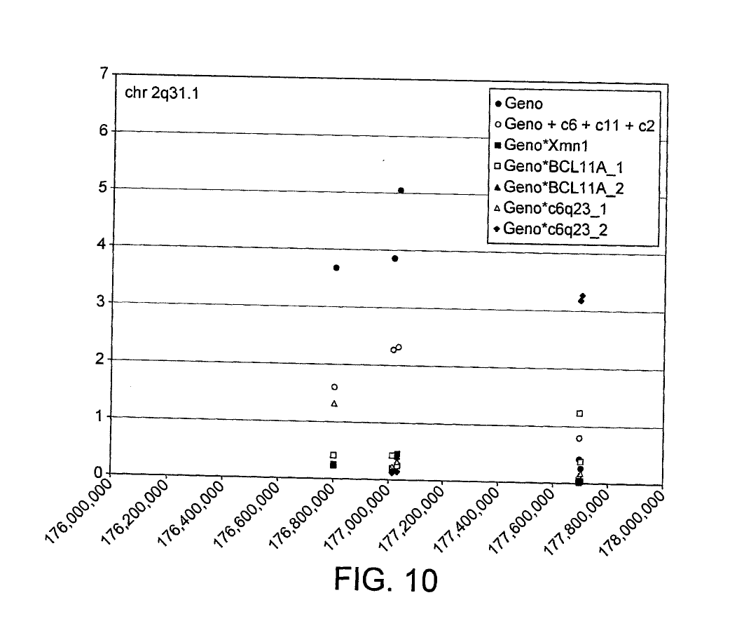

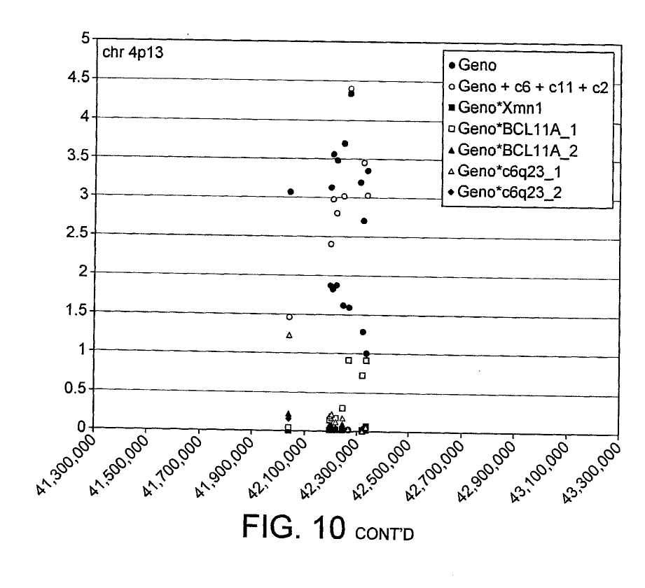

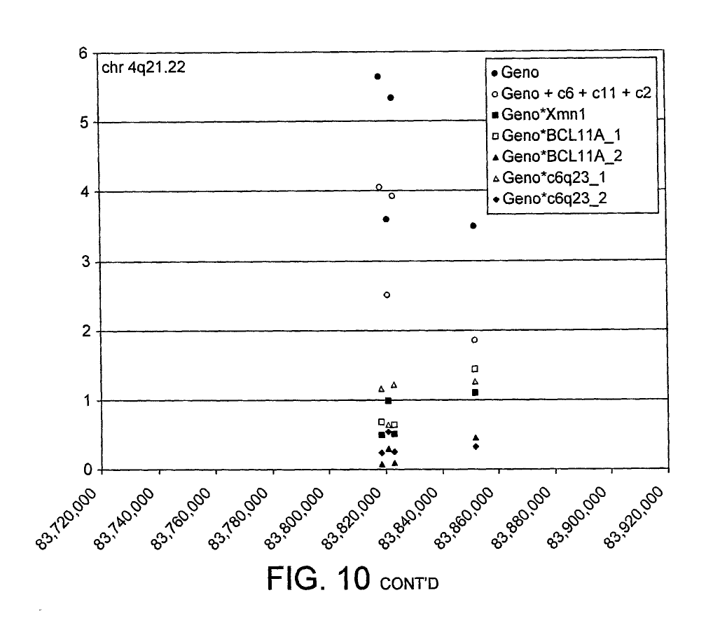

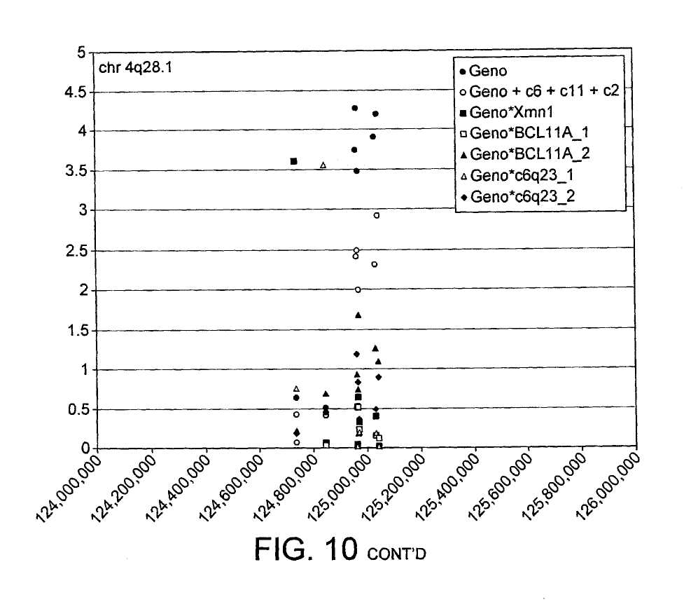

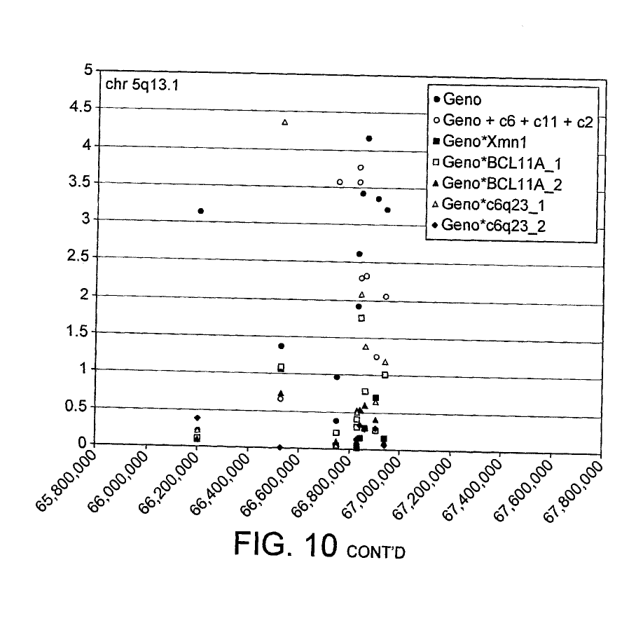

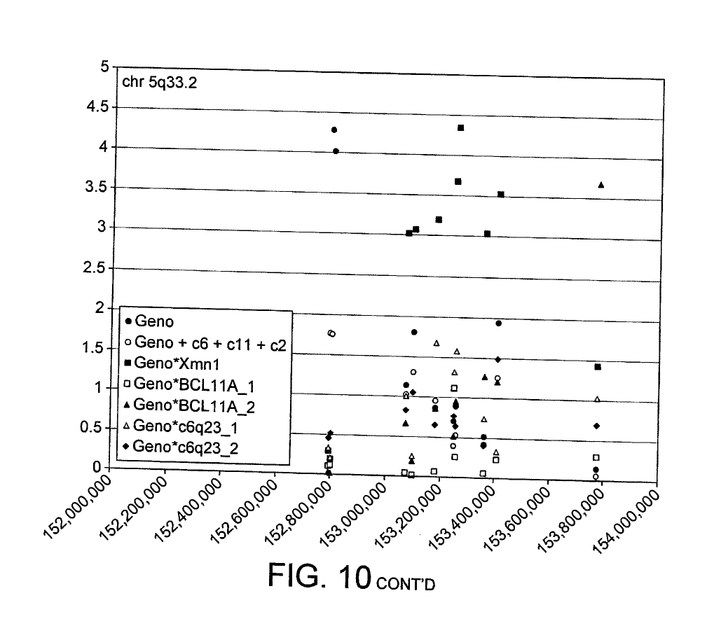

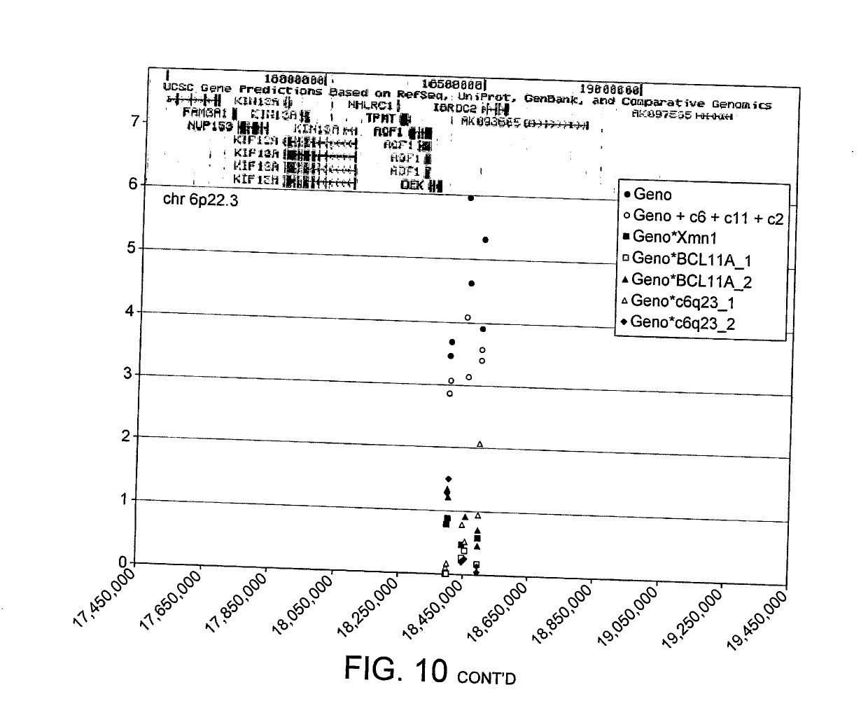

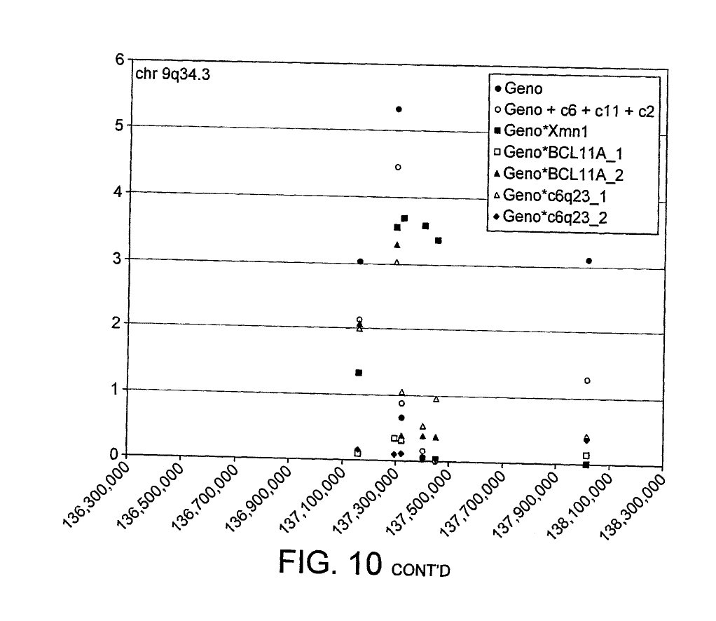

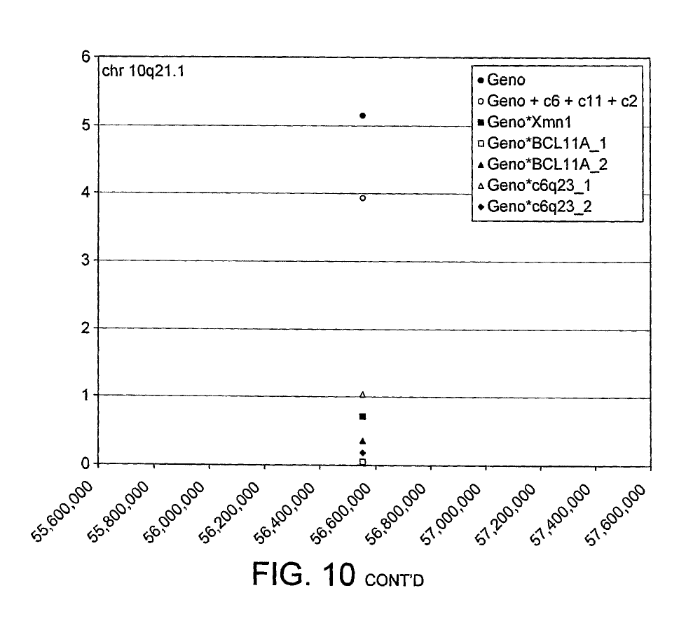

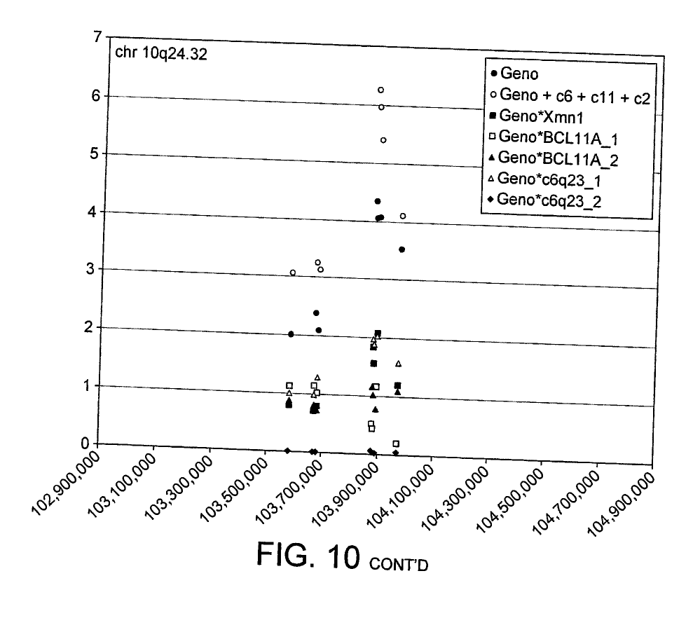

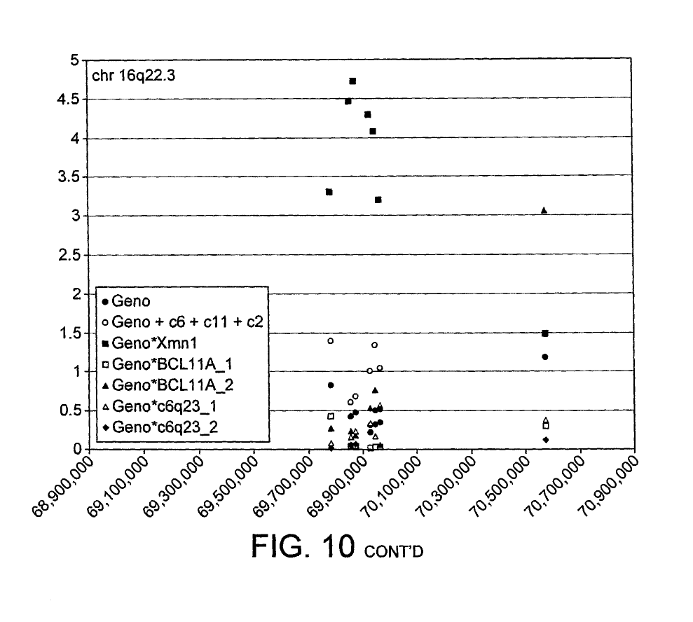

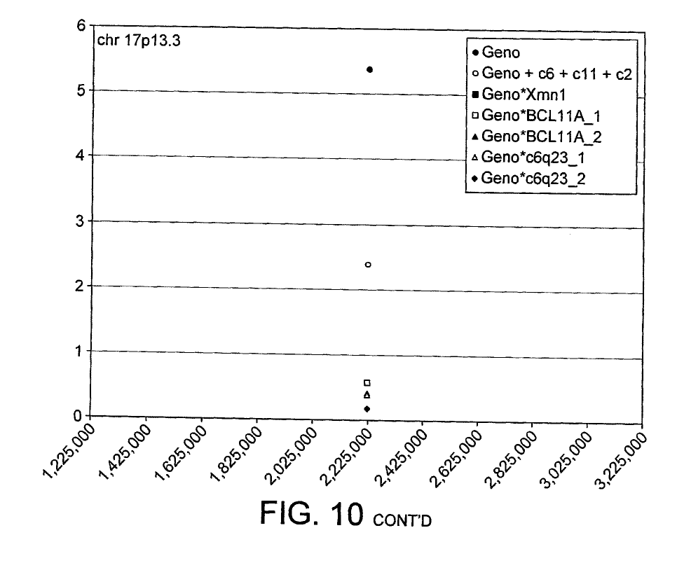

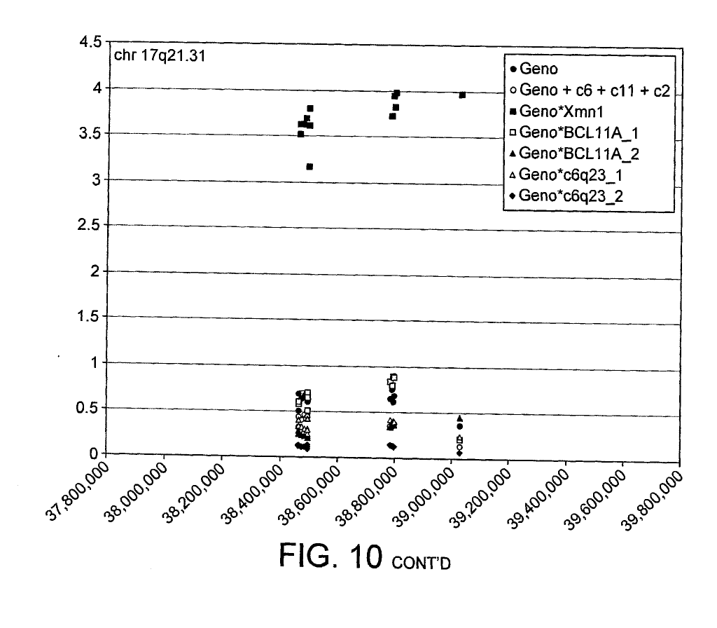

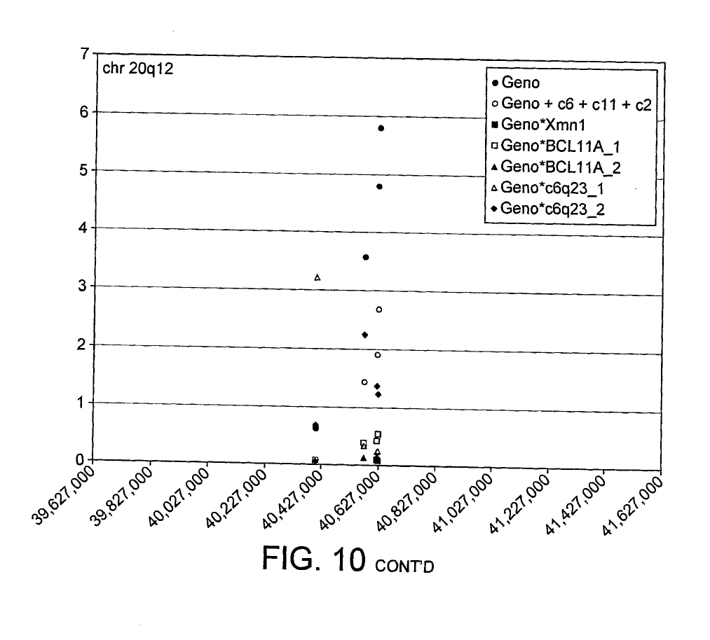

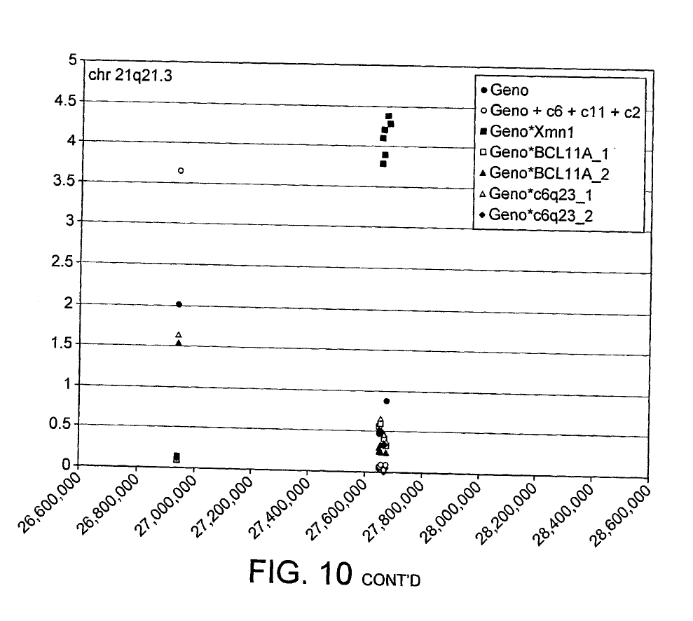

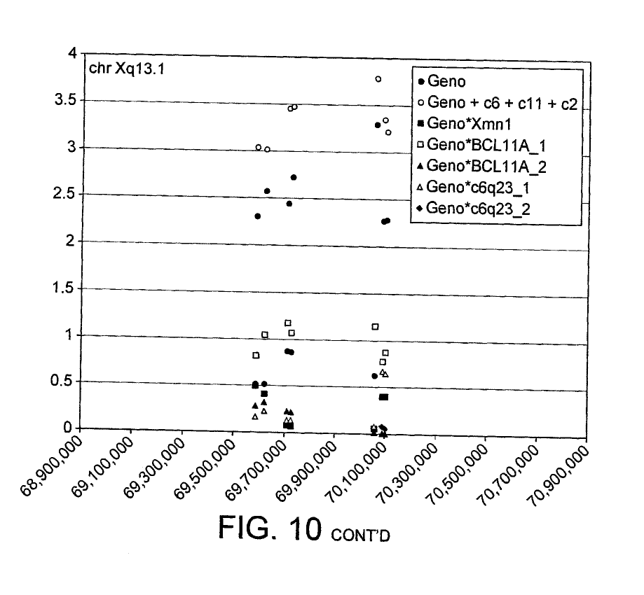

Accumulating experimental data is unveiling the genetic architecture of human quantitative variation18. Re-sequencing studies of candidate genes in extreme groups have revealed diverse sets of rare, non-synonymous alleles which collectively explain a modest proportion of the trait variance for some QTLs19 while others are associated with common alleles, for example, circulating angiotensin 1 converting enzyme (ACE) activity20. Our genome-wide association (GWA) study is designed to detect the latter. The approach of applying GWA to individuals with contrasting extreme quantitative trait values is a powerful strategy for the mapping of such QTLs as illustrated by our identification of three principal QTLs that contribute to FC (and thus HbF). This success will encourage similar approaches to the study of other human quantitative traits. One of the QTLs that we have identified is a novel locus that maps to the C2H2 type zinc-finger protein gene, BCL11A, on chromosome 2p15 which has previously been implicated in myeloid leukemia and lymphoma pathogenesis15. We examined multiple tissue cDNA panels by RT-PCR, and found BCL11A to be expressed in a variety of tissues including erythroid cells (FIG. 5). It is evident from the Gene Expression Omnibus database21 that BCL11A is expressed in CD34+ hemopoietic cells under a variety of experimental conditions and disease states. Mouse studies have shown that BCL11A is essential for early lineage commitment in the development of both T cells and B cells is. BCL11A has also been implicated in histone deacetylation and transcriptional repression in mammalian cells22. We speculate that dysregulated BCL11A expression may affect the differentiation of pluripotent hematopoietic stem cells and the kinetics of erythropoiesis and F cell production 23.

It is likely that we have identified the principal QTLs with frequent alleles affecting F cell production in the general Caucasian population that reside within the limits of the genome coverage of our markers. As the three QTLs account for approximately 50% of the trait heritability, it is possible that additional loci could be revealed with denser marker coverage. However, some or all of the remaining heritability could be due to additional loci that are undetected in the absence of alleles with predominant effects. The genome-wide association results suggest that further QTLs with relatively minor effects may be present (FIG. 1b). Detection of possible interactions with other loci that are conditional on alleles at one or more of the principal QTLs, such as recently reported using a linkage approach24, may require different sampling strategies.

Pooling of data from other ethnic groups and additional marker sets should be undertaken to obtain further knowledge of the genetic architecture of HbF and F cell production and the physiology of the associated hematopoetic mechanisms. Our data are publicly available as a contribution to this goal. Fuller understanding of the biology of HbF and FC control in adults is essential to guide development of effective therapeutic and predictive/preventive strategies for the β hemoglobinopathies6. Our study has revealed multiple QTLs within and outside the β globin gene complex that underlie the propensity to produce HbF and FC. These loci have a major influence on the large quantitative variation of these traits in normal healthy adults, in the ‘erythropoietic stress’ responses underlying variability in β thalassemia and sickle cell disease severity, and possibly, in the capacity of patients to respond to pharmacologic inducers of HbF. The identification of these QTLs and the corresponding novel candidate genes, such as BCL11A, will provide the basis for the new insights that are required to meet the medical needs cited above.

### Methodology

### Twin Samples and F-Cell Phenotyping

The St. Thomas' UK Adult Twin Registry, which commenced in 1993, consists of over 10,000 monozygous and dizygous adult twins aged 18-80 with white British ancestry1. The twins are volunteers and unselected with respect to a disease or physiological trait making them informative for studying a wide variety of quantitative human traits. A subset (5,184) of the twins has been phenotyped for multiple hematological phenotypes including measurement of F-cell levels2. The average age of the participants in the GWA panel of 179 individuals and the replication set of 90 individuals was 51 years, ranging from 18 to 79 years. The average F cell level of the <P5 group in these two sets was 0.79% (range 0.23% to 1.0%) and that of the >P95 group was 14.06% (range 10.4% to 39.61%). The average age of the participants in the unselected set of 720 twins was 62 years, (ranging from 18 to 72 years; and the average F cell level of this set was 3.33% (range 0.53% to 21.75%). F-cells were enumerated in EDTA samples by flow cytometry of 20,000 cells using a monoclonal anti-γ globin chain antibody conjugated with fluorescein isothiocyanate (FITC)3. The study was approved by the local Research Ethics Committee, King's College Hospital, London, UK (LREC No: 01-332 and LREC No: 01-083).

### Mixed Model ANOVA Methods

The relationship of the quantitative trait with age, sex and marker genotypes was evaluated using the mixed-model ANOVA procedure (PROC MIXED) from SAS version 8.2 (SAS Institute Inc., Cary, N.C., USA) with restricted maximum likelihood estimation.

Monozygotic (MZ) and dizygotic (DZ) twins were assumed to have distinct trait variances and covariances. Age, sex and marker genotypes were incorporated as fixed effects for analysis; two indicator variables were defined to test additive and dominance effects at each locus. Estimates of the genetic variance conferred by individual markers were calculated by using standard population genetic formulae4. Estimates of the joint genetic variance conferred by multiple markers in linkage disequilibrium (i.e. overall locus-effect) were calculated by using the residual variance estimates comparing nested models with the general 3-locus (chromosome 2, 6 & 11) model. Likelihood ratio test statistics from these comparisons were interpreted as Wald statistics in order to calculate a rough confidence interval of the magnitude of the locus-effects.

### Statistical Analysis and Interpretation

Analysis of extreme contrasting groups based on arbitrary thresholds (often called extreme-groups analysis, or EGA) has long been recognized as a cost-effective design for the analysis of continuous measures5. The EGA concept has been repeatedly adapted to the study of quantitative genetics (e.g. in the context of QTL mapping in line-crosses6; QTL mapping in humans7) as it is an invaluable strategy when the costs of genotyping are high compared to phenotyping. In general, sample-sizes used in genome-wide association mapping studies are limited by economic and other practical considerations and consequently influence the choice of threshold for EGA. Nevertheless, our selection criteria of P5 & P95 (5th and 95th percentile points) provides good power to map QTLs associated with modest locus-specific heritabilities. For instance, the power to detect a QTL accounting for 7.1% of the trait variance with a common marker (MAF=0.2) in linkage disequilibrium (D′=0.9) with a causative variant is over 85%, even allowing for a highly conservative single-step (“Bonferroni”) correction for 300,000 independent tests to control the overall type I error (nominal, or unadjusted p-value between 10-6-10-7). Accordingly, the three major QTLs on 2p, 6q & 11p that were detected by clusters (“stacks”) of Illumina hap300 markers with multiple p-values much less than 10-7 satisfy such a strict Bonferroni multiple testing criterion even before replication. Based on these power calculations, our study design provides greater than 98% power to detect other loci with similar size effects within the coverage of the SNP map. No other regions with markers meeting the strict criterion of p<10-7 were identified.

However, we believe it reasonable to expect that regions containing markers with suggestive evidence of association from such GWA scans will prove profitable in follow up studies even if they do not satisfy the strict multiple testing criterion; indeed this opinion is supported by recent results of GWA scans of human complex disease (e.g. type 2 diabetes8). Calculations based on a nominal alpha=10-5; an additive effect=5.0%, a marker with MAF=0.2 in strong LD (D′=0.9) give power=83%. Four markers that map outside of the 2p, 6q & 11q QTLs meet the less stringent criterion of 10-6<p<10-5; three of these (rs4535195 on chromosome 3, rs9999241 on chromosome 4 and rs12667374 on chromosome 7) are isolated with no neighboring markers that show evidence of association. One, rs886509, maps to a region on chromosome 5 in which several other markers show some evidence of association (p<0.001). Our dataset will be made public to allow these and other regions that could contain minor QTLs to be investigated through meta-analyses.

### REFERENCES

1. Cardon, L. R. Science 314, 1403-5 (2006).
2. Sladek, R. et al. Nature 445, 881-5 (2007).
3. Thein, S. L. & Craig, J. E. Hemoglobin 22, 401-414 (1998).
4. Labie, D. et al. Proceedings of the National Academy of Sciences, USA 82, 2111-2114 (1985).
5. Ho, P. J., Hall, G. W., Luo, L. Y., Weatherall, D. J. & Thein, S. L. British Journal of Haematology 100, 70-78 (1998).
6. Bank, A. Blood 107, 435-43 (2006).
7. Sadelain, M. Curr Opin Hematol 13, 142-8 (2006).
8. Gamer, C. et al. Blood 95, 342-346 (2000).
9. Gamer, C. et al. GeneScreen 1, 9-14 (2000).
10. Spector, T. D. & MacGregor, A. J. Twin Res 5, 440-443 (2002).
11. Tenesa, A., Visscher, P. M., Carothers, A. D. & Knott, S. A. Behav Genet. 35, 219-28 (2005).
12. Devlin, B. & Roeder, K. Biometrics 55, 997-1004 (1999).
13. Patterson, N., Price, A. L. & Reich, D. PLoS Genet. 2, e190 (2006).
14. Craig, J. E. et al. Nature Genetics 12, 58-64 (1996).
15. Liu, P. et al. Nat Immunol 4, 525-32 (2003).
16. International HapMap Consortium et al. Nature 437, 1299-1320 (2005).
17. Abecasis, G. R., Cardon, L. R. & Cookson, W. O. Am J Hum Genet. 66, 279-292 (2000).
18. Farrall, M. Hum Mol Genet. 13 Spec No 1, R1-7 (2004).
19. Cohen, J. C. et al. Science 305, 869-72 (2004).
20. Keavney, B. et al. Human Molecular Genetics 7, 1745-1751 (1998).
21. Edgar, R., Domrachev, M. & Lash, A. E. Nucleic Acids Res 30, 207-10 (2002).
22. Senawong, T., Peterson, V. J. & Leid, M. Arch Biochem Biophys 434, 316-25 (2005).
23. Stamatoyannopoulos, G. Exp Hematol 33, 259-71 (2005).
24. Garner, C. et al. Blood 104, 2184-6 (2004).

### SUPPLEMENTARY REFERENCES

1. Spector, T. D. & MacGregor, A. J. Twin Res 5, 440-443 (2002).
2. Garner, C. et al. Blood 95, 342-346 (2000).
3. Thorpe, S. J. et al. British Journal of Haematology 87, 125-132 (1994).
4. Falconer, D. S. Introduction to Quantitative Genetics, (Longman, London, 1981).
5. Kelley, T. L. J. Educational Psychology 30, 17-24 (1939).
6. Darvasi, A. & Soller, M. Genetics 138, 1365-73 (1994).
7. Risch, N. & Zhang, H. Science 268, 1584-1589 (1995).
8. Sladek, R. et al. Nature 445, 881-5 (2007).

### Example 2

### Summary

Individual variation in fetal hemoglobin (HbF, α₂γ₂) response underlies the remarkable diversity in phenotypic severity of sickle cell disease and β thalassemia. HbF levels and HbF-associated quantitative traits (e.g. F cell levels) are highly heritable. We have previously mapped a major QTL controlling F cell levels in an extended Asian-Indian kindred with β thalassemia to a 1.5 Mb interval on chromosome 6q23, but the causative gene(s) are not known. The QTL encompasses several genes including HBS1L, a member of the GTP-binding protein family that is expressed in erythroid progenitor cells. In this high-resolution association study we have identified multiple genetic variants within and 5′ to HBS1L at 6q23, that are strongly associated with F cell levels in families of Northern European ancestry (p=10⁻⁷⁵). The region accounts for 17.6% of the F cell variance in northern Europeans and is associated with F cell levels in the extended Asian-Indian kindred. Although mRNA levels of HBS1L and MYB in erythroid precursors grown in-vitro are positively correlated, only HBS1L expression correlates with high F cell alleles. The results support a key role for the HBS1L-related genetic variants in HbF control and illustrates the biological complexity of the mechanism of 6q QTL as a modifier of fetal hemoglobin levels in the β hemoglobinopathies.

### Introduction

Sickle cell disease and β thalassemia are amongst the most common genetic diseases worldwide and have a major impact on global health and mortality (1). Both these hemoglobinopathies display a remarkable diversity in their disease severity. A major ameliorating factor is an innate ability to produce fetal hemoglobin (HbF, α₂γ₂). HbF levels vary considerably, not only in patients with these 13 hemoglobin disorders, but also in healthy normal adults. The distribution of HbF and F cells (FCs, erythrocytes that contain measurable HbF) in healthy adults is continuous and positively skewed. Although the majority of adults have HbF of less the 0.6% of total hemoglobin, 10%-15% of individuals have increases ranging from 0.8% to 5% (2). The latter individuals are considered to have heterocellular hereditary persistence of fetal hemoglobin (hHPFH) which refers to the uneven distribution of HbF among the erythrocytes. When co-inherited with β thalassemia or sickle cell disease, hHPFH can increase HbF output to levels which are clinically beneficial (3, 4).

FC levels are strongly correlated with HbF in adults within the normal range (including hHPFH) (2), and F cells are generally used as an indirect measure of HbF within normal individuals because of the poor sensitivity for HbF assay in the lower range (see Materials and Methods). A logarithmic transformation of FC removes skewness, and leads to a distribution that is approximately normal for a representative population sample (5). The heritability of HbF and FC is estimated to be 89% (5). Cis-acting variants and rare mutations at the β globin gene locus explain some of the variability (2), but over 50% of the variance is unlinked to this locus (6). Our previous study of an Asian-Indian kindred in which β thalassemia and hHPFH were segregating identified a QTL that mapped to a 1.5 Mb interval on chromosome 6q23 with a lod score of 6.3 (7, 8) (FIG. 6a). This interval contains five known protein-coding genes (ALDH8A1, HBS1L, MYB, AHI1 and PDE7B), none of which harbored mutations (non-synonymous variants), and three (HBS1L, MYB and AHI1) are expressed in erythroid progenitor cells (9, 10).

To explore further the role of the 6q23 QTL on HbF control, we studied two panels (824 and 1217 individuals, respectively) of twin pairs of North European origin. In a high-resolution association study we identified multiple genetic variants that are strongly associated with FC levels in the Caucasian controls (p=10⁻⁷⁵). These genetic variants reside in three linkage disequilibrium (LD) blocks within HBS1L and 5′ to HBS1L, and MYB in the intergenic region.

To delineate the functional significance of these genetic variants, we performed an expression profile of HBS1L and MYB during erythropoiesis. We observed a striking correlation of increased HBS1L expression in erythroid progenitor cells with presence of the single nucleotide polymorphisms (SNPs) associated with high trait values in the three LD blocks. The present study illustrates the power of QTL mapping for positional identification of trans-acting genetic variants influencing regulation of HbF levels, a major ameliorating factor of SCD and β thalassemia.

### Results

We genotyped two panels (824 and 1217 individuals, respectively; see Table 6) of twin pairs of North European origin recruited through the Twins UK Adult Twin Registry (11). FC levels were measured as described in Materials and Methods, and log-transformed to obtain an approximately normal distribution. Age and sex, and XmnI-Gγ (−158 C/T) variant upstream of the Gγ globin gene which is associated with FC levels (6, 12) show similar associations with FC levels in both panels (Table 6). From the known genes within the 6q23 QTL interval, we selected MYB and HBS1L as candidate genes for detailed study. Both genes are expressed in erythroid precursor cells. MYB encodes a transcription factor essential for erythroid differentiation in hematopoiesis (13-15). HBS1L is the human ortholog of Saccharomyces cerevisiae HBS1 and encodes a protein with apparent GTP-binding activity, involved in the regulation of a variety of critical cellular processes (16).

Polymorphisms were identified by re-sequencing MYB and about 78 kb of the HBS1L-MYB intergenic region. We identified 184 markers for which the minor allele had 5% or greater frequency, 94 of which were selected for genotyping based on their positions, linkage disequilibrium patterns and intermediate association results. We added 27 markers from public databases to provide additional coverage particularly in the 3′ flanking regions of MYB and HBS1L. Altogether, 121 markers were genotyped with average spacing of 4.4 kb, and higher density (1.8 kb average) in the HBS1L-MYB intergenic region (Table 8a).

Twenty-eight markers provided very strong evidence of association (p<10⁻⁸) in the first panel, with the most significant results concentrated at sites between HBS1L and MYB (FIG. 6b). In particular, a 24 kb segment starting 33 kb upstream of HBS1L contained twelve markers showing very strong association (p-values between 10⁻²⁸ and 10⁻³⁹, block 2 in FIG. 6a) whereas the other thirteen markers from within this segment are less significantly associated with the trait (Table 8b). Strikingly, the twelve markers with the strongest trait association have similar allele frequencies and are in complete linkage disequilibrium (except for haplotypes with frequency <2%), whereas the others exhibit different linkage disequilibrium patterns (Tables 9a,b,c). We confirmed the association by characterizing a subset of 75 markers from the HBS1L-MYB interval in the second twin panel (FIG. 6b). The twelve markers with the strongest trait association in the first panel are also the most strongly associated in the second panel (FIG. 6b and Table 8b). When the data from the two panels were combined, these markers had association p-values of 10⁻⁵⁰ to 10⁻⁷⁵.

Markers outside of the 24 kb interval also showed consistent evidence of association in the two panels. In some instances, linkage disequilibrium between trait-associated markers appeared weak. We hypothesized that more than one variant contributes to the QTL. A stepwise statistical selection procedure led to the identification of three markers that accounted independently for a significant proportion of the trait variance even with the other markers included in the ANOVA (Table 6). The three markers were selected in the following order (with p-values from the combined data for the significance calculated with previously selected markers included): rs9399137 (p=10⁻⁷⁵), rs52090901 (p=10⁻¹⁰) and rs6929404 (p=0.0002). The first of these (rs9399137) is one of twelve markers in HBS1L MYB Intergenic Polymorphism (HMIP) block 2 (so-labeled because of its physical position) with the strongest trait associations. We identified multiple markers in two other trait-associated blocks in strong linkage disequilibrium with rs52090901 (HMIP block 1) and rs6929404 (HMIP block 3) (FIG. 6a). Minor differences in the association statistics for markers in the same block could be attributed to rare haplotypes and/or a small amount of missing genotype data

The principal chromosome 6q23 haplotype that co-segregates with high HbF and FC levels in the Asian Indian kindred also harbors the trait-associated variants at the sites within the three trait-associated blocks (data not shown).

### A Novel Transcript of HBS1L

As part of our characterization of the HBS1L-MYB intergenic region, we confirmed by RT-PCR and sequence analysis, the existence of a novel transcript of HBS1L which is expressed in thymus, Jurkat cells, peripheral leukocytes, and at minimal levels in erythroid progenitors. The novel transcript was deduced from the sequence of a thymus cDNA clone deposited in a public database (Japanese Database of Transcriptional Start Sites; DBTSS; http://www.dbtss.hgc.jp; GenBank ID DB114698). This transcript contains an alternative 119 by first exon (denoted exon 1a) which starts approximately 45 kb upstream of the previously described first exon of the gene (FIG. 6a and FIGS. 7a, b and c). A 102 by repeat-free segment that starts 129 by upstream of the initiation codon has marked nucleotide homology with other mammals and contains binding site motifs for a putative TATA box and three members of the GATA family of transcription factors (GATA-1, -2 and -3) that regulate gene expression in hematopoietic tissue during both development and adult life (17).

### Expression Profile of HBS1L and MYB During Erythropoiesis.

To investigate the functional significance of the trait-associated genetic variants, we used real-time quantitative RT-PCR to study the expression levels of HBS1L and MYB during erythropoiesis. As HBS1L-1a was expressed at very low levels in erythroid progenitors, it was excluded from the study. Erythroid cells obtained from 35 individuals (23 from the twin-pair panels, 2 from the Asian-Indian pedigree and 10 from other Caucasian volunteers) were cultured using a two-phase liquid system as described (10), and RT-PCR was performed with total RNA obtained from erythroid progenitor cells on days 0 and 3 phase II erythroid culture for each individual included in the study. We hypothesized that contrasts between the extreme genotypes would be the most informative to detect effects on expression, so individuals who were homozygous at the trait-associated sites within block 2 were chosen for these studies. Alleles associated with high trait values for a block are denoted as “H” and the alleles associated with low trait values for a block as “L”. The genotype status was usually equivalent for all the markers within a block because of the strong linkage disequilibrium. In a few instances when this was not so, we classified individuals according to the predominant pattern (see Legend to FIG. 8).

HbF and FC levels were significantly associated with genotypes in the three blocks in the samples selected for the expression study, as expected. We observed a striking relationship of increased HBS1L expression measured at day 0 associated with the presence of the H genotype in the three trait associated blocks, and a statistically less significant relationship for day 3 expression (FIG. 8). These results strongly suggest that the biological effects of genetic variants in one or more of these blocks include modulation of HBS1L expression.

### Discussion

This study has identified the principal genetic variants that account for the chromosome 6q QTL for F cells/HbF. These are distributed within three LD blocks which we refer to as HBS1L MYB Intergenic Polymorphism (HMIP) blocks 1, 2 and 3. HMIP blocks 1, 2 and 3 span a nearly contiguous segment approximately 79 kb long, starting 188 by upstream from HBS1L exon 1 and ending 45 kb upstream of MYB (FIG. 6a). Amongst the 12 markers exhibiting the strongest evidence of association, one, rs52090909, is located in the 5′ UTR of exon 1a of HBS1L. The other strongly associated markers in HMIP block 2, are either in intron 1a (rs9376090, rs9399137, rs9402685 and rs11759553), or directly upstream of the 5′ UTR of HBS1L exon 1a (rs4895440, rs4895441, rs9376092, rs9389269, rs9402686, rs11154792 and rs9483788). HMIP block 1 is also located within intron 1a of HBS1L whereas HMIP block 3 is located between exon 1a of HBS1L and the first exon of MYB. While markers within each of the trait-associated blocks are in strong linkage disequilibrium, there is less linkage disequilibrium and a greater diversity of frequent haplotypes between markers in different blocks (Table 10a). The markers interspersed within a trait-associated block that are less significantly associated with the trait have lower linkage disequilibrium with the block markers (Supporting Tables 2a, b and c). Each of the trait-associated blocks contains at least one marker that had also been characterized in the HapMap dataset (18). As we found no significant linkage disequilibrium with HapMap markers outside of the region studied here, we concluded that the trait-associated blocks were confined to the HBS1L-MYB segment. A test of linkage in the European DZ twins showed that the 6q23 QTL is completely accounted for by the markers in the three trait-associated blocks (unadjusted LOD=1.79, p=0.002; LOD adjusted for three markers that identify the trait-associated blocks=0.0).

Based on measured haplotype analysis (Tables 10a and 10b), we estimate that 17.6% of the trait variance is attributed to the markers in the three HBS1 L-MYB blocks. An additional 11.6% of the trait variance is influenced by the Xmn I variant on chromosome 11. As the overall heritability of the FC trait in Europeans is 89% (5), this suggests that additional genetic or other familial factors contribute substantially (residual heritability=59.8%) to the trait variation. The genetic variants that are associated with high F cell levels are also strongly correlated to increased expression of HBS1L in cultured erythroid cells.

Interestingly, however, FC levels and HBS1L expression were not significantly correlated in this sample set despite the association of both traits with the same genetic variants. Examination of the samples showed that this was principally due to the inclusion of two individuals with high FC values who harbor the LL genotype and exhibit low HBS1L expression. The presence of such samples is not unexpected given the selection on genotype, and the fact that most of the FC trait variance (82%) is not accounted for by the HBS1L-MYB locus.

In a previous study of 26 individuals selected to have high or low HbF, we found a negative correlation between FC levels and HBS1L expression (10). The previous sample partially overlaps with the present data set, but it contains 13 (50%) individuals with the block 2H/L genotype, and only 13 with H/H or L/L genotypes. In an attempt to reconcile the results in these two datasets, we re-examined HBS1L expression by repeating all the RT-PCR experiments. Using the new data from all 47 individuals in the combined sample set, we found significant association of block 2 genotypes with FC levels (p=0.007) and with HBS1L expression (day 0: p=0.01; day 3: p=0.03). After adjustment for genotype effects under an additive model, the residual FC trait and HBS1L expressions values were negatively correlated (day 0: ρ=−0.31, p=0.04; day 3: ρ=−0.39, p=0.01) as reported in the original subset. We conclude that multiple factors affect both the FC trait and HBS1L expression, and that these include, but are not limited to the genetic variants within HBS1L-MYB region. The sampling scheme used for ascertainment (e.g. selection on genotype or phenotype) may impact the magnitude and the direction of the observed relationships.

The biological complexity underlying gene regulation in this region is further illustrated through analysis of MYB expression. Although MYB expression was not significantly related to the genotype status (FIG. 9) or to FC levels in the block 2H/H vs. L/L samples, MYB expression at day 3 was positively correlated to HBS1L expression (Supporting Table 11). Moreover, significant correlation remained after adjustment of HBS1L for the associated HBS1L-MYB genotypes. Thus, it would seem that the correlation of HBS1L and MYB expression is principally due to factors outside of the HBS1L-MYB locus.

The location of the most significantly associated variants and their correlation with HBS1L expression implicate HBS1L in the F Cell QTL. HBS1L (16), is a putative member of the ‘GTPases’ super-family (19), which bears a close relationship to the eEF-1A (eukaryotic elongation factor 1A, or EF 1α) and eRF3 (eukaryotic release factor 3) families (16, 20). GTPases, which bind and hydrolyze GTP, are involved in regulating a variety of critical cellular processes, including protein synthesis, cytoskeleton assembly, protein trafficking and signal transduction (19). Recently it has been shown that another GTP-binding protein, the secretion-associated and RAS-related (SAR) protein may be a key molecule in the induction of γ-globin expression by hydroxyurea (21). The role of HBS1L on FC levels is not immediately apparent and could be manifested indirectly through its effect on the expression of various cytokines and transcription factors that impact erythroid cell growth (15).

The present study illustrates how genetic approaches can contribute new knowledge to the regulation of human hemoglobin through dissection of the quantitative genetic variation. The identification of novel transacting genetic variants that are associated with modulation of HbF and FC levels is a key step toward resolving some of the outstanding biological questions in the field and has the potential for novel diagnostic and therapeutic applications.

### Material and Methods

### Subjects and Phenotyping

Study participants consisted of monozygotic and same-sex dizygotic twin pairs of North European descent. The study participants were phenotyped for F-cell levels and genotyped for the XmnI-Gγ site and 121 other markers. The twin pairs who were not selected for HbF or F-cell levels or any disease or trait, were recruited from the TwinsUK Adult Twin Registry (www.twinsuk.ac.uk) (11). The average age of the participants was 47.6 years, ranging from 18 to 79 years. The average FC level of the sample was 4.06% of total erythrocytes (SD 3.15%; range 0.23% to 36.7%).

Blood samples were collected in EDTA, F-cells were enumerated by flow cytometry of 20,000 cells using a monoclonal anti-γ globin chain antibody conjugated with fluorescein isothiocyanate (FITC) (23). Current methods of quantifying HbF are not sensitive enough for measuring levels in the 0-1% range, the range usually encountered in normal subjects. Hence, in normal subjects, the trait is represented by F cells measured using a monoclonal antibody against γ chains of HbF (α₂γ₂).

The study was approved by the local Research Ethics Committee (LREC No: 01-332 and LREC No: 01-083) of King's College Hospital, London. XmnI-Gγ genotyping was performed on genomic DNA as described (24)

### SNP Discovery

A systematic investigation of genetic variants between HBS1L-MYB was made by resequencing this 125-kb region using DNA from 32 European control subjects. The genomic sequence encompassing the region (NT_{—}025741.13, 39,480,452-39,606,881, 126,430 bps) was excised with 1-kb each of adjacent sequences at both ends. PCR primers were designed by PRIMER3 to generate a total of 139 PCR amplicons (ranging from 759 by to 1,725 by with an average length of 1,208 bp) with an overlap of greater than 160 bps between adjacent amplicons. In addition, 428 internal primers were also used for sequencing. Resequencing of the human MYB gene was performed with 50 PCR amplicons generated by PRIMER3 to cover the 15 exons and parts of the introns. PCR was undertaken in 15-uL reaction volumes using 1 unit of ExTaq DNA polymerase (TaKaRa Biomedicals) and 25 ng of genomic DNA. The PCR profile consisted of an initial melting step of 5 minutes at 94° C., followed by 35 cycles of 5 seconds at 98° C., 30 seconds at 60° C., and 2 minutes at 72° C.; and a final elongation step of 10 minutes at 72° C. PCR products were purified using Bio-gel® P100 Gel (Bio-Rad Inc, Hercules, Calif., USA). PCR products were sequenced using the Bigdye Terminator cycle sequencing chemistry method. Reactions were purified using Sephadex™ G-50 Superfine (Amersham Biosciences, Uppsala, Sweden) before applying to the ABI 3730 DNA Analyzers. Detection of genetic variants was performed with in-house software (the Genalys program available at http://www.cng.fr).

### Erythroid Cell Cultures and Expression Analysis of HBS1L and MYB by Quantitative Real Time PCR.

Erythroid cells were cultured using a two-phase liquid system (modified from Fibach et al, 1989 (25)). Mononuclear cells were isolated from peripheral blood by centrifugation on a gradient of Ficoll-Hypaque and cultured for 7 days in phase I medium which consist of serum-free StemSpan (Stem Cell Technologies, UK) supplemented with 1 microgram/ml cyclosporin A, 25 ng/ml interleukin-3 (IL-3), 50 ng/ml human stem cell factor (Sigma, UK), and 0.01% bovine serum albumin (BSA). Cells were incubated at 37° C., 5% CO₂. After 7 days, non-adherent cells were collected and re-seeded at a concentration of 2.5×10⁵ cells/ml in phase II medium [StemSpan supplemented with 10⁻⁷ M dexamethasone (Sigma, UK), 50 ng/ml stem cell factor and 2 U/ml human recombinant erythropoietin (EPO, Sigma, UK)]. The cultures were diluted once or twice to maintain the cell concentration lower than 1×10⁶cells/ml in phase II. Cell samples were collected from phase II cultures on days 0 and 3.

Total RNA was isolated from erythroid cells using Tri-reagent (Sigma, UK) and quantified by absorbance at 260 nm. cDNA was synthesized using SuperScript III reverse transcriptase (Invitrogen, UK) from 1 μg of total RNA. Primers and probes were designed using Primer Express 2.0 program and synthesized by Applied Biosystems. Quantitative RT-PCR was carried out in an ABI 7900 HT Sequence Detection System using TaqMan master mix and the protocol of the manufacturer (Applied Biosystems). Sequences of the primers and probes were:

MYB probe
6-FAM-TGCTACCAACACAGAACCACACATGCA-TAMRA
MYB forward primer
5′-ATGATGAAGACCCTGAGAAGGAAA-3′
MYB reverse primer
5′-AACAGGTGCACTGTCTCCATGA-3′
HBS1L probe
6-FAM-CTATAACTACGATGAAGATTTT-TAMRA
HBS1L forward primer
5′-TCTACAGACTGGCCGTAGAGATCA-3′ (in exon 2)
HBS1L reverse primer
5′-CCCGGCATCGGAATGTT-3′ (in exon 1)

All data were normalized using the endogenous HPRT control. Assays for HPRT are available from the Applied Biosystem database. To quantify gene expression, a relative standard method was used. The quantities of targets and of the endogenous HPRT were determined from the appropriate standard curves. The target amount was then divided by the HPRT amount to obtain a normalized value. One of the experimental samples on day 0 (HPRT normalized) was designated as the calibrator, and given a relative value of 1.0. All quantities (HPRT normalized) were expressed as n-fold relative to the calibrator.

### RNA Analysis

RNA was obtained from Clontech-Europe, UK or prepared from cultured cells using Tri Reagent (Sigma, UK) according to manufacturer's instructions. One pig total RNA was reverse transcribed using SuperScript III RT (Invitrogen, UK) and oligo(dT) primers. 100 ng of cDNA was then used in a 25 μl PCR reaction containing TaqGold (Applied Biosystems, UK) at 2.5 mM MgCl₁₂ and 35 cycles of 94° C. for 30 s, 55° C. for 30 s, and 72° C. for 30s.

### Genotyping

Markers in the target region were selected for genotyping from the dbSNP (http://www.ncbi.nlm.nih.gov/SNP/) and HapMap (http://www.hapmap.org/) databases, or from the sequencing experiments described above. Most markers were genotyped by Taqman (Applied Biosystems, Foster City, Calif., USA). Taqman reactions were performed according to the manufacturer's instructions using 5.0 ng of purified and quantified genomic DNA. Plate reading was conducted on ABI Prism 7900HT sequence Detection System, and analysis was undertaken with SDS 2.0 software. A small number of markers were genotyped by direct sequencing with techniques as described above, or using the tetra primer ARMS method (26). The T homopolymer upstream of MYB (Bpil) was genotyped on a microsatellite genotyping platform from Applied Biosystems, using an ABI Prism 3100 Genetic Analyzer.

### Statistical Methods

The relationship of the quantitative trait with age, sex and marker genotypes was evaluated using the mixed-model ANOVA procedure (PROC MIXED) from SAS version 8.2 (SAS Institute Inc., Cary, N.C., USA) with restricted maximum likelihood estimation. Monozygotic (MZ) and dizygotic (DZ) twins were assumed to have distinct trait variances and covariances. The combined data from Panel 1 and Panel 2 were analyzed assuming common trait variances and equal covariances for MZ and DZ twins in the two panels. Age, sex and marker genotypes were incorporated as fixed effects for analysis. Likelihood ratio tests were used to evaluate hypotheses involving equality of the variances and covariances in different subsets of the data, and to test the fit of the additive genetic model. Haplotype estimates were obtained with the MERLIN and fugue programs (27) and haploview programs (28).

PAP [version 4.2; http://hasstedt.genetics.utah.edu/] was used to estimate effects and to obtain likelihood ratio test statistics in the measured haplotype analysis by modifying the measured genotype procedure (qmlprmv). Briefly, the phenotype trait was simultaneously adjusted for age, sex and the XmnI-Gγ marker whilst fitting a measured genotype model. The variance, correlations for DZ and MZ twins, haplotype means and dominance terms were estimated by maximum likelihood conditional on the observed genotypes at the sites included in the model, the adjusted trait phenotype and the family structure. MZ twins were constrained to be identical-by-descent at the HBS1L-MYB locus by inclusion of a completely linked and fully informative indicator marker. The mean associated with the combination of two haplotypes, Hᵢ and Hⱼ, was written as Mᵢ+Mⱼ, except when considering dominance. In the latter case, the mean was expressed as Mᵢ+Mⱼ+D_{S} for haplotype combinations with presence of hypothesized dominant allele at site S. Under the between-site additive model, the haplotype mean was written as the sum of means associated with the alleles at each site, plus a site-specific dominance term when this was included in the model. Likelihood ratio tests were used to test specific hypotheses involving nested models. A variance-components linkage analysis of FC levels in the DZ twins was performed with the MERLIN program (27) allowing for linkage disequilibrium between markers (29). Tests of population stratification (admixture) were performed with the QTDT program (30).

### REFERENCES

1. Weatherall, D. J. & Clegg, J. B. (2001) Bull World Health Organ 79, 704-12.
2. Thein, S. L. & Craig, J. E. (1998) Hemoglobin 22, 401-414.
3. Platt, O, S., Brambilla, D. J., Rosse, W. F., Milner, P. F., Castro, O., Steinberg, M. H. & Klug, P. P. (1994) New England Journal of Medicine 330, 1639-1644.
4. Ho, P. J., Hall, G. W., Luo, L. Y., Weatherall, D. J. & Thein, S. L. (1998) British Journal of Haematology 100, 70-78.
5. Garner, C., Tatu, T., Reittie, J. E., Littlewood, T., Darley, J., Cervino, S., Farrall, M., Kelly, P., Spector, T. D. & Thein, S. L. (2000) Blood 95, 342-346.
6. Garner, C., Tatu, T., Game, L., Cardon, L. R., Spector, T. D., Farrall, M. & Thein, S. L. (2000) GeneScreen 1, 9-14.
7. Craig, J. E., Rochette, J., Fisher, C. A., Weatherall, D. J., Marc, S., Lathrop, G. M., Demenais, F. & Thein, S. L. (1996) Nature Genetics 12, 58-64.
8. Garner, C., Mitchell, J., Hatzis, T., Reittie, J., Farrell, M. & Thein, S. L. (1998) American Journal of Human Genetics 62, 1468-1474.
9. Close, J., Game, L., Clark, B. E., Bergounioux, J., Gerovassili, A. & Thein, S. L. (2004) BMC Genomics 5, 33.
10. Jiang, J., Best, S., Menzel, S., Silver, N., Lai, M. I., Surdulescu, G. L., Spector, T. D. & Thein, S. L. (2006) Blood 108, 1077-1083.
11. Spector, T. D. & MacGregor, A. J. (2002) Twin Res 5, 440-443.
12. Sampietro, M., Thein, S. L., Contreras, M. & Pazmany, L. (1992) Blood 79, 832-833.
13. Emambokus, N., Vegiopoulos, A., Harman, B., Jenkinson, E., Anderson, G. & Frampton, J. (2003) EMBO J. 22, 4478-4488.
14. Oh, I. H. & Reddy, E. P. (1999) Oncogene 18, 3017-3033.
15. Cantor, A. B. & Orkin, S. H. (2002) Oncogene 21, 3368-3376.
16. Wallrapp, C., Verrier, S.-B., Zhouravleva, G., Philippe, H., Philippe, M., Gress, T. M. & Jean-Jean, O. (1998) FEBS Letters 440, 387-392.
17. Ko, L. J. & Engel, J. D. (1993) Mol Cell Biol 13, 4011-4022.
18. The International HapMap Consortium, Altshuler, D., Brooks, L. D., Chakravarti, A., Collins, F. S., Daly, M. J. & Donnelly, P. (2005) Nature 437, 1299-1320.
19. Bourne, H. R., Sanders, D. A. & McCormick, F. (1990) Nature 348, 125-132.
20. Inge-Vechtomov, S., Zhouravleva, G. & Philippe, M. (2003) Biol Cell 95, 195-209.
21. Tang, D. C., Zhu, J., Liu, W., Chin, K., Sun, J., Chen, L., Hanover, J. A. & Rodgers, G. P. (2005) Blood 106, 3256-3263.
22. Thein, S. L., Sampietro, M., Rohde, K., Rochette, J., Weatherall, D. J., Lathrop, G. M. & Demenais, F. (1994) American Journal of Human Genetics 54, 214-228.
23. Thorpe, S. J., Thein, S. L., Sampietro, M., Craig, J. E., Mahon, B. & Huelva, E. R. (1994) British Journal of Haematology 87, 125-132.
24. Craig, J. E., Sheerin, S. M., Barnetson, R. & Thein, S. L. (1993) British Journal of Haematology 84, 106-110.
25. Fibach, E., Manor, D., Oppenheim, A. & Rachniilewitz, E. A. (1989) Blood 73, 100-103.
26. Ye, S., Dhillon, S., Ke, X., Collins, A. R. & Day, I. N. (2001) Nucleic Acids Res 29, E88-8.
27. Abecasis, G. R., Chemy, S. S., Cookson, W. O. & Cardon, L. R. (2002) Nat Genet. 30, 97-101.
28. Barrett, J. C., Fry, B., Mailer, J. & Daly, M. J. (2005) Bioinformatics 21, 263-265.
29. Abecasis, G. R. & Wigginton, J. E. (2005) Am J Hum Genet. 77, 754-767.
30. Abecasis, G. R., Cardon, L. R. & Cookson, W. O. (2000) Am J Hum Genet. 66, 279-292.

### Example 3

### SNP Typing Protocol

The single nucleotide polymorphism (SNP) genotyping assays will be carried out using the Illumina® GoldenGate® assay system with VeraCode™ technology. Up to 384 SNPs can be interrogated simultaneously within a single well of a standard microplate. Genomic DNA is isolated from peripheral blood using standard techniques. The DNA is diluted to 50 ng/μl. Each assay requires 250 μg of DNA.

The following steps are a summary of the Illumina® Golden Gate® system:

1. Activation step to enable binding to Streptavidin/Biotin paramagnetic particles

2. Add DNA to oligonucleotides and hybridize (3 oligos are designed for each SNP locus, two allele-specific Cy3 or Cy5 forward primers and one locus-specific reverse primer which also carries a unique SNP-identifier address oligo).

3. The product then goes through an extension, ligation and clean up protocol

4. The product is then used as a template for PCR using the hybridized universal dye-labelled PCR primers

5. After down-stream processing, the single-stranded, dye-labelled DNAs are hybridized to their complement VeraCode bead-type on a VeraCode BeadPlate.

If 100 SNPs are to be tested, there will be 100 bead types, each with a unique “address” oligo pre-attached which will in turn allow binding of only one locus-specific SNP product.

The bead signal is read in the BeadXpress Reader System, which is a high-throughput, dual-color laser detection system that enables scanning of a broad range of multiplexed assays.

Data is analysed using the BeadStudio data analysis software or other third-party analysis programs.

### Example 4

### The HMIP-2 Locus Chromosome 6 Influences Fetal Hemoglobin in Sickle Cell Disease Patients of African Descent

### Introduction

In Europeans, three genetic loci contribute nearly half of all F-cell variability: the promoter of one of the HbF encoding genes (^{G}γ) on chromosome 11p15 itself (10.2% of the variance)¹, the HMIP locus on chromosome 6q (19.4%)² and the oncogene BCL11A on chromosome 2p (15.1%)³. The HMIP system contains three haplotype blocks, of which the second, HMIP-2 has the strongest effect in healthy Caucasian individuals². The present inventors set out to gauge the relevance of this locus for patients with sickle cell disease (SCD), since in these patients, elevated levels of fetal haemoglobin and F-cells have a disease-ameliorating effect. SCD patients in Britain are mostly of African and not of European ancestry. They tested a tag SNP for this block in patients with SCD.

### Subjects and Methods

88 patients homozygous for the Glu6Val Sickle hemoglobin mutation were recruited from the specialist clinic in the Haematology Outpatient Unit of King's College Hospital (Hospital Ethics Committee Protocol No. 01-083). All are of African descent, with the majority from West Africa. It was estimated that about a quarter had an admixed Caribbean genetic heritage.

HbF proportion in total hemoglobin (measured in a routine clinical setting by HPLC on a BioRad Variant II system, and log transformed) was used as a phenotype. Genotyping was performed by PCR/restriction assay for XmnI^{G}γ (rs7482144)⁴, or by TaqMan (Applied Biosystems, Foster City, Calif.), a hybridization based procedure, for all HMIP-2 markers (Table 13).

Genetic association of FC and HbF traits with HMIP-2 markers was tested for by linear regression (SPSS v.12) under a simple additive model. The HbF trait in our patients was adjusted for sex only, because age and the beta globin locus did not affect the trait.

### Results

Genetic association testing showed an influence of the HMIP-2 locus on fetal hemoglobin traits in the SCD patients): The tag marker^{2,3} for this locus, rs9399137, was associated with HbF in the patients with SCD (p=0.018).

To survey the association across the entire LD block, the study was extended to a set of eleven SNPs (Single Nucleotide Polymorphisms, Table 1) across the HMIP-2 block, which had previously shown very strong influence on F-cells in Caucasians². Of these, only one other marker, rs4895441, was associated with HbF values.

### Discussion

The association of genetic variation in a 24-kb HBS1L-cMYB intergenic interval, termed HMIP-2, previously seen with fetal hemoglobin traits in Caucasian healthy individuals (Example 2), can also be detected in a group of patients with SCD from London. This finding adds clinical relevance to the previous results obtained from normals.

### REFERENCES FOR EXAMPLE 4

1. Garner C, Tatu T, Game L, et al. A candidate gene study of F cell levels in sibling pairs using a joint linkage and association analysis. GeneScreen. 2000; 1:9-14.
2. Thein S L, Menzel S, Peng X, et al. Intergenic variants of HBS1L-MYB are responsible for a major quantitative trait locus on chromosome 6q23 influencing fetal hemoglobin levels in adults. Proc Natl Acad Sci USA. 2007; 104:11346-11351.
3. Menzel S, Jiang J, Silver N, et al. The HBS1L-MYB intergenic region on chromosome 6q23.3 influences erythrocyte, platelet, and monocyte counts in humans. Blood. 2007; 110:3624-3626.
4. Craig J E, Sheerin S M, Barnetson R, Thein S L. The molecular basis of HPFH in a British family identified by heteroduplex formation. British Journal of Haematology. 1993;84:106-110.

### Example 5

### Extension of the Search for Genetic Loci Influencing Fetal Haemoglobin in a Caucasian Population

### Introduction

The amount of fetal haemoglobin remaining in the circulation of adult individuals is determined by the number of HbF-containing erythrocytes, which are referred to as F cells. The level of F cells comprises a quantitative genetic trait with very high heritability (89%). To date, three major quantitative trait loci (QTLs) for this trait have been identified: the XmnI-Gγ site in the β globin locus on chromosome 11p15¹, the HBS1L-MYB intergenic region on chromosome 6q23², and the BCL11A locus on chromosome 2p³. Together, these loci account for over 50% of the total variance of the F-cell trait in healthy Caucasian populations. In this example, the present inventors provide 16 candidate loci for genes that determine part of the residual genetic variance that is so far unexplained.

### Methods

The initial study group was extended with another about 1000 persons from the St. Thomas UK Adult Twin Registry, www.twinsuk.ac.uk⁴. Additional genome-wide scanning was performed by the Sanger Centre on a platform using the Illumina Sentrix® HumanHap300 BeadChip. For about 300,000 markers retained after quality-control, association was assessed using a mixed linear model that included a random effects covariance matrix for each twin type and fixed effects for age, sex and genotype (analysis performed by Chad Garner, Irving, Calif., US). The most simple model used for first-round analysis (‘geno’ in FIG. 10) does not take any of the known F-cell loci into consideration, whereas the second model (‘Geno+c6+c11+c2’ in FIG. 10) considers all known loci as covariates, and the remaining models test for genetic interaction of the new loci with each of the previously known ones (‘Geno*Xmn1’, ‘Geno*BCL11A_{—}1’, Geno*BCL11A2′, ‘Geno*c6q23_{—}1’, ‘Geno*c6q232’ in FIG. 10).

### Results

Sixteen candidate loci were identified that are likely to contain genes that underlie the residual trait variance (about 40%) that is also due to genes, but so far unexplained.

Seven of the new loci were derived from our first-round analysis with the simplest model, to restrict type 1 error, and they reached a significance of p<10⁻⁵, or a log score of above 5. The nine remaining loci showed a clustering of several associated SNPs and showed association under several models, with p-values generally under 10⁻³ (Tables 14 and 15).

### Discussion

The present authors have identified 16 candidate QTLs for F-cell levels and HbF persistence.

### REFERENCES FOR EXAMPLE 5

1. Gamer C, Tatu T, Game L, et al. A candidate gene study of F cell levels in sibling pairs using a joint linkage and association analysis. GeneScreen. 2000; 1:9-14.
2. Thein S L, Menzel S, Peng X, et al. Intergenic variants of HBS1L-MYB are responsible for a major quantitative trait locus on chromosome 6q23 influencing fetal hemoglobin levels in adults. Proc Natl Acad Sci USA. 2007; 104:11346-11351.
3. Menzel S, Garner C, Gut I, et al. A QTL influencing F cell production maps to a gene encoding a zinc-finger protein on chromosome 2p15. Nat. Genet. 2007; 39:1197-1199.
4. Spector T D, MacGregor A L The St. Thomas' UK Adult Twin Registry. Twin Res. 2002; 5:440-443.

### LEGENDS FOR TABLES 1, 8 TO 11 AND 15

### Table 1

a) Results for representative markers for the three principal F cell QTLs.

b) Haplotype frequencies in the unselected twin panel for representative 2p15 markers.

### Table 8a

Markers genotyped in the study. Contig positions are with reference to NT_{—}025741.13. P-values for the mixed-model ANOVA tests the alternative hypothesis of different trait means for each genotype against the null hypothesis that the genotype means are equal. Markers without p-values reported for the 2nd panel have been genotyped only in the 1st panel. There was no evidence (P>0.05) of population stratification with a between-family variance-components test.

### Table 8b

Positions, genotype counts and p-values for the mixed-model ANOVA tests of association for markers within the three trait-associated blocks. Markers forming the trait associated blocks are indicated in bold. Results are also shown for markers interspersed with these. Some markers appear twice in the table because block 2 and block 3 overlap. Genotype counts include both members of each twin pair. The global p-value is calculated by comparing the null hypothesis of equal genotype means to the alternative of unconstrained genotype means. Dominance was evaluated when three genotype classes were observed. The additive (per-allele) substitution effect contrasting the reference and alternative alleles at each marker are shown (beta & s.e.).

### Table 9

Frequent haplotypes (>2%) formed by markers in the genomic segments spanned by the three trait-associated blocks: (a)=block 1; (b)=block 2; (c)=block 3 The trait associated blocks consist of all markers in the study that were concordant on frequent haplotypes (i.e. in complete linkage disequilibrium) with rs52090901, rs9399137 or rs6929404, the markers obtained in the stepwise selection procedure. The block extremities coincide with the positions of the most proximal and distal markers within each block. The haplotypes include other markers that are situated between the block extremities but are not in complete linkage disequilibrium with the block markers, which are shown in bold.

### Table 10a

Detailed results of association of three SNPs in the HBS1L-MYB intergenic region and FC trait using Measured Haplotype Analysis in the combined European twin panels. Seven haplotype-specific effects [log(FC %)] are fitted in the unrestricted (general) model [haplotype TCA is very rare (frequency <0.1%) so a specific effect was not modelled]. The estimated trait mean for a haplotype combination is the sum of the two additive haplotype mean estimates, plus a dominance effect when rs9399137 is heterozygous (−0.12±0.03). Dominance terms are not significant at other sites, and therefore, are not included. Means for each haplotype fitted under the restricted additive allele substitution model are shown for comparison. Allele-specific substitution effects are tabulated in Supporting table 3b. The haplotypes are ordered to highlight allele substitution at rs9399137 with different allele backgrounds at the other sites. Under the allele substitution model, the T to C substitution at rs9399137 results in a change of 0.53±0.03 (Supporting table 3b) in the haplotype mean irrespective of the background. The comparison of the haplotype estimates under the general and allele substitution models shows that the latter provides a good fit to the data for this site. Similar observations hold for the other sites, and overall the allele substitution model is not rejected when tested against the unrestricted measured haplotype model (χ23=5.8; p=0.12).

### Table 10b

Detailed results of association between three SNPs in the HBS1L-MYB intergenic region and FC trait using Measured Haplotype Analysis in European twins. Results from an additive allele substitution model (a nested model fitted within the measured haplotype analysis framework) are shown. Substitution effects are scaled as natural log(FC %). “Effect” denotes the maximum likelihood estimate (MLE) of the additive effect, s.e. denotes the standard error of this MLE.

### Table 11

Correlation of HBS1L and MYB expression for day 0 and for day 3. Upper triangle correlation coefficients. Lower triangle: p-values for correlation.

### Table 15

New loci showing evidence for association with the F-cell trait in Caucasian healthy individuals. For each locus, all identified associated SNPs are shown.

TABLE 1a

| | | Allele | Association Test | | | Contriutions to F cell variation (%) | | | |
|---|---|---|---|---|---|---|---|---|---|
| | | Frequency | (p-value) | | | Unselected Twins | | | |
| | | Low/High FC | | Replication | | N = 720 | | | |
| | | GWA & | GWA panel | panel | Both | Variance | ANOVA | QTDT^{c} | Variance |
| Polymorphism | Location (bp) | Replication | N = 179 | N = 90 | N = 269 | (SNP) | p-value | p-value | (Locus) |
| chr 2p15 | | | | | | | | | |
| rs243027 | 60,460,511 | 0.44/0.72 | 4.6E−08 | 6.9E−04 | 2.2E−10 | 3.8 | 1.2E−04 | n.s. | 15.1 |
| rs243081 | 60,467,280 | 0.41/0.71 | 3.8E−09 | 8.7E−05 | 2.5E−12 | 4.4 | 1.9E−04 | n.s. | |
| rs6732518^{a} | 60,562,101 | 0.19/0.59 | 6.1E−13 | 2.0E−10 | 2.1E−21 | 11.1 | 1.1E−21 | 1.0E−04 | |
| rs1427407^{b} | 60,571,547 | 0.03/0.42 | 2.5E−20 | 1.5E−11 | 6.1E−31 | 13.1 | 2.5E−22 | 1.7E−03 | |
| rs766432 | 60,573,474 | 0.03/0.41 | 1.8E−17 | 5.8E−12 | 1.8E−28 | 13.5 | 1.7E−23 | 3.0E−04 | |
| rs4671393^{a,b} | 60,574,455 | 0.03/0.41 | 5.5E−17 | 5.3E−11 | 2.6E−27 | 14.3 | 2.0E−22 | 9.0E−04 | |
| chr 6q23 | | | | | | | | | |
| rs6904897^{a} | 135,424,673 | 0.35/0.56 | 8.2E−06 | 1.5E−02 | 1.2E−06 | 2.7 | 3.4E−05 | 8.0E−02 | 19.4 |
| rs9399137^{a} | 135,460,711 | 0.18/0.57 | 2.8E−27 | 2.1E−11 | 2.5E−36 | 15.8 | 1.9E−30 | 6.0E−05 | |
| rs1320963^{a} | 135,484,905 | 0.38/0.10 | 5.4E−10 | 1.2E−06 | 4.1E−15 | 6.7 | 9.0E−12 | 1.2E−02 | |
| chr 11p15.4 | | | | | | | | | |
| Xmn I-Gγ^{a} | 5,232,745 | 0.10/0.63 | 2.0E−30 | 4.0E−11 | 2.4E−38 | 10.2 | 1.2E−17 | n.s. | 10.2 |

^{a}Markers that are not part of the genome-wide SNP set.
^{b}Markers that were used for estimating the locus contribution to the variance.

TABLE 1b

| Haplotype^{a} | Frequency^{b} |
|---|---|
| ACTGAG | 0.342 |
| ACCGAG | 0.058 |
| ACCTAG | 0.009 |
| ACCTCA | 0.123 |
| ATCGAG | 0.026 |
| CTTGAG | 0.358 |
| CTCGAG | 0.059 |
| CTCTCA | 0.011 |

^{a}based on markers rs243027-rs243081-rs6732518-rs1427407-rs766432-rs4671393
^{b}maximum likelihood estimates (MLE) of haplotype frequencies calculated using EM algorithm

TABLE 2
Test statistics for markers from the interval 60,334,477 to 60,831,488
on chromosome 2 genotyped in 179 individuals of the GWA panel.

| | | Allele | Linear | | |
|---|---|---|---|---|---|
| | | Asso- | Re- | | |
| Chromosome | | ciation | gression | | |
| position | dbSNP ID | p-values | p-values | HapMap | Illumina |
| 60334477 | rs359250 | 1.0E+00 | 9.6E−01 | Y | Y |
| 60338011 | rs359255 | 1.0E+00 | 9.6E−01 | Y | Y |
| 60339658 | rs1553935 | 7.4E−01 | 7.6E−01 | Y | Y |
| 60350798 | rs4671383 | 8.3E−01 | 3.8E−01 | Y | Y |
| 60353988 | rs2110398 | 1.0E+00 | 5.2E−01 | Y | Y |
| 60356734 | rs907574 | 1.0E+00 | 6.8E−01 | Y | Y |
| 60380898 | rs4672384 | 7.4E−01 | 7.7E−01 | Y | Y |
| 60385751 | rs17039727 | 8.2E−01 | 8.8E−01 | Y | Y |
| 60386306 | rs963261 | 2.0E−01 | 6.3E−01 | Y | Y |
| 60387703 | rs6545803 | 6.3E−01 | 8.3E−01 | Y | Y |
| 60392231 | rs6750077 | 7.2E−01 | 3.6E−01 | Y | Y |
| 60395357 | rs7595905 | 1.6E−01 | 7.4E−01 | Y | Y |
| 60401071 | rs11125833 | 8.3E−01 | 8.3E−01 | Y | Y |
| 60405305 | rs1512226 | 6.7E−01 | 8.1E−01 | Y | Y |
| 60406647 | rs7567242 | 6.0E−01 | 7.6E−01 | Y | Y |
| 60415196 | rs1512227 | 1.0E+00 | 5.5E−01 | Y | Y |
| 60415435 | rs1512228 | 1.0E+00 | 5.7E−01 | Y | Y |
| 60430793 | rs184838 | 7.3E−01 | 1.3E−01 | Y | Y |
| 60434335 | rs9309325 | 5.2E−01 | 9.6E−02 | Y | Y |
| 60434598 | rs7573683 | 7.5E−01 | 3.6E−01 | Y | Y |
| 60437022 | rs6716729 | 1.4E−01 | 3.3E−01 | Y | Y |
| 60437231 | rs243023 | 3.5E−01 | 6.0E−01 | Y | Y |
| 60438323 | rs243021 | 2.4E−01 | 6.9E−02 | Y | Y |
| 60450764 | rs243040 | 1.4E−02 | 9.8E−03 | Y | Y |
| 60451069 | rs243039 | 2.5E−02 | 1.9E−03 | Y | |
| 60451642 | rs17330660 | 3.4E−01 | 9.8E−01 | Y | |
| 60452176 | rs4672388 | 2.9E−02 | 2.4E−03 | Y | |
| 60452260 | rs243038 | 5.8E−02 | 1.3E−02 | | |
| 60452604 | rs243037 | 3.0E−02 | 1.9E−03 | Y | |
| 60453101 | rs1003691 | 1.7E−02 | 1.2E−03 | Y | |
| 60453492 | rs1003690 | 1.0E+00 | 9.3E−01 | Y | |
| 60454880 | rs243035 | 4.5E−01 | 3.7E−01 | Y | Y |
| 60455724 | rs17402613 | 2.3E−02 | 3.4E−02 | | |
| 60456396 | rs243034 | 2.7E−01 | 3.4E−01 | Y | Y |
| 60457106 | rs243033 | 9.4E−05 | 2.7E−03 | | |
| 60457454 | rs243032 | 4.2E−07 | 1.5E−05 | Y | |
| 60458151 | rs4672389 | 1.0E+00 | 7.1E−01 | Y | |
| 60458534 | rs4671389 | 1.0E+00 | 7.2E−01 | Y | |
| 60459423 | rs173373 | 7.0E−09 | 1.9E−07 | Y | |
| 60460075 | rs243030 | 1.7E−08 | 6.2E−07 | Y | |
| 60460158 | rs243029 | 4.2E−08 | 6.6E−07 | Y | |
| 60460511 | rs243027 | 2.7E−08 | 1.4E−06 | Y | Y |
| 60461232 | rs13027161 | 3.5E−08 | 3.6E−07 | Y | |
| 60461887 | rs2668729 | 3.2E−08 | 5.0E−07 | Y | |
| 60462263 | rs2540917 | 5.6E−09 | 1.5E−07 | Y | |
| 60462434 | rs2540916 | 1.6E−07 | 1.2E−06 | Y | |
| 60462978 | rs9967849 | 7.6E−09 | 2.1E−07 | Y | |
| 60463400 | rs1553934 | 1.8E−08 | 1.9E−07 | Y | |
| 60463728 | rs12622360 | 1.0E+00 | 9.2E−01 | Y | |
| 60463915 | rs2540914 | 4.1E−03 | 2.6E−03 | Y | |
| 60464789 | rs925483 | 2.6E−09 | 9.0E−08 | Y | |
| 60464941 | rs925484 | 3.1E−09 | 1.1E−07 | Y | |
| 60465512 | rs2137281 | 9.4E−10 | 4.2E−08 | Y | |
| 60465574 | rs2137282 | 7.4E−05 | 1.1E−03 | Y | |
| 60465961 | rs2137283 | 1.7E−09 | 3.2E−08 | Y | |
| 60466627 | rs243082 | 7.9E−05 | 1.2E−03 | | |
| 60467280 | rs243081 | 2.2E−09 | 7.9E−08 | Y | Y |
| 60468076 | rs243080 | 2.7E−08 | 3.5E−07 | Y | |
| 60468532 | rs243079 | 2.0E−09 | 3.9E−08 | Y | |
| 60468807 | rs243078 | 1.3E−08 | 1.8E−07 | Y | |
| 60470186 | rs243077 | 6.8E−04 | 9.6E−04 | | |
| 60471067 | rs243076 | 1.4E−08 | 9.6E−07 | Y | |
| 60471075 | rs243075 | 2.1E−03 | 6.1E−04 | | |
| 60471265 | rs243074 | 7.0E−03 | 5.4E−03 | Y | |
| 60472194 | rs243073 | 6.4E−04 | 4.5E−04 | Y | Y |
| 60472300 | rs243072 | 3.0E−03 | 1.8E−03 | Y | |
| 60472532 | rs243071 | 7.1E−03 | 5.6E−03 | Y | |
| 60473318 | rs13401861 | 4.0E−04 | 5.7E−03 | Y | |
| 60473790 | rs243070 | 1.7E−05 | 5.4E−04 | Y | |
| 60475147 | rs243067 | 1.1E−08 | 4.8E−07 | Y | |
| 60475270 | rs243066 | 5.4E−10 | 2.9E−08 | Y | |
| 60475568 | rs243065 | 3.1E−09 | 9.7E−08 | Y | |
| 60475777 | rs243064 | 2.9E−03 | 1.3E−03 | | |
| 60475785 | rs3732180 | 1.1E−03 | 1.0E−02 | Y | |
| 60475995 | rs7589285 | 5.6E−04 | 6.6E−03 | Y | |
| 60476403 | rs243063 | 6.9E−09 | 5.1E−07 | Y | |
| 60477180 | rs243062 | 4.2E−10 | 4.2E−09 | | |
| 60477202 | rs243061 | 2.0E−09 | 3.1E−08 | | |
| 60477214 | rs243060 | 2.5E−03 | 6.7E−03 | | |
| 60477309 | rs243058 | 7.7E−03 | 5.2E−03 | | |
| 60478443 | rs9309326 | 1.4E−03 | 1.2E−02 | Y | Y |
| 60478904 | rs184839 | 3.0E−03 | 2.1E−03 | Y | |
| 60479184 | rs12713420 | 1.4E−02 | 6.1E−03 | | |
| 60479750 | rs3948623 | 1.0E+00 | 8.5E−01 | Y | |
| 60480326 | rs13011022 | 1.4E−09 | 1.3E−08 | Y | |
| 60481069 | rs11125841 | 3.3E−08 | 8.5E−07 | | |
| 60481740 | rs1008616 | 1.0E+00 | 7.5E−01 | | |
| 60482179 | rs17027890 | 5.8E−01 | 3.3E−01 | | |
| 60483113 | rs888082 | 3.1E−09 | 5.9E−08 | Y | |
| 60484733 | rs12995080 | 1.2E−05 | 3.2E−04 | | |
| 60484796 | rs9989884 | 1.3E−01 | 5.7E−02 | Y | |
| 60486868 | rs13009393 | 2.2E−10 | 1.2E−08 | Y | |
| 60489196 | rs7586253 | 8.8E−03 | 4.3E−03 | Y | |
| 60489418 | rs7572340 | 8.5E−01 | 9.6E−01 | Y | |
| 60489920 | rs12464462 | 1.9E−09 | 3.6E−08 | Y | |
| 60490001 | rs12472541 | 3.9E−04 | 6.7E−03 | Y | |
| 60491160 | rs10445937 | 3.1E−09 | 1.1E−07 | Y | |
| 60492477 | rs17027967 | 1.0E+00 | 8.7E−01 | | |
| 60493237 | rs17330904 | 1.0E−03 | 5.1E−04 | | |
| 60493408 | rs12476132 | 2.9E−09 | 8.4E−08 | Y | |
| 60494311 | rs11125842 | 8.3E−08 | 1.2E−06 | Y | |
| 60494740 | rs17028031 | 1.0E+00 | 8.5E−01 | Y | |
| 60494833 | rs13028240 | 1.4E−05 | 3.6E−04 | Y | |
| 60502647 | rs12997266 | 1.9E−09 | 1.7E−08 | | |
| 60504220 | rs12104736 | 9.0E−09 | 1.2E−07 | Y | |
| 60505565 | rs13013119 | 3.7E−05 | 1.4E−04 | | |
| 60506291 | rs10180309 | 8.4E−02 | 8.7E−02 | | |
| 60507076 | rs1035831 | 6.4E−03 | 4.1E−03 | Y | |
| 60509183 | rs10490070 | 9.6E−05 | 1.7E−03 | Y | |
| 60510496 | rs13011256 | 4.5E−05 | 6.3E−04 | | |
| 60510522 | rs11894442 | 3.6E−08 | 1.3E−07 | Y | |
| 60510602 | rs11889919 | 1.3E−02 | 7.8E−03 | Y | |
| 60510966 | rs1861432 | 7.5E−03 | 4.4E−03 | Y | |
| 60511329 | rs1861431 | 8.4E−03 | 5.6E−03 | Y | |
| 60512811 | rs6718203 | 8.4E−04 | 7.0E−04 | Y | |
| 60513812 | rs17402905 | 8.0E−05 | 1.8E−03 | Y | |
| 60514026 | rs17402912 | 4.6E−05 | 1.2E−03 | Y | |
| 60515653 | rs17331017 | 6.4E−05 | 2.5E−03 | Y | |
| 60517302 | rs8179712 | 8.5E−01 | 8.6E−01 | Y | Y |
| 60518159 | rs1012223 | 3.9E−03 | 2.2E−03 | | |
| 60518580 | rs17028162 | 5.8E−01 | 3.3E−01 | | |
| 60519272 | rs1011407 | 7.3E−04 | 4.1E−04 | Y | Y |
| 60519579 | rs1011406 | 1.1E−03 | 6.9E−04 | Y | |
| 60522224 | rs12479062 | 1.0E+00 | 7.3E−01 | | |
| 60522394 | rs10490071 | 5.3E−05 | 4.5E−04 | Y | Y |
| 60522998 | rs11884411 | 1.9E−09 | 8.3E−08 | Y | |
| 60523435 | rs10490072 | 3.1E−04 | 7.1E−04 | Y | |
| 60523981 | rs12468946 | 7.3E−09 | 2.8E−07 | Y | |
| 60524843 | rs17028192 | 3.1E−04 | 7.1E−04 | | |
| 60525061 | rs1012585 | 1.5E−02 | 5.4E−03 | Y | Y |
| 60525759 | rs3034649 | 5.7E−05 | 1.4E−03 | Y | |
| 60526749 | rs35696517 | 2.4E−03 | 1.4E−02 | | |
| 60529867 | rs17028222 | 1.1E−02 | 8.2E−03 | Y | |
| 60531276 | rs9309327 | 8.6E−02 | 3.1E−02 | Y | |
| 60532730 | rs2058703 | 3.0E−02 | 7.0E−02 | Y | Y |
| 60533446 | rs17331129 | 1.0E−05 | 4.3E−04 | Y | |
| 60535951 | rs12621957 | 4.4E−01 | 2.8E−01 | Y | |
| 60536877 | rs17028290 | 8.4E−01 | 6.2E−01 | Y | |
| 60541463 | rs7569946 | 5.1E−02 | 1.6E−01 | | |
| 60543252 | rs9789627 | 5.0E−02 | 9.9E−02 | Y | Y |
| 60551158 | rs4672393 | 1.1E−02 | 5.5E−03 | Y | |
| 60551791 | rs12469024 | 1.0E+00 | 6.5E−01 | Y | |
| 60551901 | rs12477097 | 1.2E−03 | 4.1E−04 | Y | |
| 60551965 | rs4672394 | 1.4E−02 | 8.1E−03 | Y | |
| 60556270 | rs733628 | 8.7E−04 | 5.7E−04 | Y | Y |
| 60557988 | rs7581162 | 3.7E−01 | 2.8E−01 | Y | |
| 60558437 | rs7593947 | 7.9E−02 | 1.1E−01 | Y | |
| 60559112 | rs34737760 | 2.5E−04 | 3.0E−04 | | |
| 60559763 | ss69358119 | 3.9E−04 | 4.6E−04 | | |
| 60560542 | rs12992182 | 2.5E−04 | 3.2E−04 | | |
| 60560686 | rs12997966 | 2.1E−04 | 3.9E−04 | | |
| 60561092 | rs1123573 | 1.8E−02 | 3.9E−02 | Y | Y |
| 60561398 | rs7579014 | 1.2E−06 | 2.3E−06 | Y | |
| 60561445 | rs35908689 | 2.5E−04 | 3.1E−04 | | |
| 60562101 | rs6732518 | 4.1E−13 | 2.4E−10 | Y | Y |
| 60562593 | ss69358111 | 8.1E−01 | 7.2E−01 | | |
| 60564075 | rs13019832 | 9.8E−12 | 7.6E−12 | Y | |
| 60564119 | ss69358110 | 4.3E−01 | 4.2E−01 | | |
| 60564242 | rs11692396 | 7.9E−12 | 1.9E−10 | Y | |
| 60566739 | rs10189857 | 1.0E+00 | 9.7E−01 | Y | |
| 60568365 | rs6545816 | 3.2E−02 | 3.0E−02 | Y | Y |
| 60568683 | rs6545817 | 2.0E−02 | 1.7E−02 | Y | |
| 60569812 | rs13024177 | 5.9E−04 | 3.2E−03 | Y | |
| 60570903 | rs13031396 | 2.1E−04 | 9.5E−04 | Y | |
| 60571547 | rs1427407 | 5.6E−20 | 6.4E−20 | Y | Y |
| 60572352 | rs1896293 | 2.0E−07 | 8.0E−07 | | |
| 60572578 | rs1896294 | 1.7E−10 | 1.4E−09 | Y | |
| 60573422 | rs766431 | 2.7E−07 | 1.7E−05 | Y | |
| 60573474 | rs766432 | 1.7E−17 | 3.9E−16 | Y | |
| 60573750 | rs11886868 | 4.2E−11 | 1.1E−09 | Y | |
| 60573824 | rs34211119 | 7.0E−02 | 8.1E−11 | | |
| 60574093 | rs10195871 | 5.4E−11 | 1.2E−09 | Y | |
| 60574261 | rs10172646 | 4.3E−11 | 4.5E−10 | Y | |
| 60574455 | rs4671393 | 1.2E−16 | 2.8E−16 | Y | |
| 60574815 | rs7584113 | 2.9E−10 | 2.3E−09 | Y | |
| 60574851 | rs7557939 | 4.6E−11 | 6.7E−10 | Y | |
| 60575544 | rs6706648 | 9.3E−08 | 1.5E−07 | Y | |
| 60575745 | rs6738440 | 6.0E−06 | 1.5E−05 | Y | |
| 60576770 | rs7565301 | 8.0E−01 | 5.8E−01 | Y | |
| 60577176 | rs6729815 | 5.1E−02 | 3.9E−02 | Y | |
| 60580920 | rs7560588 | 6.1E−01 | 7.2E−01 | | |
| 60581133 | rs6709302 | 1.1E−05 | 2.3E−05 | Y | |
| 60582798 | rs10184550 | 1.9E−02 | 1.2E−01 | Y | Y |
| 60584843 | ss69358098 | 6.8E−02 | 1.3E−01 | | |
| 60590341 | rs6724431 | 6.6E−01 | 5.2E−01 | Y | Y |
| 60591731 | rs1896297 | 3.4E−02 | 4.5E−02 | Y | Y |
| 60602582 | rs76673 | 1.6E−02 | 5.0E−02 | Y | Y |
| 60616006 | rs2556378 | 2.0E−03 | 1.5E−03 | Y | Y |
| 60637076 | rs3765154 | 3.5E−01 | 1.8E−01 | Y | Y |
| 60639441 | rs12328348 | 5.9E−01 | 3.6E−01 | Y | Y |
| 60652625 | rs356982 | 2.2E−01 | 1.4E−01 | Y | Y |
| 60658901 | rs357004 | 9.2E−01 | 6.7E−01 | Y | Y |
| 60665088 | rs356999 | 6.6E−01 | 2.3E−01 | Y | Y |
| 60667970 | rs2195086 | 3.7E−01 | 2.7E−01 | Y | Y |
| 60678945 | rs1510480 | 8.3E−01 | 6.3E−01 | Y | Y |
| 60686166 | rs2042799 | 5.8E−01 | 3.4E−01 | Y | Y |
| 60691660 | rs2059710 | 4.1E−01 | 3.1E−01 | Y | Y |
| 60700362 | rs4672396 | 8.7E−02 | 2.4E−02 | Y | Y |
| 60708275 | rs10496088 | 7.6E−01 | 9.3E−01 | Y | Y |
| 60720330 | rs1866206 | 8.2E−01 | 5.0E−01 | Y | Y |
| 60722118 | rs842767 | 2.4E−01 | 6.1E−02 | Y | Y |
| 60726355 | rs842764 | 3.0E−02 | 2.2E−03 | Y | Y |
| 60741706 | rs881952 | 1.0E+00 | 8.0E−01 | Y | Y |
| 60750244 | rs2420382 | 1.2E−01 | 8.5E−03 | Y | Y |
| 60752167 | rs1344915 | 1.3E−01 | 2.2E−02 | Y | Y |
| 60763537 | rs10198826 | 4.2E−02 | 1.0E−02 | Y | Y |
| 60815807 | rs3796067 | 4.5E−01 | 6.0E−01 | Y | Y |
| 60815927 | rs12713426 | 4.6E−01 | 6.1E−01 | Y | Y |
| 60821465 | rs7576218 | 4.6E−01 | 6.1E−01 | Y | Y |
| 60826290 | rs1866207 | 2.9E−01 | 1.8E−01 | Y | Y |
| 60831488 | rs9309330 | 1.0E+00 | 9.7E−01 | Y | Y |

Marker from the Illumina Sentrix ® HumanHap300 BeadChip are indicated by “Y” in the column “Illumina”. Similarly, markers genotyped in the CEU HapMap panel are indicated by “Y” in the column “HapMap”. Other markers were identified from dbSNP and by resequencing of ~183-kb (chr2: 60,456,126 to 60,639,057) in 32 Caucasian controls. In the interval of strongest association (60,456,396-60,582,798) which contained all markers with p < 0.0001 in the association tests, we genotyped 150 markers, including 114 from the CEU HapMap set.

TABLE 3
Halotype frequencies in the unselected
twin panel for representative 2p15 markers.

| Haplotype^{a} | Frequency^{b} |
|---|---|
| ACTGAG | 0.342 |
| ACCGAG | 0.058 |
| ACCTAG | 0.009 |
| ACCTCA | 0.123 |
| ATCGAG | 0.026 |
| CTTGAG | 0.358 |
| CTCGAG | 0.059 |
| CTCTCA | 0.011 |

^{a}based on markers rs243027-rs243081-rs6732518-rs1427407-rs766432-rs4671393
^{b}maximum likelihood estimates (MLE) of haplotype frequencies calculated using EM algorithm

TABLE 4
Linkage disequilibrium in the unselected twin panel for markers genotyped at the
chromosome 2 and chromosome 6 QTLs
Chr 2 (D′/r²)

| | rs243027 | rs243081 | rs6732518 | rs1427407 | rs766432 | rs4671393 |
|---|---|---|---|---|---|---|
| rs243027 | 1.00/1.00 | 0.99/0.88 | 0.48/0.08 | 0.82/0.09 | 0.79/0.09 | 0.80/0.08 |
| rs243081 | — | 1.00/1.00 | 0.36/0.05 | 0.84/0.10 | 0.83/0.10 | 0.81/0.09 |
| rs6732518 | — | — | 1.00/1.00 | 0.98/0.42 | 0.97/0.40 | 0.97/0.38 |
| rs1427407 | — | — | — | 1.00/1.00 | 0.95/0.87 | 0.96/0.87 |
| rs766432 | — | — | — | — | 1.00/1.00 | 0.99/0.95 |
| rs4671393 | — | — | — | — | — | 1.00/1.00 |

Chr 6 (D′/r²)

| | rs6904897 | rs9399137 | rs1320963 |
|---|---|---|---|
| rs6904897 | 1.00/1.00 | 0.83/0.41 | 0.16/0.01 |
| rs9399137 | — | 1.00/1.00 | 0.91/0.10 |
| rs1320963 | — | — | 1.00/1.00 |

TABLE 5
Significance values for conditional test statistic from the linear
regression in the twin panel.

| | F statistic | | F statistic | | F statistic |
|---|---|---|---|---|---|
| SNP 1 | p-value | SNP 2 | p-value | SNP 3 | p-value |
| rs243081 | 0.09 | rs6732518 | 4.12e−5 | rs4671393 | 1.12e−5 |
| rs243027 | 0.14 | rs6732518 | 2.52e−5 | rs4671393 | 1.99e−5 |

Association of the trait with two markers, rs243081 and rs243027, from the 2^{nd} cluster is non-significant after taking into account the association with markers rs4671393 and rs6732518 from the 1^{st} cluster.

TABLE 6
Number of twin pairs and singletons in panels 1 and 2, within twin correlations of logₑ % F cells in the two panels,
parameter estimates for the fixed effects for age, sex, and Xmnl-Gγ, and P values for fixed effects.

| | | Number included in sample | | | Trait | Parameter estimate (top) and p-values (bottom) | | | |
|---|---|---|---|---|---|---|---|---|---|
| | | Pairs | Singletons¹ | Individuals | correlation | Sex | Age | Xmnl-G γ Add | Xmnl-^{G} γ Dom |
| Panel 1 | DZ | 311 | 3 | 625 | 0.42 ± 0.05 | 0.34 ± 0.09 | −0.006 ± 0.002 | −0.24 ± 0.04 | 0.12 ± 0.05 |
| | MZ | 96 | 7 | 199 | 0.83 ± 0.03 | P = 0.0002 | P = 0.002 | P = 10⁻¹¹ | P = 0.01 |
| Panel 2 | DZ | 574 | 11 | 1159 | 0.47 ± 0.03 | 0.39 ± 0.16 | −0.007 ± 0.002 | −0.28 ± 0.03 | 0.05 ± 0.04 |
| | MZ | 29 | 0 | 58 | 0.86 ± 0.05 | P = 0.02 | P = 0.002 | P = 10⁻¹⁸ | n.s. |

The first panel was used as a primary family set for genetic mapping whereas the second panel, which was collected and phenotyped during the primary mapping phase, was used for confirmation studies. The first twin panel is composed of 311 dizygotic (DZ) twin pairs, 96 monozygotic (MZ) twin pairs, and 11 singletons. The fixed-effects parameter estimates are the regression coefficients with sex scorred 1 for male and 2 for female, age measured in years, and genotypes at Xmnl-Gγ coded 0 for CC, 1 for CT, and 2 for TT. The dominance effect at Xmnl-Gγ is the estimated deviation of the CT heterozygote mean from the midpoint between the CC and TT means.
*DNA or phenotype available for only one twin in pair.

TABLE 7
Significance tests for sex, age, Xmnl-Gγ, and the three selected HBS1L-MYB markers

| | Fixed effects P-vals | | | | | | |
|---|---|---|---|---|---|---|---|
| | | | | HBS1L-MYB | | | |
| | | | | Block 1 | Block 2 | | Block 3 |
| | | | Xmnl-G γ | (rs52090901) | (rs9399137) | | (rs6929404) |
| | Sex | Age | additive | additive | Additive | dominance | additive |
| Panel 1 | 0.0001 | 0.0005 | 10⁻¹⁴ | 0.006 | 10⁻²⁴ | 0.0005 | 0.01 |
| Panel 2 | 0.004 | 0.0005 | 10⁻²² | 0.002 | 10⁻²⁴ | 0.06 | 0.005 |
| Combined | 10⁻⁵ | 10⁻⁷ | 10⁻³⁵ | 10⁻⁵ | 10⁻⁴⁵ | 0.0004 | 0.0002 |

The significance tests are conditional on the presence of the nontested parameters in the model. For HBS1L-MYB, these are difference from P values for the marginal test statistics in SI Table 4 because of partial LD between the markers. P values for dominance are showing only when significant. We employed a stepwise statistical procedure to select the markers shown here. New markers were incorporated into the ANOVA only if they accounted for a significant proportion of the train variance when more strongly associated markers were already included in the model (thus accounting for linkage disequilibrium with these). We selected the marker with the most significant test statistic to incorporate at each step until no remaining markers gave a significant trait association (P.0.01). We obtained equivalent results using either the markers genotyped in the first twin panel, or the combined data with markers that were characterized in both panels.

TABLE 8

| | | | | ANOVA p-values | |
|---|---|---|---|---|---|
| Chromosome position | Contig position | Internal ID | dbSNP ID | 1st panel | 2nd panel |
| 135329106 | 39391842 | — | rs9402669 | 6.8E−01 | |
| 135349178 | 39411914 | — | rs4376364 | 4.6E−01 | |
| 135364022 | 39426758 | — | rs9373120 | 5.4E−01 | |
| 135392072 | 39454808 | — | rs987690 | 2.6E−03 | |
| 135396811 | 39459547 | — | rs4896130 | 7.3E−03 | 2.5E−01 |
| 135400260 | 39462996 | — | rs7742542 | 2.8E−03 | 3.8E−01 |
| 135401739 | 39464475 | — | rs9376084 | 4.6E−01 | 7.7E−03 |
| 135407511 | 39470247 | — | rs6569990 | 3.7E−03 | 2.4E−01 |
| 135410907 | 39473643 | — | rs6915770 | 4.1E−03 | 3.2E−01 |
| 135411606 | 39474342 | — | rs11755229 | 7.6E−03 | 2.0E−01 |
| 135414769 | 39477505 | — | rs1041480 | 6.2E−03 | 3.7E−01 |
| 135417455 | 39480191 | — | rs2297338 | 4.0E−03 | 3.3E−01 |
| 135417684 | 39480420 | C29955341 | rs2297339 | 3.6E−01 | |
| 135417685 | 39480421 | C29955342 | rs52090900 | 4.0E−07 | |
| 135417751 | 39480487 | C29955343 | rs2297340 | 3.3E−03 | |
| 135417902 | 39480638 | C29955344 | rs52090901 | 5.8E−05 | 2.3E−03 |
| 135417925 | 39480661 | C29955345 | rs52090902 | 2.6E−03 | 2.4E−01 |
| 135418072 | 39480808 | C29953465 | rs52090903 | 3.8E−03 | 2.2E−01 |
| 135418102 | 39480838 | C29955337 | rs9389262 | 4.6E−03 | 3.4E−01 |
| 135418168 | 39480904 | C29953468 | rs13208043 | 1.2E−01 | 8.1E−01 |
| 135418784 | 39481520 | C29953468 | rs2183709 | 5.3E−03 | 2.9E−01 |
| 135418879 | 39481615 | C29953469 | rs4142299 | 4.5E−03 | 1.9E−01 |
| 135420841 | 39483577 | C29953745 | rs11154791 | 4.5E−04 | 6.1E−04 |
| 135422941 | 39485677 | C29953471 | rs11759062 | 1.5E−04 | 7.5E−04 |
| 135423044 | 39485780 | C29953472 | rs11759077 | 2.4E−04 | 5.4E−04 |
| 135424673 | 39487409 | — | rs6904897 | 2.0E−05 | 2.0E−04 |
| 135425482 | 39488218 | C29953474 | rs11758774 | 1.1E−04 | 7.5E−04 |
| 135432529 | 39495265 | C29953462 | rs1547247 | 1.2E−14 | |
| 135437241 | 39499977 | C29953463 | rs13220662 | 2.8E−11 | 4.1E−09 |
| 135443064 | 39505800 | C29953464 | rs52090904 | 4.1E−08 | 2.0E−08 |
| 135446815 | 39509551 | C29953534 | rs1331308 | 4.4E−05 | |
| 135447052 | 39509788 | C29953535 | rs949895 | 9.4E−05 | |
| 135450809 | 39513545 | — | rs6913541 | 2.6E−03 | |
| 135452921 | 39515657 | C29953538 | rs9376090 | 7.9E−36 | 3.8E−40 |
| 135453430 | 39516166 | C29953539 | rs9389266 | 1.3E−03 | |
| 135454075 | 39516811 | C29953540 | rs52090905 | 4.0E−09 | 9.9E−08 |
| 135454329 | 39517065 | C29953541 | rs52090906 | 4.8E−09 | |
| 135455762 | 39518498 | C29953542 | rs52090907 | 1.8E−09 | |
| 135460711 | 39523447 | C29954334 | rs9399137 | 4.5E−38 | 3.8E−40 |
| 135460947 | 39523683 | C29953510 | rs52090908 | 6.4E−06 | |
| 135460998 | 39523734 | C29953511 | rs9402684 | 2.4E−04 | |
| 135461381 | 39524117 | C29953514 | rs9402685 | 9.4E−32 | 2.7E−37 |
| 135461527 | 39524263 | C29953515 | rs7743042 | 1.2E−04 | |
| 135463989 | 39526725 | C29953517 | rs11759553 | 7.6E−39 | 5.4E−47 |
| 135465105 | 39527841 | C29953519 | rs1074849 | 7.3E−12 | |
| 135465872 | 39528608 | C29953520 | rs52090909 | 4.9E−38 | 1.2E−37 |
| 135465896 | 39528632 | C29953521 | rs6930223 | 1.1E−05 | |
| 135468251 | 39530987 | C29953523 | rs4895440 | 4.1E−39 | 1.0E−35 |
| 135468266 | 39531002 | C29953524 | rs4895441 | 2.2E−38 | 2.8E−36 |
| 135468837 | 39531573 | C29953525 | rs9376092 | 2.1E−38 | 3.0E−36 |
| 135468852 | 39531588 | C29953526 | rs9389269 | 1.1E−38 | 2.0E−35 |
| 135469510 | 39532246 | C29953527 | rs9402686 | 1.7E−38 | 5.1E−36 |
| 135471786 | 39534522 | C29954343 | rs10484494 | 2.4E−08 | 4.4E−05 |
| 135473333 | 39536069 | C29953581 | rs11154792 | 1.4E−35 | 3.6E−31 |
| 135473754 | 39536490 | C29953582 | rs1411919 | 8.3E−12 | 1.4E−15 |
| 135474576 | 39537312 | C29953583 | rs7766963 | 4.3E−03 | |
| 135476864 | 39539600 | — | rs2223385 | 3.9E−12 | 5.2E−16 |
| 135477194 | 39539930 | C29953585 | rs9483788 | 6.6E−29 | 4.0E−24 |
| 135479079 | 39541815 | C29953586 | rs1320959 | 2.8E−11 | |
| 135480316 | 39543052 | C29953589 | rs52090910 | 1.4E−07 | 9.2E−06 |
| 135480956 | 39543692 | C29953590 | rs2026937 | 1.0E−02 | 2.0E−01 |
| 135484218 | 39546954 | C29953593 | rs9483791 | 2.3E−11 | 1.5E−14 |
| 135484905 | 39547641 | — | rs1320963 | 5.3E−12 | 6.3E−14 |
| 135485702 | 39548438 | C29953595 | rs2026938 | 1.3E−10 | 4.2E−14 |
| 135487141 | 39549877 | C29953596 | rs9376093 | 6.8E−12 | 1.8E−15 |
| 135487507 | 39550243 | C29953597 | rs9376094 | 4.1E−11 | 5.3E−15 |
| 135488534 | 39551270 | C29953599 | rs9399139 | 1.3E−01 | 5.4E−01 |
| 135489466 | 39552202 | C29953600 | rs9321485 | 3.4E−10 | 1.1E−13 |
| 135489513 | 39552249 | C29953601 | rs9321486 | 5.2E−12 | 1.5E−14 |
| 135491008 | 39553744 | C29953602 | rs9494149 | 1.5E−10 | 1.9E−14 |
| 135492448 | 39555184 | C29953604 | rs9376095 | 2.7E−10 | 3.3E−14 |
| 135492890 | 39555626 | C29953607 | rs1041478 | 3.7E−01 | 5.5E−01 |
| 135493257 | 39555993 | C29953608 | rs6934903 | 5.2E−23 | 2.0E−18 |
| 135493273 | 39556009 | C29953609 | rs1569534 | 1.5E−11 | 1.4E−13 |
| 135495720 | 39558456 | C29953611 | rs6929404 | 5.4E−12 | 1.1E−13 |
| 135497022 | 39559758 | C29953614 | rs9385716 | 3.5E−11 | 3.7E−13 |
| 135499234 | 39561970 | C29953662 | rs1883354 | 5.9E−01 | 2.8E−01 |
| 135509418 | 39572154 | C29953684 | rs6929368 | 4.4E−01 | 3.9E−01 |
| 135509698 | 39572434 | — | rs9494154 | 2.4E−17 | 6.2E−16 |
| 135510584 | 39573320 | C29953685 | rs9494155 | 4.1E−01 | 7.3E−01 |
| 135519030 | 39581766 | — | rs7765438 | 4.5E−01 | 3.3E−01 |
| 135524512 | 39587248 | C29953689 | rs6922541 | 3.9E−01 | |
| 135542466 | 39605202 | C29350526 | rs6938173 | 8.5E−08 | 4.2E−08 |
| 135543234 | 39605970 | Bpil | | 1.0E−08 | 8.7E−07 |
| 135545478 | 39608214 | — | rs210962 | 4.5E−07 | 1.1E−08 |
| 135549087 | 39611823 | C29336484 | rs6922903 | 8.9E−07 | |
| 135556251 | 39618987 | C17988439 | rs210798 | 2.1E−02 | |
| 135556526 | 39619262 | C29942363 | rs52090911 | 1.5E−03 | |
| 135559307 | 39622043 | C29942346 | rs12663543 | 1.1E−06 | 3.7E−09 |
| 135559689 | 39622425 | C29942347 | rs12660713 | 1.9E−05 | |
| 135561193 | 39623929 | C29334569 | rs6920829 | 1.4E−05 | 1.5E−07 |
| 135564050 | 39626786 | C29942366 | rs52090912 | 2.7E−08 | 1.1E−08 |
| 135564375 | 39627111 | C29380834 | rs7757388 | 5.5E−01 | |
| 135564448 | 39627184 | C18118072 | rs3752383 | 2.8E−08 | |
| 135564632 | 39627368 | C18015056 | rs743589 | 1.4E−08 | 5.3E−09 |
| 135565479 | 39628215 | C29942351 | rs52090913 | 2.5E−08 | |
| 135566209 | 39628945 | C29942352 | rs9385719 | 1.5E−08 | 3.6E−09 |
| 135566246 | 39628982 | C29942355 | rs9402696 | 2.8E−08 | |
| 135567089 | 39629825 | C18122181 | rs3819409 | 2.4E−08 | 4.0E−09 |
| 135567430 | 39630166 | C18122182 | rs3819410 | 8.5E−09 | |
| 135567620 | 39630356 | C29942356 | rs9389278 | 1.2E−08 | |
| 135571254 | 39633990 | C29942357 | rs12203816 | 9.4E−09 | 7.2E−09 |
| 135573144 | 39635880 | C17988503 | rs210950 | 8.3E−09 | 2.6E−09 |
| 135573332 | 39636068 | C17988502 | rs210949 | 2.3E−06 | |
| 135573493 | 39636229 | C17988501 | rs210948 | 1.9E−01 | |
| 135576711 | 39639447 | C17988497 | rs210944 | 1.2E−01 | |
| 135577140 | 39639876 | C17988495 | rs210942 | 8.8E−07 | 6.8E−07 |
| 135577714 | 39640450 | C29348821 | rs6936293 | 1.2E−07 | |
| 135578189 | 39640925 | C17988494 | rs210941 | 1.8E−01 | |
| 135578886 | 39641622 | C29362372 | rs7738267 | 1.4E−07 | 2.7E−10 |
| 135580285 | 39643021 | C18076714 | rs2179308 | 4.5E−01 | |
| 135580332 | 39643068 | C18028011 | rs1013891 | 4.5E−05 | 1.1E−03 |
| 135581089 | 39643825 | C18117295 | rs3216774 | 4.4E−02 | 1.0E+00 |
| 135625991 | 39688727 | — | rs2050018 | 8.3E−01 | |
| 135650130 | 39712856 | — | rs6904233 | 9.1E−01 | |
| 135658325 | 39721061 | — | rs2142956 | 9.0E−01 | |
| 135714977 | 39777713 | — | rs2746429 | 6.3E−01 | |
| 135794506 | 39857242 | — | rs2757640 | 9.7E−01 | |
| 135818171 | 39880907 | — | rs2614267 | 9.5E−01 | |
| 135827866 | 39890602 | — | rs2614281 | 2.1E−01 | |
| 135859828 | 39922564 | — | rs6928455 | 9.6E−01 | |

TABLE 8b

| | | | | Genotypes | | | Association | | Additive effect | |
|---|---|---|---|---|---|---|---|---|---|---|
| Chromosome | | Ref | All | 1st panel | | | 1st panel | | 1st panel | |
| position | Marker | Allele R | Allele A | R/R | R/A | A/A | Global | Dom | beta | s.e. |
| BLOCK 1 | | | | | | | | | | |
| 135417902 | rs52090901 | T | G | 244 | 322 | 115 | 5.8E−05 | 8.9E−01 | 1.4E−01 | 3.2E−02 |
| 135417925 | rs52090902 | C | T | 163 | 327 | 191 | 2.6E−03 | 6.5E−01 | 1.1E−01 | 3.1E−02 |
| 135418072 | rs52090903 | T | G | 164 | 326 | 190 | 3.8E−03 | 7.4E−01 | 1.0E−01 | 3.1E−02 |
| 135418102 | rs9389262 | G | T | 165 | 326 | 189 | 4.6E−03 | 8.9E−01 | 1.0E−01 | 3.1E−02 |
| 135418168 | rs13208043 | T | C | 606 | 65 | 5 | 1.2E−01 | 6.9E−01 | −9.1E−02 | 1.2E−01 |
| 135418784 | rs2183709 | C | T | 169 | 320 | 199 | 5.3E−03 | 1.0E+00 | 9.9E−02 | 3.1E−02 |
| 135418879 | rs4142299 | G | T | 170 | 328 | 195 | 4.5E−03 | 1.0E+00 | 1.0E−01 | 3.1E−02 |
| 135420841 | rs11154791 | A | G | 249 | 319 | 121 | 4.5E−04 | 7.6E−01 | 1.2E−01 | 3.2E−02 |
| 135422941 | rs11759062 | A | C | 208 | 269 | 101 | 1.5E−04 | 1.0E+00 | 1.4E−01 | 3.4E−02 |
| 135423044 | rs11759077 | A | G | 203 | 280 | 100 | 2.4E−04 | 7.8E−01 | 1.4E−01 | 3.5E−02 |
| 135424673 | rs6904897 | T | G | 240 | 334 | 116 | 2.0E−05 | 4.4E−01 | 1.4E−01 | 3.3E−02 |
| 135425482 | rs11758774 | T | G | 248 | 322 | 123 | 1.1E−04 | 6.8E−01 | 1.3E−01 | 3.2E−02 |
| BLOCK 2 | | | | | | | | | | |
| 135452921 | rs9376090 | T | C | 378 | 286 | 50 | 7.9E−36 | 1.2E−03 | 4.8E−01 | 3.9E−02 |
| 135453430 | rs9389266 | G | T | 512 | 173 | 28 | 1.3E−03 | 3.1E−01 | −1.1E−01 | 5.4E−02 |
| 135454075 | rs52090905 | C | T | 581 | 120 | 4 | 4.0E−09 | 2.5E−01 | −1.9E−01 | 1.3E−01 |
| 135454329 | rs52090906 | T | C | 582 | 126 | 4 | 4.8E−09 | 2.7E−01 | −1.9E−01 | 1.3E−01 |
| 135455762 | rs52090907 | C | G | 563 | 121 | 2 | 1.8E−09 | 1.5E−01 | −9.5E−02 | 1.8E−01 |
| 135460711 | rs9399137 | T | C | 363 | 290 | 51 | 4.5E−38 | 2.7E−04 | 5.0E−01 | 3.8E−02 |
| 135460947 | rs52090908 | T | C | 619 | 72 | 0 | 6.4E−06 | — | −3.2E−01 | 7.0E−02 |
| 135460998 | rs9402684 | T | C | 152 | 334 | 200 | 2.4E−04 | 1.0E+00 | 1.3E−01 | 3.2E−02 |
| 135461381 | rs9402685 | T | C | 358 | 264 | 46 | 9.4E−32 | 2.1E−03 | 4.7E−01 | 4.0E−02 |
| 135461527 | rs7743042 | A | G | 155 | 349 | 197 | 1.2E−04 | 8.6E−01 | 1.3E−01 | 3.1E−02 |
| 135483989 | rs11759553 | A | T | 364 | 298 | 54 | 7.6E−39 | 6.8E−04 | 4.9E−01 | 3.7E−02 |
| 135465105 | rs1074849 | G | A | 420 | 242 | 42 | 7.3E−12 | 5.8E−01 | −2.4E−01 | 4.4E−02 |
| 135465872 | rs52090909 | C | G | 360 | 293 | 52 | 4.9E−38 | 4.0E−04 | 5.0E−01 | 3.8E−02 |
| 135465896 | rs6930223 | G | T | 162 | 345 | 192 | 1.1E−05 | 4.4E−01 | 1.5E−01 | 3.1E−02 |
| 135468251 | rs4895440 | A | T | 358 | 293 | 53 | 4.1E−39 | 3.1E−04 | 5.0E−01 | 3.7E−02 |
| 135468266 | rs4895441 | A | G | 364 | 293 | 51 | 2.2E−38 | 2.6E−04 | 5.0E−01 | 3.8E−02 |
| 135468837 | rs9376092 | C | A | 351 | 300 | 52 | 2.1E−38 | 6.8E−04 | 5.0E−01 | 3.8E−02 |
| 135468852 | rs9389269 | T | C | 364 | 293 | 53 | 1.1E−38 | 6.4E−04 | 5.0E−01 | 3.8E−02 |
| 135469510 | rs9402686 | G | A | 366 | 297 | 53 | 1.7E−38 | 3.3E−04 | 5.0E−01 | 3.8E−02 |
| 135471786 | rs10484494 | G | A | 617 | 93 | 0 | 2.4E−08 | — | 3.6E−01 | 6.4E−02 |
| 135473333 | rs11154792 | T | C | 382 | 282 | 47 | 1.4E−35 | 5.7E−03 | 4.9E−01 | 4.0E−02 |
| 135473754 | rs1411919 | A | G | 420 | 256 | 44 | 8.3E−12 | 2.5E−01 | −2.2E−01 | 4.3E−02 |
| 135474576 | rs7766963 | T | C | 173 | 355 | 184 | 4.3E−03 | 4.4E−01 | 1.0E−01 | 3.1E−02 |
| 135476864 | rs2223385 | G | A | 419 | 256 | 45 | 3.9E−12 | 2.4E−01 | −2.2E−01 | 4.2E−02 |
| 135477194 | rs9483788 | T | C | 377 | 286 | 45 | 6.6E−29 | 1.3E−02 | −4.4E−01 | 4.1E−02 |
| BLOCK 3 | | | | | | | | | | |
| 135473754 | rs1411919 | A | G | 420 | 256 | 44 | 8.3E−12 | 2.5E−01 | −2.2E−01 | 4.3E−02 |
| 135474576 | rs7765963 | T | C | 173 | 355 | 184 | 4.3E−03 | 4.4E−01 | 1.0E−01 | 3.1E−02 |
| 135476864 | rs2223385 | G | A | 419 | 256 | 45 | 3.9E−12 | 2.4E−01 | −2.2E−01 | 4.2E−02 |
| 135477194 | rs9483788 | T | C | 377 | 286 | 45 | 6.6E−29 | 1.3E−02 | 4.4E−01 | 4.1E−02 |
| 135479079 | rs1320959 | T | C | 417 | 252 | 41 | 2.8E−11 | 1.0E−01 | −2.0E−01 | 4.5E−02 |
| 135480316 | rs52090910 | A | G | 608 | 93 | 2 | 1.4E−07 | 5.4E−01 | 2.4E−01 | 1.9E−01 |
| 135480956 | rs2026937 | A | G | 175 | 330 | 195 | 1.0E−02 | 2.7E−01 | 9.0E−02 | 3.1E−02 |
| 135484218 | rs9483791 | T | C | 410 | 241 | 48 | 2.3E−11 | 1.8E−01 | −2.1E−01 | 4.1E−02 |
| 135484905 | rs1320963 | A | G | 414 | 257 | 46 | 5.3E−12 | 1.4E−01 | −2.1E−01 | 4.2E−02 |
| 135485702 | rs2026938 | G | A | 413 | 237 | 46 | 1.3E−10 | 2.9E−01 | −2.1E−01 | 4.2E−02 |
| 135487141 | rs9376093 | C | T | 410 | 240 | 48 | 6.8E−12 | 1.3E−01 | −2.1E−01 | 4.1E−02 |
| 135487507 | rs9376094 | T | A | 415 | 234 | 50 | 4.1E−11 | 1.9E−01 | −2.1E−01 | 4.0E−02 |
| 135488534 | rs9399139 | C | T | 210 | 326 | 158 | 1.3E−01 | 3.9E−01 | 5.6E−02 | 3.1E−02 |
| 135489466 | rs9321485 | T | C | 409 | 237 | 50 | 3.4E−10 | 2.2E−01 | −2.0E−01 | 4.1E−02 |
| 135489513 | rs8321486 | T | C | 403 | 247 | 49 | 5.2E−12 | 6.0E−02 | −2.0E−01 | 4.1E−02 |
| 135491008 | rs9494149 | C | T | 410 | 247 | 43 | 1.5E−10 | 1.4E−01 | −2.0E−01 | 4.3E−02 |
| 135492448 | rs9376095 | T | C | 408 | 232 | 50 | 2.7E−10 | 1.7E−01 | −2.0E−01 | 4.0E−02 |
| 135492890 | rs1041478 | A | G | 213 | 322 | 136 | 3.7E−01 | 6.0E−01 | 4.1E−02 | 3.3E−02 |
| 135493257 | rs6934903 | T | A | 450 | 229 | 23 | 5.2E−23 | 7.1E−03 | 5.0E−01 | 5.6E−02 |
| 135493273 | rs1569534 | C | T | 420 | 258 | 37 | 1.5E−11 | 2.0E−01 | −2.2E−01 | 4.5E−02 |
| 135495720 | rs6929404 | C | A | 413 | 238 | 42 | 5.4E−12 | 1.6E−01 | −2.2E−01 | 4.3E−02 |
| 135497022 | rs9385716 | A | G | 417 | 248 | 38 | 3.5E−11 | 8.8E−02 | −2.0E−01 | 4.5E−02 |

| | Genotypes | | | Association | | Additive effect | |
|---|---|---|---|---|---|---|---|
| Chromosome | 2nd panel | | | 2nd panel | | 2nd panel | |
| position | R/R | R/A | A/A | Global | Dom | beta | s.e. |
| BLOCK 1 | | | | | | | |
| 135417902 | 424 | 533 | 183 | 2.3E−03 | 4.7E−01 | 1.0E−01 | 3.0E−02 |
| 135417925 | 258 | 603 | 298 | 2.4E−01 | 8.4E−01 | 4.8E−02 | 2.9E−02 |
| 135418072 | 263 | 593 | 301 | 2.2E−01 | 8.9E−01 | 4.9E−02 | 2.8E−02 |
| 135418102 | 254 | 593 | 290 | 3.4E−01 | 6.5E−01 | 4.1E−02 | 2.9E−02 |
| 135418168 | 1055 | 104 | 4 | 8.1E−01 | 5.4E−01 | 6.6E−02 | 1.5E−01 |
| 135418784 | 259 | 602 | 296 | 2.9E−01 | 1.0E+00 | 4.5E−02 | 2.9E−02 |
| 135418879 | 257 | 598 | 295 | 1.9E−01 | 8.2E−01 | 5.2E−02 | 2.9E−02 |
| 135420841 | 422 | 539 | 188 | 6.1E−04 | 4.9E−01 | 1.1E−01 | 3.0E−02 |
| 135422941 | 423 | 548 | 183 | 7.5E−04 | 4.4E−01 | 1.1E−01 | 3.0E−02 |
| 135423044 | 430 | 561 | 185 | 5.4E−04 | 4.0E−01 | 1.2E−01 | 3.0E−02 |
| 135424673 | 411 | 540 | 187 | 2.0E−04 | 4.8E−01 | 1.2E−01 | 3.0E−02 |
| 135425482 | 430 | 562 | 190 | 7.5E−04 | 3.8E−01 | 1.1E−01 | 3.0E−02 |
| BLOCK 2 | | | | | | | |
| 135452921 | 596 | 505 | 85 | 3.8E−40 | 6.6E−02 | 4.4E−01 | 3.5E−02 |
| 135453430 | — | — | — | — | — | — | — |
| 135454075 | 947 | 215 | 13 | 9.9E−08 | 3.5E−01 | −1.9E−01 | 8.5E−02 |
| 135454329 | — | — | — | — | — | — | — |
| 135455762 | — | — | — | — | — | — | — |
| 135460711 | 588 | 491 | 82 | 3.8E−40 | 3.2E−02 | 4.5E−01 | 3.5E−02 |
| 135460947 | — | — | — | — | — | — | — |
| 135460998 | — | — | — | — | — | — | — |
| 135461381 | 585 | 493 | 81 | 2.7E−37 | 8.5E−02 | 4.3E−01 | 3.6E−02 |
| 135461527 | — | 13 | — | — | — | — | — |
| 135483989 | 600 | 486 | 88 | 5.4E−37 | 1.3E−01 | 4.2E−01 | 3.5E−02 |
| 135465105 | — | — | — | — | — | — | — |
| 135465872 | 597 | 476 | 87 | 1.2E−37 | 1.2E−01 | 4.2E−01 | 3.4E−02 |
| 135465896 | — | — | — | — | — | — | — |
| 135468251 | 590 | 471 | 84 | 1.0E−35 | 2.5E−01 | 4.1E−01 | 3.5E−02 |
| 135468266 | 598 | 481 | 85 | 2.8E−36 | 9.2E−02 | 4.2E−01 | 3.5E−02 |
| 135468837 | 597 | 485 | 90 | 3.0E−36 | 1.1E−01 | 4.1E−01 | 3.4E−02 |
| 135468852 | 602 | 484 | 85 | 2.0E−35 | 1.2E−01 | 4.1E−01 | 3.5E−02 |
| 135469510 | 601 | 486 | 82 | 5.1E−36 | 1.3E−01 | 4.2E−01 | 3.6E−02 |
| 135471786 | 1009 | 146 | 8 | 4.4E−05 | 8.4E−01 | 2.2E−01 | 1.1E−01 |
| 135473333 | 644 | 450 | 69 | 3.6E−31 | 5.3E−02 | 4.1E−01 | 3.8E−02 |
| 135473754 | 677 | 418 | 64 | 1.4E−15 | 4.2E−01 | −2.5E−01 | 4.1E−02 |
| 135474576 | — | — | — | — | — | — | — |
| 135476864 | 672 | 424 | 64 | 5.2E−16 | 5.7E−01 | −2.6E−01 | 4.1E−02 |
| 135477194 | 623 | 480 | 71 | 4.0E−24 | 1.8E−01 | 3.5E−01 | 3.8E−02 |
| BLOCK 3 | | | | | | | |
| 135473754 | 677 | 418 | 64 | 1.4E−15 | 4.2E−01 | −2.5E−01 | 4.1E−02 |
| 135474576 | — | — | — | — | — | — | — |
| 135476864 | 672 | 424 | 64 | 5.2E−16 | 5.7E−01 | −2.6E−01 | 4.1E−02 |
| 135477194 | 623 | 480 | 71 | 4.0E−24 | 1.8E−01 | 3.5E−01 | 3.8E−02 |
| 135479079 | — | — | — | — | — | — | — |
| 135480316 | 1024 | 156 | 9 | 9.2E−06 | 5.8E−01 | 2.9E−01 | 1.0E−01 |
| 135480956 | 261 | 610 | 296 | 2.0E−01 | 8.1E−01 | 5.0E−02 | 2.8E−02 |
| 135484218 | 688 | 428 | 65 | 1.5E−14 | 5.1E−01 | −2.4E−01 | 4.1E−02 |
| 135484905 | 680 | 412 | 62 | 6.3E−14 | 3.9E−01 | −2.3E−01 | 4.2E−02 |
| 135485702 | 688 | 411 | 62 | 4.2E−14 | 4.2E−01 | −2.3E−01 | 4.1E−02 |
| 135487141 | 690 | 425 | 65 | 1.8E−15 | 4.4E−01 | −2.5E−01 | 4.1E−02 |
| 135487507 | 689 | 415 | 67 | 5.3E−15 | 3.5E−01 | −2.4E−01 | 4.1E−02 |
| 135488534 | 337 | 602 | 231 | 5.4E−01 | 3.1E−01 | 9.8E−03 | 2.9E−02 |
| 135489466 | 680 | 422 | 64 | 1.1E−13 | 6.5E−01 | −2.4E−01 | 4.1E−02 |
| 135489513 | 675 | 438 | 63 | 1.5E−14 | 7.8E−01 | −2.5E−01 | 4.1E−02 |
| 135491008 | 671 | 427 | 63 | 1.9E−14 | 5.0E−01 | −2.4E−01 | 4.1E−02 |
| 135492448 | 684 | 421 | 58 | 3.3E−14 | 7.2E−01 | −2.7E−01 | 4.3E−02 |
| 135492890 | 377 | 574 | 189 | 5.5E−01 | 2.9E−01 | 6.9E−04 | 3.0E−02 |
| 135493257 | 772 | 364 | 39 | 2.0E−18 | 7.8E−01 | 3.2E−01 | 5.1E−02 |
| 135493273 | 704 | 391 | 57 | 1.4E−13 | 1.0E+00 | −2.6E−01 | 4.3E−02 |
| 135495720 | 701 | 391 | 56 | 1.1E−13 | 8.4E−01 | −2.6E−01 | 4.3E−02 |
| 135497022 | 709 | 391 | 59 | 3.7E−13 | 7.2E−01 | −2.6E−01 | 4.2E−02 |

TABLE 9a
Block 1
Marker ID

| | | | | | |
|---|---|---|---|---|---|
| rs52090901 | rs52090902 | rs52090903 | rs9389262 | rs13208043 | rs2183709 |

| | | | | | |
|---|---|---|---|---|---|
| T | C | T | G | T | C |
| G | T | G | T | T | T |
| T | T | G | T | T | T |
| T | C | T | G | C | C |

| | | | | | | |
|---|---|---|---|---|---|---|
| rs4142299 | rs11154791 | rs11759062 | rs11759077 | rs6904897 | rs11758774 | Hap freq. |

| | | | | | | |
|---|---|---|---|---|---|---|
| G | A | A | A | T | T | 0.43 |
| T | G | C | G | G | G | 0.39 |
| T | A | A | A | T | T | 0.11 |
| G | A | A | A | T | T | 0.05 |

TABLE 9b
Block 2

Marker ID

| | | | | | | | | |
|---|---|---|---|---|---|---|---|---|
| rs9376090 | rs9389266 | rs52090905 | rs52090906 | rs52090907 | rs9399137 | rs52090908 | rs9402684 | rs9402685 |

| | | | | | | | | |
|---|---|---|---|---|---|---|---|---|
| T | G | C | T | C | T | T | T | T |
| C | G | C | T | C | C | T | C | C |
| T | T | C | T | C | T | T | C | T |
| T | G | T | C | G | T | C | C | T |
| C | G | C | T | C | C | T | C | C |
| T | G | T | C | G | T | T | C | T |

| | | | | | | | | |
|---|---|---|---|---|---|---|---|---|
| rs7743042 | rs11759553 | rs1074849 | rs52090909 | rs6930223 | rs4895440 | rs4895441 | rs9376092 | rs9389269 |

| | | | | | | | | |
|---|---|---|---|---|---|---|---|---|
| A | A | G | C | G | A | A | C | T |
| G | T | G | G | T | T | G | A | C |
| G | A | A | C | T | A | A | C | T |
| G | A | A | C | T | A | A | C | T |
| G | T | G | G | T | T | G | A | C |
| G | A | A | C | T | A | A | C | T |

| | | | | | | | |
|---|---|---|---|---|---|---|---|
| rs9402686 | rs10484494 | rs11154792 | rs1411919 | rs7766963 | rs2223385 | rs9483788 | Hap freq |

| | | | | | | | |
|---|---|---|---|---|---|---|---|
| G | G | T | A | T | G | T | 0.45 |
| A | G | C | A | C | G | C | 0.18 |
| G | G | T | G | C | A | T | 0.13 |
| G | G | T | G | C | A | T | 0.06 |
| A | A | C | A | C | G | C | 0.05 |
| G | G | T | G | C | A | T | 0.04 |

TABLE 9c
Block 3
Marker ID

| | | | | | | | | | |
|---|---|---|---|---|---|---|---|---|---|
| rs1411919 | rs7766963 | rs2223385 | rs9483788 | rs1320959 | rs52090910 | rs2026937 | rs9483791 | rs1320963 | rs2026938 |

| | | | | | | | | | |
|---|---|---|---|---|---|---|---|---|---|
| A | T | G | T | T | A | A | T | A | G |
| G | C | A | T | C | A | G | C | G | A |
| A | C | G | C | T | A | G | T | A | G |
| A | C | G | C | T | A | G | T | A | G |
| A | C | G | C | T | G | G | T | A | G |

| | | | | | | | | | |
|---|---|---|---|---|---|---|---|---|---|
| rs9376093 | rs9376094 | rs9399139 | 9321485 | rs9321486 | rs9494149 | rs9376095 | rs1041478 | rs6934903 | rs1569534 |

| | | | | | | | | | |
|---|---|---|---|---|---|---|---|---|---|
| C | T | C | T | T | C | C | A | T | C |
| T | A | T C | C | T | C | G | 1 | T | |
| C | T | T | T | T | C | T | G | A | C |
| C | T | C | T | T | C | T | A | T | C |
| C | T | C | T | T | C | T | A | T | C |
| C | T | T | T | T | C | T | G | A | C |

| | | |
|---|---|---|
| rs6929404 | rs9385716 | Hap freq |

| | | |
|---|---|---|
| C | A | 0.47 |
| A | G | 0.20 |
| C | A | 0.13 |
| C | A | 0.06 |
| C | A | 0.06 |

TABLE 10a

| | | | | | |
|---|---|---|---|---|---|
| | | | | Unrestricted | Allele subsitution |
| rs6904897 | rs9399137 | rs6929404 | Frequency | model | model |

| | | | | | |
|---|---|---|---|---|---|
| T | T | C | 47.1% | 0.57 ± 0.01 | 0.56 |
| T | C | C | 3.4% | 1.17 ± 0.06 | 1.10 |
| G | T | C | 5.0 | 0.46 ± 0.05 | 0.46 |
| G | C | C | 20.4% | 0.97 ± 0.03 | 0.99 |
| G | T | A | 11.4% | 0.38 ± 0.03 | 0.37 |
| G | C | A | 3.5% | 0.96 ± 0.06 | 0.90 |
| T | T | A | 9.1% | 0.46 ± 0.03 | 0.48 |

TABLE 10b

| Block | marker | substitution | effect | s.e. |
|---|---|---|---|---|
| 1 | rs6904897 | T->G | −1.1E−01 | 2.6E−02 |
| 2 | rs9399137 | T->C | 5.3E−01 | 3.2E−02 |
| 3 | rs210962 | C->A | −8.8E−02 | 2.3E−02 |

TABLE 11

| | |
|---|---|
| MYB | HBS1L |

| | | Day 0 | Day 3 | Day 0 | Day 3 |
|---|---|---|---|---|---|
| MYB | Day 0 | — | 0.01 | 0.26 | −0.14 |
| | Day 3 | N.S | — | 0.49 | 0.68 |
| HBS1L | Day 0 | N.S. | 0.003 | — | 0.57 |
| | Day 3 | N.S. | <0.0001 | 0.0003 | — |

Above diagonal = correlation
Below diagonal = p-value

TABLE 12
Summary of the high scoring SNPs associated with increased HbF

| | |
|---|---|
| Allele | Allele |

| | | | | | | | |
|---|---|---|---|---|---|---|---|
| | Location | Association | | | | | Increased |
| Polymorhpism | (bp) | p= | Reference | Alternative | Minor | (MAF*) | Hbf |

| | | | | | | | |
|---|---|---|---|---|---|---|---|
| chr 2p15 | | | | | | | |
| rs243027 | 60,460,511 | 2.2E-10 | T | G | G | (0.43) | G |
| rs243081 | 60,467,280 | 2.5E-12 | G | A | A | (0.48) | A |
| rs6732518 | 60,562,101 | 2.1E-21 | C | T | C | (0.24) | C |
| rs1427407 | 60,571,547 | 6.1E-31 | T | G | T | (0.14) | T |
| rs766432 | 60,573,474 | 1.8E-28 | C | A | C | (0.12) | C |
| rs4671393 | 60,574,455 | 2.6E-27 | A | G | A | (0.12) | A |
| chr 6q23 | | | | | | | |
| rs6904897 | 135,424,673 | 1.2E-06 | T | G | G | (0.37) | T |
| rs9399137 | 135,460,711 | 2.5E-36 | T | C | C | (0.23) | C |
| rs1320963 | 135,484,905 | 4.1E-15 | A | G | G | (0.23) | A |
| chr 11p15.4 | | | | | | | |
| XmnI-Gγ | 5,232,745 | 2.4E-38 | G | A | A | (0.33) | A |
| (=rs7482144) | | | | | | | |

MAF minor allele frequency
Reference allele: the allele (base, letter) of the SNP that is present in the public version of the human genome sequence (reference sequence), as published by by NCBI. Of the two strands of the (double-stranded) DNA molecule, the letter that names this allele occurs in the ‘reference strand’. So ‘reference’ means two things: reference sequence and reference strand.
Alternative allele: the allele (base, letter) of the SNP that occurs at the same spot (SNP) of the sequence, but in alternative versions of the sequence, e.g. in other people than the study subject who provided the reference sequence. This alternative allele makes this spot in the DNA a SNP (single-nucleotide polymorphism).
Minor allele: can be the reference allele or the alternative allele. This depends on the SNP in question. Minor means that this allele is the less frequent one in the population under study.
Allele that increases HbF: the allele that we found is associated with an increase in foetal haemoglobin (HbF). Usually, but not always, this allele will have an increased frequency (occurrence) in people with high HbF.

TABLE 13
Test for genetic association with 11 markers across the HMIP-2
locus on chromosome 6q in 88 patients with sickle cell
disease (HbSS).

| HMIP-2 marker | MAF | β | P = |
|---|---|---|---|
| I-01 (rs9376090) | 0.02 | 0.150 | 0.197 |
| I-02 (rs9399137) | 0.07 | 0.274 | 0.018 |
| I-03 (rs9402685) | 0.31 | −0.008 | 0.944 |
| I-04 (rs11759553) | 0.38 | 0.181 | 0.095 |
| I-05 (rs35959442^{‡}) | 0.36 | 0.130 | 0.215 |
| I-06 (rs4895440) | 0.35 | 0.123 | 0.249 |
| I-07 (rs4895441) | 0.06 | 0.221 | 0.034 |
| I-08 (rs9376092) | 0.16 | 0.037 | 0.731 |
| I-09 (rs9389269) | 0.04 | 0.143 | 0.176 |
| I-10 (rs9402686) | 0.04 | 0.137 | 0.196 |
| I-11 (rs11154792) | 0.12 | 0.151 | 0.204 |

MAF—minor allele frequency,
β - regression coefficient

TABLE 14
New loci showing evidence for association with the F-cell trait in Caucasian
healthy individuals.

| | | | | | p-values for various models | | | | | | | |
|---|---|---|---|---|---|---|---|---|---|---|---|---|
| | | | repre- | | | Geno + | | | | | | |
| | | | sent- | | | c6 + | | | | | | |
| locus | | | ative | | | c11 + | Geno* | Geno* | Geno* | Geno* | Geno* | reason for |
| # | chr | band | SNP | location | Geno | c2 | Xmn1 | BCL11A_1 | BCL11A_2 | c6q23_1 | c6q23_2 | inclusion |
| 1 | 2 | 2q31.1 | rs6749901 | 177035448 | 5.0408 | 2.3068 | 0.4525 | 0.24 | 0.4068 | 0.31 | 0.1343 | model 1 above 5 |
| 2 | 4 | 4p13 | rs2290870 | 42271177 | 4.3358 | 4.3968 | 0.0289 | 0.9205 | 0.015 | 0.0244 | 1.5823 | cluster above 3 |
| 3 | 4 | 4q21.22 | rs6535374 | 83818702 | 5.6339 | 4.0418 | 0.4901 | 0.6748 | 0.0724 | 1.1599 | 0.2282 | model 1 above 5 |
| 4 | 4 | 4q28.1 | rs979755 | 124968427 | 4.271 | 2.4815 | 0.6373 | 0.5081 | 0.7386 | 0.1819 | 0.8219 | cluster above 3 |
| 5 | 5 | 5q13.1 | rs2171812 | 66862442 | 4.1598 | 2.3247 | 0.282 | 0.7827 | 0.5896 | 1.3865 | 0.2682 | cluster above 3 |
| 6 | 5 | 5q33.2 | rs2434220 | 153257952 | 0.8915 | 0.5219 | 4.3428 | 0.2555 | 0.9442 | 1.5744 | 0.6339 | cluster above 3 |
| 7 | 6 | 6p22.3 | rs1570683 | 18447773 | 5.9584 | 4.0781 | 0.4551 | 0.2483 | 1.0646 | 0.786 | 0.1936 | model 1 above 5 |
| 8 | 9 | 9q34.3 | rs4842236 | 137297618 | 5.3115 | 4.4431 | 3.5405 | 0.3372 | 3.285 | 3.0189 | 0.0877 | model 1 above 5 |
| 9 | 10 | 10q21.1 | rs7092223 | 56556926 | 5.1429 | 3.9311 | 0.7023 | 0.0421 | 0.3521 | 1.0327 | 0.1735 | model 1 above 5 |
| 10 | 10 | 10q24.32 | rs2815401 | 103881964 | 4.3436 | 6.2567 | 1.8275 | 0.5209 | 1.1564 | 1.9786 | 0.0572 | cluster above 3 |
| 11 | 16 | 16q22.3 | rs3803704 | 69876078 | 0.4823 | 0.6772 | 4.7141 | 0.0373 | 0.1851 | 0.2336 | 0.0707 | cluster above 3 |
| 12 | 17 | 17p13.3 | rs2252909 | 2225359 | 5.3742 | 2.3803 | 0.5659 | 0.5703 | 0.4017 | 0.3889 | 0.1647 | model 1 above 5 |
| 13 | 17 | 17q21.31 | rs9912203 | 38800671 | 0.6826 | 0.3712 | 3.9776 | 0.8781 | 0.3607 | 0.3968 | 0.1232 | cluster above 3 |
| 14 | 20 | 20q12 | rs4327285 | 40627042 | 5.793 | 2.6695 | 0.0754 | 0.5305 | 0.1174 | 0.2383 | 1.2191 | model 1 above 5 |
| 15 | 21 | 21q21.3 | rs2167597 | 27667687 | 0.0058 | 0.0279 | 4.3778 | 0.4106 | 0.4635 | 0.4576 | 0.3316 | cluster above 3 |
| 16 | X | Xq13.1 | rs5937025 | 70058755 | 3.2814 | 3.776 | 0.0539 | 1.1461 | 0.0069 | 0.0784 | 0.6193 | cluster above 3 |

For each locus, the most representative SNP is shown. For each SNP, a log score (−log₁₀ of association p-value) is given for each of the statistical models evaluated.

TABLE 15

| | | | | | p-values for various models | | | | | | | |
|---|---|---|---|---|---|---|---|---|---|---|---|---|
| | | | | | | Geno + | | | | | | |
| | | | | | | c6 + | Geno* | Geno* | Geno* | Geno* | Geno* | reason for |
| locus # | chr | band | SNP name | location | Geno | c11 + c2 | Xmn1 | BCL11A_1 | BCL11A_2 | c6q23_1 | c6q23_2 | inclusion |
| 1 | 2 | 2q31.1 | rs6749901 | 177035448 | 5.0408 | 2.3068 | 0.4525 | 0.24 | 0.4068 | 0.31 | 0.1343 | model 1 |
| | | | rs3850167 | 176804554 | 3.6741 | 1.5919 | 0.2457 | 0.4092 | 0.2168 | 1.3098 | 0.2348 | above 5 |
| | | | rs6433589 | 177017187 | 3.8511 | 2.2688 | 0.1938 | 0.4134 | 0.1714 | 0.2226 | 0.1218 | |
| | | | rs11688232 | 177695270 | 0.4211 | 0.7882 | 0.0537 | 1.2265 | 0.0152 | 0.1282 | 3.1853 | |
| | | | rs2706134 | 177703938 | 0.2475 | 0.1664 | 0.0225 | 0.3726 | 0.0693 | 0.1656 | 3.2729 | |
| 2 | 4 | 4p13 | rs2290870 | 42271177 | 4.3358 | 4.3968 | 0.0289 | 0.9205 | 0.015 | 0.0244 | 1.5823 | cluster |
| | | | rs2719934 | 42042230 | 3.0693 | 1.4565 | 0.0015 | 0.0385 | 0.216 | 1.2199 | 0.158 | above 3 |
| | | | rs10034610 | 42199584 | 3.1305 | 2.3953 | 0.0142 | 0.1357 | 0.0823 | 0.191 | 1.8657 | |
| | | | rs10517038 | 42205999 | 3.5503 | 2.9737 | 0.0083 | 0.1735 | 0.0698 | 0.2131 | 1.8196 | |
| | | | rs3811768 | 42221793 | 3.4755 | 2.7981 | 0.0142 | 0.1634 | 0.0495 | 0.1224 | 1.8638 | |
| | | | rs3811769 | 42245921 | 3.7018 | 3.0194 | 0.0089 | 0.2966 | 0.085 | 0.166 | 1.614 | |
| | | | rs2306004 | 42322593 | 2.7049 | 3.455 | 0.015 | 0.7226 | 0.0382 | 0.0022 | 1.2807 | |
| | | | rs1460362 | 42339069 | 3.3508 | 3.0324 | 0.0705 | 0.9192 | 0.0135 | 0.0495 | 1.0113 | |
| 3 | 4 | 4q21.22 | rs6535374 | 83818702 | 5.6339 | 4.0418 | 0.4901 | 0.6748 | 0.0724 | 1.1599 | 0.2282 | model 1 |
| | | | rs2276883 | 83821174 | 3.5901 | 2.4952 | 0.9845 | 0.5387 | 0.2916 | 0.6365 | 0.5408 | above 5 |
| | | | rs6419260 | 83823263 | 5.3329 | 3.9134 | 0.504 | 0.6406 | 0.0833 | 1.219 | 0.2508 | |
| | | | rs1506609 | 83851997 | 3.4849 | 1.8554 | 1.0936 | 1.4329 | 0.4488 | 1.2553 | 0.3212 | |
| 4 | 4 | 4q28.1 | rs979755 | 124968427 | 4.271 | 2.4815 | 0.6373 | 0.5081 | 0.7386 | 0.1819 | 0.8219 | cluster |
| | | | rs2553364 | 124738882 | 0.6314 | 0.4227 | 3.5962 | 0.0646 | 0.2106 | 0.7428 | 0.1715 | above 3 |
| | | | rs1425416 | 124847728 | 0.5015 | 0.409 | 0.0613 | 0.0249 | 0.6778 | 3.5442 | 0.4447 | |
| | | | rs1347188 | 124962709 | 3.7391 | 2.4066 | 0.0352 | 0.5249 | 0.9273 | 0.0186 | 1.1722 | |
| | | | rs1433212 | 124972424 | 3.465 | 1.9921 | 0.3171 | 0.2233 | 1.6655 | 0.1881 | 0.3537 | |
| | | | rs13116100 | 125033874 | 3.8976 | 2.3044 | 0.3912 | 0.1504 | 1.2519 | 0.1758 | 0.4799 | |
| | | | rs999190 | 125042126 | 4.1925 | 2.9065 | 0.0099 | 0.1179 | 1.0927 | 0.0179 | 0.8863 | |
| 5 | 5 | 5q13.1 | rs2171812 | 66862442 | 4.1598 | 2.3247 | 0.282 | 0.7827 | 0.5896 | 1.3865 | 0.2682 | cluster |
| | | | rs36138 | 66202370 | 0.3689 | 0.2157 | 0.1096 | 0.1107 | 0.097 | 0.2115 | 3.1406 | above 3 |
| | | | rs1697142 | 66531603 | 1.3619 | 0.6618 | 1.0634 | 1.0914 | 0.7378 | 4.3595 | 0.0012 | |
| | | | rs2707772 | 66749767 | 0.959 | 3.5618 | 0.0389 | 0.2144 | 0.0945 | 0.0464 | 0.3787 | |
| | | | rs1532121 | 66833063 | 2.6187 | 3.7693 | 0.0326 | 0.2918 | 0.0626 | 0.5191 | 0.124 | |
| | | | rs1532122 | 66833479 | 1.9145 | 3.5626 | 0.0138 | 0.4074 | 0.1007 | 0.5005 | 0.1395 | |
| | | | rs13183882 | 66846595 | 3.4143 | 2.2898 | 0.1541 | 1.7522 | 0.5411 | 2.081 | 0.3178 | |
| | | | rs4565172 | 66908117 | 3.3566 | 1.2471 | 0.7003 | 0.2558 | 0.4054 | 0.6413 | 0.2783 | |
| | | | rs7703239 | 66941591 | 3.2039 | 2.0545 | 0.1444 | 1.0045 | 0.0942 | 1.1739 | 0.0576 | |
| 6 | 5 | 5q33.2 | rs2434220 | 153257952 | 0.8915 | 0.5219 | 4.3428 | 0.2555 | 0.9442 | 1.5744 | 0.6339 | cluster |
| | | | rs4246043 | 152796682 | 4.2721 | 1.757 | 0.2866 | 0.0988 | 0.0205 | 0.3183 | 0.4509 | above 3 |
| | | | rs4958655 | 152801782 | 4.0094 | 1.741 | 0.188 | 0.1077 | 0.0116 | 0.1957 | 0.5096 | |
| | | | rs4502882 | 153074191 | 1.1376 | 1.0229 | 3.0144 | 0.0411 | 0.6628 | 1.0011 | 0.8201 | |
| | | | rs4273649 | 153100241 | 1.7992 | 1.2985 | 3.0662 | 0.0101 | 0.1815 | 0.2509 | 1.0468 | |
| | | | rs2964011 | 153183075 | 0.8543 | 0.9455 | 3.1958 | 0.0568 | 0.8507 | 1.6715 | 0.6456 | |
| | | | rs1366095 | 153251949 | 0.6962 | 0.3916 | 3.6827 | 1.1102 | 0.5126 | 1.3148 | 0.7545 | |
| | | | rs11748836 | 153362041 | 0.5054 | 0.4121 | 3.0337 | 0.0477 | 1.2598 | 0.7392 | 0.3979 | |
| | | | rs4958692 | 153411458 | 1.9285 | 1.2414 | 3.5346 | 0.2294 | 1.2029 | 0.324 | 1.4896 | |
| | | | rs3776998 | 153778031 | 0.1392 | 0.0546 | 1.4205 | 0.2873 | 3.6721 | 1.0178 | 0.6902 | |
| 7 | 6 | 6p22.3 | rs1570683 | 18447773 | 5.9584 | 4.0781 | 0.4551 | 0.2483 | 1.0646 | 0.786 | 0.1936 | model 1 |
| | | | rs214532 | 18397751 | 3.4543 | 2.8561 | 0.7839 | 0.0001 | 1.3402 | 0.0902 | 1.2673 | above 5 |
| | | | rs445149 | 18402642 | 3.6731 | 3.0556 | 0.8737 | 0.0001 | 1.2064 | 0.1529 | 1.4948 | |
| | | | rs2328225 | 18454623 | 4.6172 | 3.1222 | 0.3589 | 0.3732 | 0.9038 | 0.5097 | 0.2436 | |
| | | | rs7748189 | 18493868 | 5.2982 | 3.5641 | 0.5773 | 0.1342 | 0.694 | 0.9351 | 0.121 | |
| | | | rs764885 | 18495794 | 3.9021 | 3.3878 | 0.1234 | 0.1668 | 0.4469 | 2.0766 | 0.0395 | |
| 8 | 9 | 9q34.3 | rs4842236 | 137297618 | 5.3115 | 4.4431 | 3.5405 | 0.3372 | 3.285 | 3.0189 | 0.0877 | model 1 |
| | | | rs12380578 | 137159547 | 3.0155 | 2.1284 | 1.3154 | 0.0948 | 2.0554 | 1.9793 | 0.1488 | above 5 |
| | | | rs10745401 | 137322007 | 0.6579 | 0.8711 | 3.6859 | 0.3124 | 0.3791 | 1.0442 | 0.1124 | |
| | | | rs7040000 | 137403552 | 0.059 | 0.1526 | 3.5656 | 0.0284 | 0.3883 | 0.5289 | 0.0255 | |
| | | | rs7044895 | 137450751 | 0.0272 | 0.0063 | 3.3656 | 0.0307 | 0.3723 | 0.9523 | 0.0308 | |
| | | | rs1475784 | 138017087 | 3.0974 | 1.2686 | 0.0007 | 0.1306 | 0.364 | 0.425 | 0.3654 | |
| 9 | 10 | 10q21.1 | rs7092223 | 56556926 | 5.1429 | 3.9311 | 0.7023 | 0.0421 | 0.3521 | 1.0327 | 0.1735 | model 1 |
| | | | | | | | | | | | | above 5 |
| 10 | 10 | 10q24.32 | rs2815401 | 103581964 | 4.3436 | 6.2567 | 1.8275 | 0.5209 | 1.1564 | 1.9786 | 0.0572 | cluster |
| | | | rs3781298 | 103881467 | 2.0085 | 3.0655 | 0.7872 | 1.1229 | 0.8851 | 1.0023 | 0.0039 | above 3 |
| | | | rs7913468 | 103669304 | 2.3926 | 3.2473 | 0.715 | 1.1466 | 0.8057 | 0.9822 | 0.0082 | |
| | | | rs11191150 | 103680560 | 2.0984 | 3.1359 | 0.7927 | 1.0136 | 0.7212 | 1.287 | 0.008 | |
| | | | rs4919611 | 103884929 | 4.0431 | 5.96 | 1.5484 | 0.4274 | 1.0181 | 1.877 | 0.0352 | |
| | | | rs4919613 | 103895769 | 4.0532 | 5.4003 | 2.0673 | 1.1548 | 0.7803 | 2.025 | 0.018 | |
| | | | rs7083450 | 103974050 | 3.5272 | 4.0977 | 1.1943 | 0.1848 | 1.0853 | 1.5746 | 0.0409 | |
| 11 | 16 | 16q22.3 | rs3803704 | 69876078 | 0.4823 | 0.6772 | 4.7141 | 0.0373 | 0.1851 | 0.2336 | 0.0707 | cluster |
| | | | rs1559420 | 69784829 | 0.8272 | 1.3887 | 3.2982 | 0.424 | 0.2668 | 0.076 | 0.0122 | above 3 |
| | | | rs6499492 | 69858360 | 0.4231 | 0.607 | 4.4534 | 0.0393 | 0.2354 | 0.1561 | 0.0568 | |
| | | | rs713532 | 69929494 | 0.3101 | 1.0017 | 4.2931 | 0.0191 | 0.5225 | 0.3326 | 0.2181 | |
| | | | rs8054321 | 69946683 | 0.5041 | 1.3465 | 4.0704 | 0.0218 | 0.7589 | 0.1719 | 0.3205 | |
| | | | rs3935259 | 69965788 | 0.3516 | 1.05 | 3.1946 | 0.0204 | 0.0568 | 0.5717 | 0.5218 | |
| | | | rs10492825 | 70575918 | 0.1158 | 0.2916 | 1.4776 | 0.2936 | 3.0578 | 0.378 | 1.1811 | |
| 12 | 17 | 17p13.3 | rs2252909 | 2225359 | 5.3742 | 2.3803 | 0.5659 | 0.5703 | 0.4017 | 0.3889 | 0.1647 | model 1 |
| | | | | | | | | | | | | above 5 |
| 13 | 17 | 17q21.31 | rs9912203 | 38800671 | 0.6826 | 0.3712 | 3.9776 | 0.8781 | 0.3607 | 0.3968 | 0.1232 | cluster |
| | | | rs8176273 | 38465179 | 0.5027 | 0.3295 | 3.5091 | 0.5857 | 0.2801 | 0.4023 | 0.1348 | above 3 |
| | | | rs8176265 | 38467522 | 0.6898 | 0.4418 | 3.6206 | 0.6085 | 0.2566 | 0.3411 | 0.1172 | |
| | | | rs1799966 | 38476620 | 0.6388 | 0.4035 | 3.624 | 0.6881 | 0.2469 | 0.3307 | 0.1065 | |
| | | | rs1060915 | 38487996 | 0.6721 | 0.4661 | 3.6924 | 0.66 | 0.2287 | 0.3022 | 0.1139 | |
| | | | rs16942 | 38497526 | 0.6082 | 0.4343 | 3.6163 | 0.6996 | 0.2344 | 0.4224 | 0.1327 | |
| | | | rs799917 | 38498462 | 0.4666 | 0.2225 | 3.1655 | 0.5092 | 0.3038 | 0.2517 | 0.0859 | |
| | | | rs16940 | 38498763 | 0.6063 | 0.4341 | 3.7942 | 0.6443 | 0.2062 | 0.2993 | 0.1126 | |
| | | | rs4534897 | 38787334 | 0.6459 | 0.3562 | 3.7234 | 0.8354 | 0.3455 | 0.4183 | 0.1444 | |
| | | | rs4793234 | 38791709 | 0.7498 | 0.3679 | 3.9412 | 0.791 | 0.3718 | 0.3966 | 0.1312 | |
| | | | rs11657004 | 38798277 | 0.6201 | 0.3517 | 3.824 | 0.8933 | 0.3581 | 0.4057 | 0.131 | |
| | | | rs1728171 | 39028855 | 0.3673 | 0.1281 | 3.9628 | 0.2098 | 0.4513 | 0.2443 | 0.068 | |
| 14 | 20 | 20q12 | rs4327285 | 40627042 | 5.793 | 2.6695 | 0.0754 | 0.5305 | 0.1174 | 0.2383 | 1.2191 | model 1 |
| | | | rs6102788 | 40406674 | 0.6243 | 0.6692 | 0.072 | 0.0761 | 0.6818 | 3.2049 | 0.047 | above 5 |
| | | | rs2205944 | 40578759 | 3.5617 | 1.4275 | 0.378 | 0.3771 | 0.1196 | 0.3361 | 2.2333 | |
| | | | rs6030328 | 40622417 | 4.7969 | 1.9027 | 0.0817 | 0.4115 | 0.1362 | 0.2174 | 1.3543 | |
| 15 | 21 | 21q21.3 | rs2167597 | 27667687 | 0.0058 | 0.0279 | 4.3778 | 0.4106 | 0.4635 | 0.4578 | 0.3316 | cluster |
| | | | rs2830319 | 26943343 | 2.0094 | 3.6468 | 0.1313 | 0.0907 | 1.5437 | 1.6366 | 0.1107 | above 3 |
| | | | rs2830869 | 27651900 | 0.0416 | 0.0577 | 3.7772 | 0.5491 | 0.2448 | 0.4998 | 0.4937 | |
| | | | rs2830872 | 27652632 | 0.0485 | 0.0597 | 4.0995 | 0.5593 | 0.2907 | 0.5298 | 0.4738 | |
| | | | rs1023381 | 27655042 | 0.0434 | 0.0594 | 4.1959 | 0.5885 | 0.3316 | 0.6553 | 0.4921 | |
| | | | rs1452096 | 27659930 | 0.0723 | 0.0869 | 3.8883 | 0.503 | 0.2341 | 0.5104 | 0.4872 | |
| | | | rs2830896 | 27677096 | 0.0455 | 0.0913 | 4.2739 | 0.3219 | 0.23 | 0.3593 | 0.8707 | |
| 16 | X | Xq13.1 | rs5937025 | 70058755 | 3.2814 | 3.776 | 0.0539 | 1.1461 | 0.0069 | 0.0784 | 0.6193 | cluster |
| | | | rs2274309 | 69590536 | 2.298 | 3.0318 | 0.4965 | 0.8151 | 0.2771 | 0.159 | 0.514 | above 3 |
| | | | rs4844228 | 69623741 | 2.5632 | 3.0067 | 0.4094 | 1.0372 | 0.3251 | 0.2197 | 0.5094 | |
| | | | rs2147719 | 69711838 | 2.4379 | 3.4411 | 0.0746 | 1.1667 | 0.2252 | 0.1274 | 0.8666 | |
| | | | rs5936938 | 69729275 | 2.716 | 3.4624 | 0.0591 | 1.0621 | 0.2135 | 0.1291 | 0.8505 | |
| | | | rs5981041 | 70090056 | 2.2633 | 3.3363 | 0.401 | 0.7692 | 0.0003 | 0.6622 | 0.0742 | |
| | | | rs5937039 | 70101555 | 2.2785 | 3.2064 | 0.3919 | 0.8638 | 0.0013 | 0.647 | 0.0495 | |

All publications mentioned in the above specification are herein incorporated by reference. Various modifications and variations of the described methods and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in biochemistry and molecular biology or related fields are intended to be within the scope of the following claims.

1-25. (canceled)

26. A method for determining the severity of a disease attributed to at least one genetic mutation comprising the steps of:
(a) providing a sample from said subject; and
(b) determining the presence of a combination of single nucleotide polymorphism(s), selected from the group consisting of: nucleotides 60,460,511, 60,467,280, 60,562,101, 60,571,547, 60,573,474 and 60,574,455 on chromosome 2p15; at nucleotide 135,424,673, 135,460,711, 135,468,266 and 135,484,905 on chromosome 6q23 and at nucleotide 5,232,745 on chromosome 11,
wherein the presence of said single nucleotide polymorphism(s) in said sample is indicative that the severity of said disease will be or is less severe in said subject in comparison to a subject that does not possess single nucleotide polymorphism(s).

27. A method for determining the severity of a disease attributed to at least one genetic mutation comprising the steps of:
(a) providing a sample from said subject; and
(b) determining the presence of one or more single nucleotide polymorphism(s), wherein said single nucleotide polymorphism(s) are selected from the group consisting of: a mutation at nucleotide 177035448 on chromosome 2q31.1; a mutation at nucleotide 42271177 on chromosome 4p13; a mutation at nucleotide 83818702 on chromosome 4q21.22; a mutation at nucleotide 124968427 on chromosome 4q28.1; a mutation at nucleotide 66862442 on chromosome 5q13.1; a mutation at nucleotide 153257952 on chromosome 5q33.2; a mutation at nucleotide 18447773 on chromosome 6p22.3; a mutation at nucleotide 137297618 on chromosome 9q34.3; a mutation at nucleotide 56556926 on chromosome 10q21.1; a mutation at nucleotide 103881964 on chromosome 10q24.32; a mutation at nucleotide 69876078 on chromosome 16q22.3; a mutation at nucleotide 2225359 on chromosome 17p13.3; a mutation at nucleotide 38800671 on chromosome 17q21.31; a mutation at nucleotide 40627042 on chromosome 20q12; a mutation at nucleotide 27667687 on chromosome 21q21.3; a mutation at nucleotide 70058755 on chromosome Xq13.1 and combinations thereof,
wherein the presence of said single nucleotide polymorphism(s) in said sample is indicative that the severity of said disease will be or is less severe in said subject in comparison to a subject that does not possess single nucleotide polymorphism(s).

28. The method according to claim 26, wherein the presence of the single nucleotide polymorphism(s) is determined using a microarray.

29. The method according to claim 26, wherein the presence of the single nucleotide polymorphism(s) is determined using a Illumina® GoldenGate® assay system with VeraCode™ technology.

30. The method according to claim 27, wherein the presence of the single nucleotide polymorphism(s) is determined using a microarray.

31. The method according to claim 27, wherein the presence of the single nucleotide polymorphism(s) is determined using a Illumina® GoldenGate® assay system with VeraCode™ technology.

32. A composition comprising a plurality of nucleic acid probes which specifically hybridises to one or more diagnostic markers for determining the severity of a disease attributed to at least one genetic mutation in one or more of the genes encoding haemoglobin polypeptide chains, wherein said markers are a combination of single nucleotide polymorphisms selected from the group consisting of:
nucleotides 60,460,511, 60,467,280, 60,562,101, 60,571,547, 60,573,474 and 60,574,455 on chromosome 2p15; at nucleotide 135,424,673, 135,460,711, 135,468,266 and 135,484,905 on chromosome 6q23 and at nucleotide 5,232,745 on chromosome 11.

33. A composition comprising a plurality of nucleic acid probes which specifically hybridises to one or more diagnostic markers for determining the severity of a disease attributed to at least one genetic mutation in one or more of the genes encoding haemoglobin polypeptide chains, wherein said markers are a combination of single nucleotide polymorphisms selected from the group consisting of:
a mutation at nucleotide 177035448 on chromosome 2q31.1; a mutation at nucleotide 42271177 on chromosome 4p13; a mutation at nucleotide 83818702 on chromosome 4q21.22; a mutation at nucleotide 124968427 on chromosome 4q28.1; a mutation at nucleotide 66862442 on chromosome 5q13.1; a mutation at nucleotide 153257952 on chromosome 5q33.2; a mutation at nucleotide 18447773 on chromosome 6p22.3; a mutation at nucleotide 137297618 on chromosome 9q34.3; a mutation at nucleotide 56556926 on chromosome 10q21.1; a mutation at nucleotide 103881964 on chromosome 10q24.32; a mutation at nucleotide 69876078 on chromosome 16q22.3; a mutation at nucleotide 2225359 on chromosome 17p13.3; a mutation at nucleotide 38800671 on chromosome 17q21.31; a mutation at nucleotide 40627042 on chromosome 20q12; a mutation at nucleotide 27667687 on chromosome 21q21.3; a mutation at nucleotide 70058755 on chromosome Xq13.1 and combinations thereof.

34. The composition of claim 32 wherein the probes are immobilized on a substrate.

35. The composition of claim 32 wherein the probes are hybridizable elements on a microarray.

36. A kit comprising the composition of claim 32.

37. The composition of claim 33 wherein the probes are immobilized on a substrate.

38. The composition of claim 33 wherein the probes are hybridizable elements on a microarray.

39. A kit comprising the composition of claim 33.


SEQUENCE LISTING (14 sequences)

SEQ ID NO: 1 - DNA, 24 bp, Artificial Sequence
  Primer
gcaaaccccagcacttaagcaaac

SEQ ID NO: 2 - DNA, 24 bp, Artificial Sequence
  Primer
ccacagctttttctaagcagaggc

SEQ ID NO: 3 - DNA, 22 bp, Artificial Sequence
  Primer
ctacagcaggcttcaggaagtg

SEQ ID NO: 4 - DNA, 22 bp, Artificial Sequence
  Primer
cacaggctcaacggaaggtttg

SEQ ID NO: 5 - DNA, 27 bp, Artificial Sequence
  MYB probe
tgctaccaacacagaaccacacatgca

SEQ ID NO: 6 - DNA, 24 bp, Artificial Sequence
  MYB forward primer
atgatgaagaccctgagaaggaaa

SEQ ID NO: 7 - DNA, 22 bp, Artificial Sequence
  MYB reverse primer
aacaggtgcactgtctccatga

SEQ ID NO: 8 - DNA, 22 bp, Artificial Sequence
  HBS1L probe
ctataactacgatgaagatttt

SEQ ID NO: 9 - DNA, 24 bp, Artificial Sequence
  HBS1L forward primer
tctacagactggccgtagagatca

SEQ ID NO: 10 - DNA, 17 bp, Artificial Sequence
  HBS1L reverse primer
cccggcatcggaatgtt

SEQ ID NO: 11 - protein, 684 aa, Homo sapiens
MARHRNVRGYNYDEDFEDDDLYGQSVEDDYCISPSTAAQFIYSRRDKPSVEPVEEYDYEDLKESSNSVSNHQLSGFDQARLYSCLDHMREVLGDAVPDEILIEAVLKNKFDVQKALSGVLEQDRVQSLKDKNEATVSTGKIAKGKPVDSQTSRSESEIVPKVAKMTVSGKKQTMGFEVPGVSSEENGHSFHTPQKGPPIEDAIASSDVLETASKSANPPHTIQASEEQSSTPAPVKKSGKLRQQIDVKAELEKRQGGKQLLNLVVIGHVDAGKSTLMGHMLYLLGNINKRTMHKYEQESKKAGKASFAYAWVLDETGEERERGVTMDVGMTKFETTTKVITLMDAPGHKDFIPNMITGAAQADVAVLVVDASRGEFEAGFETGGQTREHGLLVRSLGVTQLAVAVNKMDQVNWQQERFQEITGKLGHFLKQAGFKESDVGFIPTSGLSGENLITRSQSSELTKWYKGLCLLEQIDSFKPPQRSIDKPFRLCVSDVFKDQGSGFCITGKIEAGYIQTGDRLLAMPPNETCTVKGITLHDEPVDWAAAGDHVSLTLVGMDIIKINVGCIFCGPKVPIKACTRFRARILIFNIEIPITKGFPVLLHYQTVSEPAVIKRLISVLNKSTGEVTKKKPKFLTKGQNALVELQTQRPIALELYKDFKELGRFMLRYGGSTIAAGVVTEIKE

SEQ ID NO: 12 - protein, 699 aa, Homo sapiens
MERPAPWTLWVTTSWWYIWALRSSVTFLPDFEDDDLYGQSVEDDYCISPSTAAQFIYSRRDKPSVEPVEEYDYEDLKESSNSVSNHQLSGFDQARLYSCLDHMREVLGDAVPDEILIEAVLKNKFDVQKALSGVLEQDRVQSLKDKNEATVSTGKIAKGKPVDSQTSRSESEIVPKVAKMTVSGKKQTMGFEVPGVSSEENGHSFHTPQKGPPIEDAIASSDVLETASKSANPPHTIQASEEQSSTPAPVKKSGKLRQQIDVKAELEKRQGGKQLLNLVVIGHVDAGKSTLMGHMLYLLGNINKRTMHKYEQESKKAGKASFAYAWVLDETGEERERGVTMDVGMTKFETTTKVITLMDAPGHKDFIPNMITGAAQADVAVLVVDASRGEFEAGFETGGQTREHGLLVRSLGVTQLAVAVNKMDQVNWQQERFQEITGKLGHFLKQAGFKESDVGFIPTSGLSGENLITRSQSSELTKWYKGLCLLEQIDSFKPPQRSIDKPFRLCVSDVFKDQGSGFCITGKIEAGYIQTGDRLLAMPPNETCTVKGITLHDEPVDWAAAGDHVSLTLVGMDIIKINVGCIFCGPKVPIKACTRFRARILIFNIEIPITKGFPVLLHYQTVSEPAVIKRLISVLNKSTGEVTKKKPKFLTKGQNALVELQTQRPIALELYKDFKELGRFMLRYGGSTIAAGVVTEIKE

SEQ ID NO: 13 - DNA, 27 bp, Artificial Sequence
  RT-PCR product across exon 1a/2 junction of HBS1L-1a transcript
acctttctcccagattttgaagatgat

SEQ ID NO: 14 - protein, 9 aa, Artificial Sequence
  Synthetic Construct
TFLPDFEDD